(19) United States
(12) Patent Application Publication
(10) Pub. No.: US 2025/0196078 A1
(43) Pub. Date: Jun. 19, 2025

(54) APPARATUS FOR SUPPLYING A PARTICULATE MATERIAL

(71) Applicant: UNIVERSITY OF STRATHCLYDE, Glasgow (GB)

(72) Inventors: Chung-Hsien HOU, Denny (GB); Daniel MARKL, Lenzie, Kirkintilloch (GB); Gavin William HALBERT, Jordanhill (GB)

(21) Appl. No.: 18/865,942

(22) PCT Filed: May 16, 2023
(86) PCT No.: PCT/GB2023/051291

§ 371 Date: Nov. 14, 2024

(30) Foreign Application Priority Data
May 16, 2022 (GB) 2207163.3

(51) Int. Cl. B01F 27/192; B01F 23/60; B01F 27/1142; B01F 27/1143; B01F 35/21; B01F 35/221; B01F 35/513; B01F 101/22; G05D 7/06

(52) U.S. Cl. CPC B01F 27/192; B01F 23/60; B01F 27/1142; B01F 27/1143; B01F 35/21111; B01F 35/221422; B01F 35/2218; B01F 35/513; G05D 7/0611; B01F 2101/22; B01F 2215/0422

(57) ABSTRACT

We disclose an apparatus (2) for supplying a particulate material (4) at a target mass flow rate, the apparatus comprising an entrainment region (6) configured to entrain the particulate material (4) in a gas or gas mixture flowing through the entrainment region (6), a cross-sectional area of at least a part of the entrainment region being adjustable based on the particulate material (4) and a supply device (8) configured to supply the particulate material (4) to the entrainment region (6) at approximately or at the target mass flow rate.

### FIELD

The present disclosure relates to an apparatus for supplying a particulate material at a target mass flow rate and associated systems, devices and methods.

### BACKGROUND

Continuous supplying or feeding of particulate material in small quantities with minimal variations over time may be desirable in a range of industries. For example, in the pharmaceutical industry, it may be desirable to supply or feed particulate material including, for example, high-potency active pharmaceutical ingredients with doses in the range of milligrams or less per tablet. This may require a feed rate of less than 10 g/h with minimal variation over time.

### SUMMARY

According to a first aspect of the present disclosure there is provided an apparatus for supplying a particulate material at a target mass flow rate, the apparatus comprising an entrainment region configured to entrain the particulate material in a gas or gas mixture flowing through the entrainment region, a cross-sectional area of at least a part of the entrainment region being adjustable based on the particulate material, and a supply device configured to supply the particulate material to the entrainment region at approximately or at the target mass flow rate.

The apparatus may be used in pharmaceutical applications. In such applications or other applications, it may be desirable to minimise a deviation or variation of the mass flow rate of the particulate material from the target mass flow rate. The deviation or variation of the mass flow rate may dependent on an entrainment energy or entrainment power. The entrainment energy or entrainment power may be understood as the energy or power required to entrain, e.g. to incorporate or mix, the particulate material in the gas or gas mixture. The entrainment energy or entrainment power may be dependent on one or more properties of the particulate material. The entrainment energy or entrainment power may be dependent on one or more properties of the gas or gas mixture. For example, the entrainment energy or entrainment power may be dependent on a velocity of the gas or gas mixture flowing through the entrainment region. By providing the apparatus with an adjustable cross-sectional area of at least a part of the entrainment region, the entrainment energy or entrainment power and/or the velocity of the gas or gas mixture flowing through in the entrainment region may be adjusted, e.g. roughly adjusted, based on the particulate material. This may aid the reduction of variations or deviations in the mass flow rate of the particulate material relative to the target flow rate, e.g. over time. This may allow for the apparatus to supply the particulate material at a mass flow rate of less than 10 g/h with minimal or reduced variations or deviations over time.

Additionally or alternatively, by providing the apparatus with an adjustable cross-sectional area of a part of the entrainment region, based on the particulate material, a rate and/or efficiency of the entrainment of the particulate material in the gas or gas mixture may be increased, the apparatus may operable with different particulate materials, accumulation of particulate material in the entrainment region may be reduced and/or a workload and/or gas or gas mixture consumption of a separation device may be reduced.

The cross-sectional area of at least the part of entrainment region may be adjustable based on the one or more properties of the particulate material. The one or more properties of the particulate material may comprise at least one (at least two of, or all of) of: a cohesion force between particles of the particulate material, an electrostatic charge of particles of the particulate material, a compressibility of the particulate material, mechanical interlocking between particles of the particulate material, a particle sizeand/or shape of the particulate material, and a density of the particulate material.

The entrainment region may comprise a first part. The entrainment region may comprise a second part. The first part of the entrainment region may comprise or define a first cross-sectional area. The second part of the entrainment region may comprise or define a second cross-sectional area.

The apparatus may comprise a first restriction member. The first restriction member may be moveable into the first part of the entrainment region, e.g. to adjust the first cross-sectional area of the first part of the entrainment region.

The first restriction member may be moveable between a first position and a second position, e.g. based on the particulate material. In the first position, the first restriction member may extend or protrude into the first part of the entrainment region.

In the second position, the first restriction member may be retracted from the first part of the entrainment region. The first position of the first restriction member may be selected based on the particulate material. For example, an extension or protrusion, e.g. a degree or amount thereof, of the first restriction member into the first part of the entrainment region may be selected based on the particulate material.

When the first restriction member is in the first position, the first cross-sectional area of the first part of the entrainment region may be decreased, e.g. relative to the first cross-sectional area of the first part of the entrainment region, when the first restriction member is in the second position. The first restriction member may allow for an adjustment, e.g. a rough adjustment, of the velocity of the gas or gas mixture flowing through the entrainment region and/or the entrainment energy or entrainment power in the entrainment region based on the particulate material.

The apparatus may comprise a second restriction member. The second restriction member may be, or configured to be, removeably arranged in the second part of the entrainment region. The second restriction member may be configured to adjust the second cross-sectional area of the second part of the entrainment region.

The apparatus may be operable between a first configuration and a second configuration, e.g. based on the particulate material. In the first configuration of the apparatus, the second restriction member may be arranged in the second part of the entrainment region. In the second configuration, the restriction member may be absent or removed from the second part of the entrainment region.

The second restriction member may be configured to decrease the second cross-sectional area of the second part of the entrainment region. The second restriction member may be configured to decrease the second cross-sectional area of the second part of the entrainment region by about 2% to 98%, such as by about 50%, 75% or 90%. When the apparatus is in the first configuration, the second cross-sectional area of the second part of the entrainment region may be decreased, e.g. relative to the second cross-sectional area of the second part of the entrainment region, when the apparatus is in the second configuration.

The second restriction member may be configured to extend along the second part of the entrainment region. For example, when the apparatus is in the first configuration, the second restriction member may be arranged to extend in a direction parallel, e.g. substantially parallel, to a central or longitudinal axis of the apparatus, e.g. the entrainment region. The second restriction member may be configured to extend beyond the entrainment region.

The second restriction member may comprise a first part. The second restriction member may comprise a second part. The first and second parts of the second restriction member may be arranged on either side of the first restriction member, e.g. when the apparatus is in the first configuration.

A cross-sectional area of the second restriction member may be selected based on the particulate material. The second restriction member may allow for an adjustment, e.g. a rough adjustment, of velocity of the gas or gas mixture flowing through the entrainment region and/or the entrainment energy or entrainment power the entrainment region based on the particulate material.

The apparatus may comprise a first conduit. The first conduit may be configured to direct the gas or gas mixture from a gas or gas mixture supply to the entrainment region. The apparatus may comprise a second conduit. The second conduit may be configured to direct the particulate material entrained in the gas or gas mixture away from the entrainment region. The first part of the second restriction member may be configured to extend along at least a part or all of the first conduit The first part of the second restriction member may be configured to define and/or adjust a cross-sectional area of the first conduit, e.g. based on the particulate material. The second restriction member may be configured to extend along at least a part or all of the second conduit. The second restriction member may be configured to define and/or adjust a cross-sectional area of the second conduit, e.g. based on the particulate material. For example, the first part of the second restriction member may be configured to decrease the cross-sectional area of the first conduit, e.g. based on the particulate material. The second part of the second restriction member may be configured to decrease the cross-sectional area of the second conduit, e.g. based on the particulate material. The first and/or second parts of the second restriction member may be configured to decrease the cross-sectional area of the first and/or second conduits, respectively, by about 2% to 98%, such as by about 50%, 75% or 90%.

The apparatus may comprise a control system. The control system may be configured to control one or more properties of the gas or gas mixture flowing through the entrainment region. The control system may be configured to control a mass flow rate of the particulate material supplied by the supply device, e.g. based on the target mass flow rate. The one or more properties of the gas or gas mixture may comprise at least one of: a pressure of the gas or gas mixture in or flowing through the entrainment region and a flow rate of the gas or gas mixture in or flowing through the entrainment region.

The pressure of the gas or gas mixture and/or the flow rate of the gas or gas mixture in or flowing through the entrainment region may be selected, e.g., based on the particulate material and/or the target mass flow rate of the particulate material. For example, the pressure of the gas or gas mixture in the entrainment region may be between about 0 Pa and 150 kPa. The flow rate of the gas or gas mixture in or flowing through the entrainment region may be between about 3×10⁻⁵ m³/s (2 l/min) and 4×10⁻⁴ m³/s (25 l/min).

The control system may comprise a first sensor. The first sensor may be configured to sense a first signal. The first signal may indicative of a mass flow rate of the particulate material. The control system may be configured to determine the mass flow rate of the particulate material, e.g. based on the sensed first signal. The mass flow rate of the particulate material may comprise a mass flow rate of the particulate material entrained in the gas or gas mixture. The mass flow rate of the particulate material May comprise a mass flow rate of the particulate material separated from the gas or gas mixture.

The control system may comprise a plurality of first sensors. Each sensor of the plurality of first sensors may be configured to sense a first signal. At least one first signal or each first signal may indicative of a mass flow rate of the particulate material. The control system may be configured to determine the mass flow rate of the particulate material, e.g. based on the sensed first signal of at least one or each first sensor of the plurality of first sensors. The mass flow rate of the particulate material may comprise a mass flow rate of the particulate material entrained in the gas or gas mixture. The mass flow rate of the particulate material may comprise a mass flow rate of the particulate material separated from the gas or gas mixture.

The control system may be configured to compare the determined mass flow rate of the particulate material to the target mass flow rate. The control system may be configured to determine a target flow rate and/or target pressure of the gas or gas mixture flowing through the entrainment region, e.g. based on a result of the comparison between the determined mass flow rate of the particulate material and the target mass flow rate.

The control system may comprise a second sensor. The second sensor may be configured to sense a second signal. The second signal may be indicative of the flow rate or a pressure of the gas or gas mixture flowing through the entrainment region. The control system may be configured to determine the flow rate or pressure of the gas or gas mixture flowing through the entrainment region, e.g. based on the sensed second signal. The control system may be configured to compare the determined flow rate or pressure to the target flow rate or target pressure. The control system may be configured to adjust at least one of: the one or more properties of the gas or gas mixture flowing through entrainment region, and a mass flow rate of the particulate material supplied by the supply device, e.g. based on a result of the comparison between the determined flow rate or pressure and the target flow rate or target pressure. By adjusting the one or more properties, e.g. the flow rate and/or the pressure, of the gas or gas mixture flowing through entrainment region, the velocity of the gas or gas mixture in or flowing through the entrainment region may be controlled or adjusted. This in turn may allow an adjustment, e.g. a fine adjustment, of the entrainment energy or entrainment power.

The control system may be configured to move the first restriction member between the first position and the second position. The control system may be configured to control and/or adjust the first position of the first restriction member in the first part of the entrainment region, e.g. based on the particulate material and/or the target mass flow rate. For example, based on the comparison between the determined mass flow rate and the target mass flow rate, the control system may be configured to adjust and/or control the first position of the first restriction member in the first part of the entrainment region and/or move the first restriction member between the first and second positions.

The supply device may be arranged or configured to supply the particulate material to the first part of the entrainment region. The supply device may comprise a container for holding the particulate material. The supply device may comprise a moving arrangement. The moving arrangement may be configured to move the material from the container to the entrainment region.

At least a part of the moving arrangement may be arranged to be moveable in the container.

The supply device may comprise a housing. At least a part of the moving arrangement may be arranged in the housing. The container may be connected to the housing e.g. an outside of the housing. The container may comprise an opening to an exterior of the supply device. By connecting the container to an outside of the housing, the container may be refilled with particulate material during the operation of the apparatus. This may allow for a continuous supply of the particulate material to the entrainment region, which may in turn allow for a continuous operation of the apparatus. The opening of the container to the exterior of the supply device may facilitate refilling of the container with the particulate material.

One or more walls of the container may be formed from a flexible material. The supply device may comprise a support arrangement. The support arrangement may be configured to support and/or move at least one of the one or more walls of the container. For example, the support arrangement may be configured to move the at least one of the one or more walls, e.g. to aid movement of the particulate material in the container. The support arrangement may be configured to engage with and/or to support the at least one of the one or more walls, e.g. to prevent arching of the at least one of the one or more walls. This may reduce accumulation of the particulate material on one or more walls of the container.

The supply device may comprise an agitating device. The agitating device may be configured to move the particulate material in the container. The agitating device may be configured agitate the particulate material, e.g. to aid movement of the particulate material in the container. The agitating device may be configured to regulate a supply of particulate material from supply device. By providing the supply device with an agitating device, an accuracy in supplying the particulate material by the supply device may be improved. The agitating device may aid the supply of a cohesive particulate material.

The moving arrangement, e.g. one or more parts thereof, may be arranged at an angle between 0 degrees and 180 degrees, such as about 60 degrees, relative to a longitudinal axis of the container.

The moving arrangement may comprise a piston. The piston may be configured to move the particulate material in the container to the entrainment region, e.g. in use.

The moving arrangement may comprise a helical or spiral structure or helical or spiral member. The helical or spiral structure or helical or spiral member may be configured to receive particulate material from the container. The helical or spiral structure or helical or spiral member may be configured to move the particulate material to the entrainment region, e.g. in use.

The apparatus may comprise a separation device. The separation device may be configured to receive the particulate material entrained in the gas or gas mixture from the entrainment region. The separation device may be configured to separate the particulate material from the gas or gas mixture.

The separation device may comprise a cyclonic separation device. The separation device may be or comprise a modular separation device.

The separation device may comprise a vibration device. The vibration device may be configured to vibrate the separation device, e.g. a part thereof.

The separation device may comprise one or more guide members. The one or more guide members may be configured to direct the particulate material entrained in the gas or gas mixture on a helical path. The one or more guide members may be arranged to extend parallel to a longitudinal axis of the separation device. The one or more guide members comprise one or more baffle rods.

According to a second aspect of the present disclosure there is provided a restriction member for use in an apparatus for supplying a particulate material at a target mass flow rate, wherein the restriction member is configured to adjust a cross-sectional area of at least a part of the entrainment region of the apparatus, e.g. based on the particulate material. The apparatus may comprise the apparatus according to the first aspect.

The restriction member may be configured to be removeably arranged in at least the part of the apparatus.

The restriction member may be configured to reduce the cross-sectional area of at least the part of the entrainment region of the apparatus, e.g. based on the particulate material. The restriction member may be configured to decrease the cross-sectional area of at least the part of the entrainment region of the apparatus by about 2% to 98%, such as by about 50%, 75% or 90%.

The restriction member may comprise any of the feature of the second restriction member described in the first aspect.

According to a third aspect of the present disclosure there is provided a method of using an apparatus for supplying a particulate material at a target mass flow rate, the method comprising providing an apparatus according to first aspect, selecting the particulate material and adjusting the cross-sectional area of at least the part of the entrainment region based on the particulate material.

The step of adjusting the cross-sectional area of at least the part of the entrainment region based on the particulate material may comprise moving the first restriction member between the first and the second position, e.g. based on the particulate material.

The step of adjusting the cross-sectional area of at least the part of the entrainment region may comprise selecting a second restriction member, e.g. based on the particulate material. The step of adjusting the cross-sectional area of at least the part of the entrainment region may comprise operating the apparatus into the first configuration. For example, the step of adjusting the cross-sectional area of at least the part of the entrainment region may comprise arranging the selected second restriction member in the second part of the entrainment region. The step of adjusting the cross-sectional area of at least the part of the entrainment region may comprise removing a previously used second restriction member from the second part of the entrainment region, e.g. prior to arranging the selected second restriction member in the second part of the entrainment region.

The step of selecting a second restriction member may comprise selecting a cross-sectional area of the second restriction member, e.g. based on the particulate material.

The method may comprise selecting one or more properties of the gas or gas mixture. The one or more properties of the gas or gas mixture may be selected based on the particulate material.

The method may comprise controlling the one or more properties of the gas or gas mixture flowing through the entrainment region, e.g. based on the target mass flow rate. The method may comprise controlling the mass flow rate of the particulate material supplied by the supply device, e.g. based on the target mass flow rate.

The one or more properties of the gas or gas mixture may comprise a pressure of the gas or gas mixture in or flowing through the entrainment region. The one or more properties of the gas or gas mixture may comprise a flow rate of the gas or gas mixture in the entrainment region.

The method may comprise receiving a first signal, e.g. from a first sensor. The method may comprise receiving a plurality of first signals, e.g. from a plurality of first sensors. The first signal, the plurality of first signals, at least one or each first signal of the plurality of first signals may be indicative of a mass flow rate of the particulate material. The method may comprise determining the mass flow rate of the particulate material, e.g. based on the first signal, the plurality of first signals, at least one or each first signal of the plurality of first signals. The mass flow rate of the particulate material may comprise a mass flow rate of the particulate material entrained in the gas or gas mixture. The mass flow rate of the particulate material may comprise a mass flow rate of the particulate material separated from the gas or gas mixture.

The method may comprise comparing the determined mass flow rate of the particulate material to the target mass flow rate. The method may comprise determining a target flow rate and/or target pressure of the gas or gas mixture flowing through the entrainment region, e.g. based on a result of the comparison between the determined mass flow rate of the particulate material and the target mass flow rate.

The method may comprise receiving a second signal, e.g. from a second sensor. The second signal may be indicative of the flow rate or a pressure of the gas or gas mixture flowing through the entrainment region. The method may comprise determining the flow rate or pressure of the gas or gas mixture flowing through the entrainment region, e.g. based on the second signal. The method may comprise comparing the determined flow rate and/or pressure to the target flow rate and/or target pressure. The method may comprise adjusting at least one of: the one or more properties of the gas or gas mixture flowing through entrainment region, and a mass flow rate of the particulate material supplied by the supply device, e.g. based on a result of the comparison between the determined flow rate or pressure and the target flow rate or target pressure. By adjusting the one or more properties, e.g. the flow rate and/or the pressure, of the gas or gas mixture flowing through entrainment region, the velocity of the gas or gas mixture in the entrainment region may be controlled or adjusted. This in turn may allow an adjustment, e.g. a fine adjustment, of the entrainment energy or entrainment power.

The method may comprise controlling a speed or velocity of the moving arrangement and/or a speed or velocity of the agitating device. The method may comprise adjusting the speed or velocity of the moving arrangement and/or the speed or velocity of the agitating device, e.g. based on the result of the comparison between the determined mass flow rate of the particulate material and the target mass flow rate.

The method may comprise separating the particulate material from the gas or gas mixture, e.g. using the separation device.

According to a fourth aspect of the present disclosure there is provided a manufacturing system comprising an apparatus for supplying a particulate material at a target mass flow rate according to the first aspect.

The manufacturing system may comprise at least one of: a pharmaceutical manufacturing system, a food and/or beverage manufacturing system, a cosmetic product manufacturing system, and/or a chemical system, such as a chemical reactor.

The particulate material may comprise a food ingredient or substance, a cosmetic ingredient or substance, a particulate reactant or particulate catalyst.

In embodiments where the system is a pharmaceutical manufacturing system, the system may be configured to manufacture a drug or drug product.

The manufacturing system may comprise a 3D printing manufacturing system or an additive manufacturing system.

According to a fifth aspect of the present disclosure there is provided a manufacturing method. The method may comprise providing an apparatus according to first aspect. The method may comprise selecting the particulate material. The method may comprise adjusting the cross-sectional area of at least the part of the entrainment region based on the particulate material.

The method may comprise or be part of at least one of: a pharmaceutical manufacturing method, a food and/or beverage manufacturing method and a cosmetic product manufacturing method.

The method may be or comprise a 3D printing manufacturing method or an additive manufacturing method.

The method may comprise any of the features of the method of the third aspect.

According to a sixth aspect of the present disclosure there is provided a system for blending or mixing a plurality of particulate materials, the system comprising a plurality of apparatuses for supplying a particulate material at a target mass flow rate, each apparatus of the plurality of apparatuses comprising the apparatus for supplying a particulate material at a target mass flow rate according to the first aspect and a blending or mixing device, wherein each apparatus of the plurality of apparatuses is connected to the blending or mixing device.

The blending or mixing device may comprise the separation device.

According to a seventh aspect of the present disclosure there is provided an agitating device for moving a particulate material in a container. The device may comprise a first spiral or helical portion. The device may comprise a second spiral or helical portion. The second spiral or helical portion may be arranged or configured to surround the first spiral or helical portion. The first spiral or helical portion may be configured to move at least a portion of the particulate material in the container in a first direction. The second spiral or helical portion may be configured to move at least a portion, e.g. another portion, of the particulate in the container in a second direction. The first and second directions may be parallel to a longitudinal axis of the device. The first direction may be opposite to the second direction.

The first or helical spiral portion may comprise a first diameter and/or a first pitch. The second spiral portion may comprise a second diameter and/or a second pitch. The first and second diameters may be different. The first and second pitches may be different. At least one of the first diameter, the second diameter, the first pitch and/or the second pitch may be selected based on the particulate material.

At least one of the first and/or second spiral or helical portions may be configured such that at least one of the first and second diameters changes, e.g. decreases, along a length of the first and/or second spiral or helical portions, respectively.

The device may comprise a third spiral or helical portion. The third spiral or helical portion may be arranged between the first and second spiral or helical portions. The device may comprise a fourth spiral or helical portion. The fourth spiral or helical portion being may be arranged to surround the first and/or third spiral or helical portions. The fourth spiral or helical portion may be arranged to be offset relative to the second spiral portion.

The third spiral or helical portion may comprise a third diameter and/or a third pitch. The fourth spiral or helical portion may comprise a fourth diameter and/or a fourth pitch. At least one of the third and/or fourth pitches may be selected based on the particulate material. At least one of the third and/or fourth spiral or helical portions may be configured such that at least one of the third and/or fourth diameters changes, e.g. decreases, along a length of the third and fourth spiral or helical portions, respectively. The fourth diameter may be the same as the second diameter. The fourth pitch may be the same as the second pitch.

The first spiral or helical portion may comprise a plurality of crest portions. The helical or spiral member may be configured such that each crest portion extends between a central axis and an outer edge helical or spiral member. The helical or spiral member is configured such that a portion of particulate material is receivable between adjacent crest portions of the plurality of crest portions.

According to an eighth aspect of the present disclosure there is provided a helical or spiral member for moving a particulate material. The helical or spiral member may comprising a plurality of crest portions. The helical or spiral member may be configured such that each crest portion extends between a central axis and an outer edge of the helical or spiral member. The helical or spiral member may be configured such that a portion of particulate material is receivable between adjacent crest portions of the plurality of crest portions. A distance between adjacent crest portions of the plurality of crest portions and/or a shape of at least a portion of the helical or spiral member may be selected based on the particulate material. The portion of the helical or spiral member may comprise an end portion of the helical or spiral member. The helical or spiral member may be configured such that the shape of the end portion is the same as a shape of a remainder of the helical or spiral member. Alternatively, the helical or spiral member may be configured such that the shape of the end portion is different relative to the shape of the remainder of the helical or spiral member. For example, when the shape of the end portion is different relative to the shape of the remainder of the helical or spiral member, the helical or spiral member may be configured such that a distance between two or more adjacent crest portions of the end portion is different, e.g. increased, relative to a distance between two or more adjacent crest portions of the remainder of the helical or spiral member. For example, when the shape of the end portion is different relative to the shape of the remainder of the helical or spiral member, the helical or spiral member may be configured such that a radius of one or more crest portions of the end portion is different, e.g. decreased, relative to a radius of one or more crest portions of the remainder of the helical or spiral member.

The helical or spiral member may be or comprise the first spiral or helical portion of the seventh aspect. Alternatively, the helical or spiral member may be or comprise a shaft or a moving arrangement of a supply device.

According to a ninth aspect of the present disclosure there is provided a supply device for supplying a particulate material at approximately or at a target mass flow rate.

The supply device may comprise a container for holding the particulate material. The supply device may comprise a moving arrangement configured to move the particulate material from the container, e.g. to a location or a desired location, at approximately or at the target mass flow rate. The location or desired location may be the entrainment region of the apparatus according to the first aspect. Alternatively, the location or desired location may comprise a part of a manufacturing system, another device or apparatus and/or a location at which a product comprising the particulate material may be manufactured.

The moving arrangement may comprise a helical or spiral member. The helical or spiral member may be configured to receive at least a portion of particulate material from the container. The helical or spiral member may be configured to move the particulate material from the container, e.g. to the location or desired location. The helical or spiral member may comprise a helical or spiral member according to the eighth aspect.

The container may be connected to the moving arrangement. The moving arrangement may be arranged at an angle relative to a longitudinal axis of the container. The moving arrangement may be arranged at an angle between 0 degrees and 180 degrees, such as 60 degrees, 90 degrees or 120 degrees, relative to the longitudinal axis of the container.

The supply device may comprise an agitating device. At least a portion of the agitating device may be arranged in the container. The agitating device may be configured to move the particulate material in the container. The agitating device may be configured to agitate the particulate material, e.g. to aid movement of the particulate material in the container. The agitating device may be configured to regulate a supply of particulate material from supply device. The agitating device may be configured to move a portion of the particulate material towards the moving arrangement. The agitating device may be configured to regulate or control an amount of the particulate material, e.g. a mass flow rate of the particulate material, moved to the moving arrangement.

By providing the supply device with an agitating device, an accuracy in supplying the particulate material by the supply device may be improved. The agitating device may aid the supply of a cohesive particulate material.

The agitating device may be configured to move at least some or a portion of the particulate material in the container in a first direction. The agitating device may be configured to move at least some or a portion of the particulate material in the container in a second direction. The first and/or second directions may be parallel to the longitudinal axis of the agitating device. The first direction may be opposite to the second direction.

The supply device may comprise an outlet. The outlet may be configured to supply the particulate material from the container, e.g. at approximately or at the target mass flow rate. The agitating device may be configured to move a portion of the particulate material towards the outlet. The agitating device may be configured to regulate or control an amount of the particulate material, e.g. a mass flow rate of the particulate material, moved to the outlet.

The container may comprise one or more walls. The one or more walls of the container may be formed from a flexible material. The supply device may comprise a support arrangement. The support arrangement may be configured to support and/or move the at least one of the one or more walls of the container. For example, the support arrangement may be configured to move the at least one of the one or more walls, e.g. to aid movement of the particulate material in the container. The support arrangement may be configured to engage with and/or to support the at least one of the one or more walls, e.g. to prevent arching of the at least one of the one or more walls. This may reduce accumulation of the particulate material on one or more walls of the container.

The supply device may comprise a housing. At least a part of the moving arrangement may be arranged in the housing. The container may be connected to the housing e.g. an outside of the housing. The container may comprise an opening to an exterior of the supply device. By connecting the container to an outside of the housing, the container may be refilled with particulate material during the operation of the supply device. This may allow for a continuous supply of the particulate material. The opening of the container to the exterior of the supply device may facilitate refilling of the container with the particulate material.

The supply device may comprise a control system. The control system may be configured to control a speed or velocity of the moving arrangement, e.g. based on the particulate material and/or the target mass flow rate. The control system may be configured to control a speed or velocity of the agitating device, e.g. based on the particulate material and/or the target mass flow rate. By controlling the speed or velocity of the moving arrangement and/or agitating device, variations in the mass flow rate of the particulate material supplied by the supply device may be reduced. For example, the supply device may supply the particulate material at approximately or at the target mass flow rate with reduced variations. Additionally or alternatively, controlling the speed or velocity of the moving arrangement and/or agitating device the mass flow rate of the particulate material may be controlled, e.g. independently controlled.

The control system may comprise a sensor. The sensor may be configured to sense a signal. The signal may be indicative of a mass flow rate of the particulate material supplied by the supply device. The control system may be configured to determine the mass flow rate of the particulate material supplied by the supply device, e.g. based on the sensed signal. The control system may be configured to compare the determined mass flow rate of the particulate material to the target mass flow rate. The control system may be configured to adjust the speed or velocity of the moving arrangement, e.g. based on a result of the comparison between the determined mass flow rate of the particulate material and the target mass flow rate. The control system may be configured to adjust the speed or velocity of the agitating device, e.g. based on the result of the comparison between the determined mass flow rate of the particulate material and the target mass flow rate.

The supply device may be part of or comprised in an apparatus for supplying a particulate material at a target mass flow rate. The apparatus may comprise any of the features of the apparatus according to the first aspect. For example, the apparatus may comprise an entrainment region configured to entrain the particulate material in a gas or gas mixture flowing through the entrainment region. A cross-sectional area of at least a part of the entrainment region may be adjustable based on the particulate material. The entrainment region may improve, e.g. further improve, an accuracy of the mass flow rate of the particulate material and/or reduce, e.g. further reduce, variations of the mass flow rate of the particulate material. Alternatively, the supply device may be used on its own, e.g. without an entrainment region.

According to a tenth aspect of the present disclosure there is provided a method of using a supply device for supplying a particulate material at approximately or at a target mass flow rate. The method may comprise providing the supply device according to the ninth aspect. The method may comprise filling the container with a particulate material. The method may comprise operating the agitating device to move the particulate material in the container. Operating the agitating device may comprise moving, e.g. rotating, a portion of the agitating device in the container. Operating the agitating device may comprise selecting a speed or velocity of the agitating device, e.g. based on the particulate material and/or the target mass flow rate.

The method may comprise supplying the particulate material from the outlet. For example, the agitating device may be configured to move a portion of the particulate material towards the outlet. The agitating device may be configured to regulate or control an amount of the particulate material, e.g. a mass flow rate of the particulate material, to the outlet.

Alternatively, the method may comprise operating the moving arrangement to move the particulate material from the container, e.g. to a location or a desired location, at approximately or at the target mass flow rate. Operating the moving arrangement may comprise moving, e.g. rotating, a shaft, e.g. a helical or spiral member. Operating the moving arrangement may comprise selecting a speed or velocity of the moving arrangement, e.g. the shaft, e.g. the helical or spiral member, based on the particulate material and/or the target mass flow rate.

The method may comprise refilling the container with the particulate material, e.g. when a level of the particulate material in the container has decreased, e.g. to below a threshold level.

According to an eleventh aspect of the present disclosure there is provided a manufacturing system comprising a device for supplying a particulate material at approximately or at a target mass flow rate according to the ninth aspect.

The manufacturing system may comprise at least one of: a pharmaceutical manufacturing system, a food and/or beverage manufacturing system, a cosmetic product manufacturing system, and/or a chemical system, such as a chemical reactor.

The particulate material may comprise a food ingredient or substance, a cosmetic ingredient or substance, a particulate reactant or particulate catalyst.

In embodiments where the system is a pharmaceutical manufacturing system, the system may be configured to manufacture a drug or drug product.

The manufacturing system may comprise a 3D printing manufacturing system or an additive manufacturing system.

According to a twelfth aspect of the present disclosure there is provided a system for blending or mixing a plurality of particulate materials. The system may comprise a plurality of devices for supplying a particulate material at approximately or at a target mass flow rate. At least one or each of the plurality of devices may comprise a supply device for supplying a particulate material at approximately or at a target mass flow rate according to the ninth aspect. At least one of the plurality of devices is arranged to supply particulate material into a container of at least one other of the plurality of devices.

According to a thirteenth aspect of the present disclosure there is provided a computer program comprising computer executable instructions that, when executed by a processor, cause the processor to control an additive manufacturing apparatus to manufacture at least a part of the apparatus according to the first aspect, at least a part of the agitating device of the seventh aspect, the helical or spiral member of the eighth aspect and/or at least a part of the supply device according to the ninth aspect.

The part of the apparatus may comprise at least one of: the entrainment region, the first restriction member, the second restriction member, one or more parts of the supply device; and one or more parts or all of the separation device.

According to an fourteenth aspect of the present disclosure there is provided a method of manufacturing a product via additive manufacturing, the method comprising obtaining an electronic file representing a geometry of the product, wherein the product comprises at least a part of the apparatus according to the first aspect, at least a part of the agitating device of the seventh aspect, the helical or spiral member of the eighth aspect and/or at least a part of the supply device according to the eighth aspect and controlling an additive manufacturing apparatus to manufacture, over one or more additive manufacturing steps, the product according to the geometry represented or specified in the electronic file.

The part of the apparatus may comprise at least one of: the entrainment region, the first restriction member, the second restriction member, one or more parts of the supply device; and one or more parts or all of the separation device.

According to a fifteenth aspect of the present disclosure there is provided a computer-readable storage medium having stored thereon the computer program according to the thirteenth aspect.

Various aspects and features of the present disclosure set out above or below may be combined with various other aspects and features of the present disclosure as will be readily apparent to the skilled person.

### BRIEF DESCRIPTION OF THE DRAWINGS

Some preferred embodiments of the disclosure will now be described by way of example only and with reference to the accompanying drawings, in which:

FIG. 1 depicts an exemplary apparatus for supplying a particulate material at a target mass flow rate;

FIGS. 2A and 2B depict cross-sectional views of an entrainment region of the apparatus of FIG. 1;

FIG. 3A depicts a table of exemplary second restriction members with varying cross-sectional areas for use in the apparatus of FIG. 1;

FIG. 3B depicts an end portion of one or more second restriction members of FIG. 3A;

FIGS. 3C to 3F depict cross-sectional views of the entrainment region of the apparatus of FIG. 1 with the first restriction member in different positions;

FIG. 4 depicts an exemplary supply device for use in the apparatus of FIG. 1;

FIG. 5 depicts a portion of the supply device of FIG. 4;

FIG. 6A depicts another exemplary supply device for use in the apparatus of FIG. 1;

FIG. 6B depicts a cross-sectional view of the supply device of FIG. 6A;

FIGS. 6C to 6G depict exemplary shafts for use in the supply device of FIGS. 6A and 6B;

FIGS. 7A to 7C depict other exemplary supply devices for use in the apparatus of FIG. 1;

FIG. 7D depicts a portion of an agitating device for use in any of the supply devices of FIGS. 7A to 7C;

FIGS. 7E to 7G depict exemplary respective portions of an agitating device for use in any of the supply devices of FIG. 7A to 7C;

FIG. 7H depicts another exemplary portion of an agitating device for use in any of the supply devices of FIGS. 7A to 7C;

FIGS. 7I to 7K each depict an exemplary supply device comprising an agitating device with a moving arrangement at a different angle;

FIG. 7L depicts an exemplary system for blending or mixing a plurality of particulate materials;

FIGS. 7M and 7N depict another exemplary supply device;

FIG. 8A depicts an exemplary separation device for use in the apparatus of FIG. 1;

FIG. 8B depicts another exemplary separation device for use in the apparatus of FIG. 1;

FIGS. 8C to 8E depict exemplary embodiments of a portion of the separation device of FIGS. 8A and 8B;

FIG. 9 depicts an exemplary control system for use in the apparatus of FIG. 1, when the apparatus comprises the supply device of FIG. 4;

FIG. 10A depicts an exemplary control system for use in the apparatus of FIG. 1, when the apparatus comprises the supply device of FIG. 6A;

FIGS. 10B and 10C each depict an exemplary control system for use in the supply device;

FIG. 11 depicts another exemplary control system for use in the apparatus of FIG. 1, when the apparatus comprises the supply device of FIG. 4;

FIG. 12 depicts another exemplary control system for use in the apparatus of FIG. 1, when the apparatus comprises the supply device of FIG. 6A;

FIG. 13 depicts a graph of mass flow rates of the particulate material supplied by the apparatus of FIG. 1 over time for different flow rates of the gas or gas mixture;

FIG. 14 depicts a graph of relative standard deviations determined for the mass flow rates of FIG. 13 over the flow rate of the gas or gas mixture;

FIG. 15 depicts a graph of mass flow rates of the particulate material supplied by the apparatus of FIG. 1 over time for different flow rates of the gas or gas mixture;

FIG. 16A depicts a graph of relative standard deviations determined for the mass flow rate of FIG. 15 over the flow rate of the gas or gas mixture;

FIG. 16B depicts a graph of relative standard deviations of determined mass flow rates over the pressure of the gas or gas mixture flowing through the entrainment region;

FIG. 17A depicts a graph of mass flow rates of a particulate material for different piston speeds and different flow rates of the gas or gas mixture flowing through the entrainment region;

FIG. 17B depicts a graph of mass flow rates of four different particulate materials supplied by the apparatus of FIG. 1 over the speed of a piston;

FIG. 18 depicts a graph of the relative standard deviations of mass flow rates over a second cross-sectional area of a second part of an entrainment of the apparatus of FIG. 1;

FIG. 19 depicts a graph of the relative standard deviations of mass flow rates over a first cross-sectional area of a first part of an entrainment region of the apparatus of FIG. 1;

FIG. 20 depicts a table summarising the measurements of the mass flow rates for four different particulate materials supplied by the apparatus of FIG. 1;

FIG. 21A depicts a graph of the velocity of the gas or gas mixture flowing through the entrainment region over the mass flow rates for different particulate materials;

FIG. 21B depicts a graph of the flow rate of the gas or gas mixture flowing through the entrainment region over the mass flow rates for different particulate materials;

FIG. 21C depicts a graph of the entrainment power over the mass flow rate for different particulate materials;

FIGS. 22A to 22C each depict a graph of the mass flow rate of a particulate material supplied by the supply device 8 of FIGS. 6A, 6B, 7B and 7C over time;

FIGS. 22D and 22E each depict a graph of the mass flow rate of another particulate material supplied by the supply device 8 of FIGS. 6A, 6B, 7B and 7C over time;

FIG. 23A depicts a plan view of an exemplary system for blending or mixing a plurality of particulate materials;

FIG. 23B depicts a perspective view of the system of FIG. 23A;

FIG. 23C depicts a sectional view of the system of FIG. 23A;

FIG. 24 depicts an exemplary flow diagram outlining the steps of a method of using the apparatus of FIG. 1;

FIG. 25 depicts an exemplary flow diagram outlining the steps of a method of manufacturing a product via additive manufacturing;

FIGS. 26 to 28 each depict a graph of a relative standard deviation that was determined for mass flow rates of different particulate materials supplied by the supply device of FIGS. 6A, 6B, 7A, 7B, 7C and 7I to 7K;

FIG. 29 depicts a graph of a mass flow rate of different particulate materials over a speed or velocity of the agitating device

FIGS. 30 to 32 each depicts a graph of mass flow rates of a particulate material supplied by the supply device of FIGS. 6A, 6B, 7A, 7B and 7C and 7I to 7K over time;

FIG. 33 depicts a table summarising the measured mass flow rates of croscarmellose sodium;

FIG. 34 depicts a table summarising the measured mass flow rates of magnesium stearate;

FIG. 35 depicts a table summarising the measured mass flow rates of paracetamol; and

FIG. 36 depicts an exemplary flow diagram outlining the steps of a method of using a supply device for supplying a particulate material at approximately or at a target mass flow rate.

### DETAILED DESCRIPTION

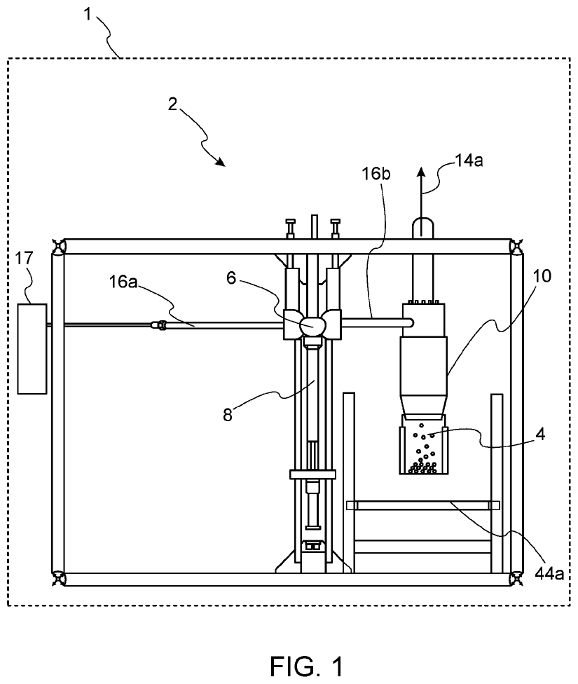

FIG. 1 shows an exemplary apparatus 2 for supplying a particulate material 4 at a target mass flow rate. The apparatus 2 may be provided in the form of dosing device or feeding device, such as a micro-feeder or a pneumatic micro-feeder. The particulate material 4 may be provided in the form of a powder. It will be appreciated that in other embodiments the particulate material may be provided in the form of a sand, shredded wood or the like. The apparatus 2 comprises an entrainment region 6 configured to entrain the particulate material 4 in a gas or gas mixture flowing through the entrainment region 6. The gas or gas mixture may be provided in the form of air. However, it will be appreciated that in other examples other gas or gas mixtures, such as nitrogen or the like, may be used. The entrainment region 6 may be provided in the form a tee piece, tubular or the like. The entrainment region 6 may be formed from plastic material, such as a polymer material. For example, the polymer material may comprise Perfluoroalkoxy alkanes (PFA) or the like. It will be appreciated that in other embodiments, the entrainment region may be formed from another material, such as a metal material or another plastic material and/or may be provided in another form than a tubular or tee piece.

It will be appreciated that the apparatus 2 disclosed herein may supply the particulate material at the target mass flow rate with minimal or reduced variations, as will be described below. The terms “at the target mass flow rate” may be understood as encompassing “at about or approximately the target mass flow rate.”

It will be appreciated that the term “entrain” may be understood as incorporating or mixing the particulate material in or with the gas or gas mixture. In other words, in the entrainment region may be understood as a region in which a particulate material-gas or gas mixture may be formed.

A cross-sectional area of at least a part of the entrainment region 6 is adjustable based on at least one of the particulate material 4. For example, the cross-sectional area of the part of the entrainment region 6 may be adjustable based on one or more properties of the particulate material 4. The one or more properties of the particulate material 4 may comprise a cohesion force between particles of the particulate material 4, a particle size of the particulate material 4, electrostatic charge of the particles of the particulate material 4, a particle shape of the particulate material 4, a compressibility of the particulate material 4, mechanical interlocking between the particles of the particulate material 4 and/or a density of the particulate material 4.

The apparatus 2 may be part of a pharmaceutical manufacturing system 1, which indicated in FIG. 1 by the dotted box. The pharmaceutical manufacturing system 1 may be configured to manufacture a drug or drug product. In such embodiments, the particulate material 4 may comprise an active ingredient or substance, such as a high-potency active pharmaceutical ingredient or the like. The pharmaceutical manufacturing system 1 may be or comprise a pharmaceutical 3D printing or a pharmaceutical additive manufacturing system. It will be appreciated that the apparatus disclosed is not limited to being part of or used in a pharmaceutical manufacturing system. For example, in other embodiments, the apparatus may be part of a food and/or beverage manufacturing system, a cosmetic product manufacturing system, a chemical system, such as a chemical reactor and/or the like. In such other embodiments, the particulate material may comprise a food ingredient or substance, a cosmetic ingredient or substance, a particulate reactant or particulate catalyst and/or the like. In such other embodiments, the manufacturing system may comprise a 3D printing manufacturing system or an additive manufacturing system.

For example, in pharmaceutical applications or other applications of the apparatus 2, it may be desirable to minimise a deviation or variation of the mass flow rate of the particulate material 4 from the target mass flow rate. The deviation or variation of the mass flow rate may be dependent on an entrainment energy or entrainment power. The entrainment energy or entrainment power may be understood as a minimum energy or power to pick up and/or entrain a particle of the particulate material 4 in the gas or gas mixture. One or more forces may be acting on each of the particles of the particulate material 4. For example, the forces may include an adhesion force, a drag force and a gravitational force. The sum of the forces may be proportional to the entrainment energy or entrainment power. As such, the entrainment energy or entrainment power may be dependent on the properties of the particulate material 4. In the present disclosure, the terms “entrainment energy” and “entrainment power” may be interchangeably used. It will be appreciated that power can be considered as an amount of energy transferred, e.g. on the particulate material, per time unit.

The entrainment energy or entrainment power may also be dependent on one or more properties of the gas or gas mixture flowing through the entrainment region. For example, the entrainment energy or entrainment power may be dependent on a velocity of the gas or gas mixture flowing through the entrainment region 6. The velocity of the gas or gas mixture may be dependent on a flow rate and/or pressure of the gas or gas mixture flowing through the entrainment region 6. When the velocity of the gas or gas mixture flowing through the entrainment region 6 is constant, e.g. substantially constant, a constant, e.g. substantially constant, entrainment energy or entrainment power may be supplied. This may cause an amount of particulate material 4 to be entrained in the gas or gas mixture. The inventors have found that adjustments or changes in the velocity of the gas or gas mixture flowing through the entrainment region 6 may result in changes in the mass flow rate of the particulate material 4. For example, an increase in the velocity of the gas or gas mixture may result in an increase in the entrainment energy or entrainment power, which in turn may cause an increase in the mass flow rate of the particulate material 4. A decrease in the velocity of the gas or gas mixture may result in a decrease in the entrainment energy or entrainment power, which in turn may cause a decrease in the mass flow rate of the particulate material 4. As such, changes or adjustments of the velocity of the gas or gas mixture flowing through the entrainment region 6 may cause changes or adjustments of the entrainment energy or entrainment power, which may result in changes or adjustments of the mass flow rate of the particulate material 4.

By providing the apparatus 2 with an adjustable cross-sectional area of at least a part of the entrainment region 6, the entrainment energy or entrainment power and/or the velocity of the gas or gas mixture flowing through in the entrainment region 6 may be adjusted, e.g. roughly adjusted, based on the particulate material 4. This may aid the reduction of variations or deviations in the mass flow rate of the particulate material 4 relative to the target flow rate, e.g. over time. This may allow for the apparatus 2 to supply the particulate material 4 at a mass flow rate of less than 10 g/h with minimal or reduced variations or deviations over time.

Additionally or alternatively, by providing the apparatus 2 with the adjustable cross-sectional area of the part of the entrainment region 6, based on the particulate material 4, a rate and/or efficiency of the entrainment of the particulate material 4 in the gas or gas mixture may be increased, the apparatus 2 may operable with different particulate materials, accumulation of the particulate material 4 in the entrainment region 6 may be reduced and/or a workload and/or gas or gas mixture consumption of a separation device 10, which will be described below, may be reduced.

The apparatus 2 comprises a supply device 8. The supply device 8 is configured to supply the particulate material 4 to the entrainment region 6 at or at approximately the target mass flow rate. The supply device 8 may be configured to supply the particulate material 4 to the entrainment region 6 at a constant, e.g. substantially constant, rate or speed. The supply device 8 may supply the particulate material 4 with some variations from the target mass flow rate. These variations may be reduced or minimised, for example by providing the apparatus 2 with an entrainment region 6, an adjustable cross-sectional area of at least a part of the entrainment region 6 and/or by adjusting the one or more properties of the gas or gas mixture flowing through the entrainment region 6.

In the embodiment shown in FIG. 1, the apparatus 2 comprises a separation device 10. As will be described below in more detail, the separation device 10 may be configured to receive the particulate material 4 entrained in the gas or gas mixture from the entrainment region 6 and to separate the particulate material 4 from the gas or gas mixture. Although FIG. 1 shows the apparatus 2 as comprising the separation device 10, it will be appreciated that in other embodiments, the apparatus may be provided without the separation device. For example, in such other embodiments, it may not be necessary to separate the particulate material from the gas or gas mixture. Such other embodiments may comprise crystal-seeding applications of the apparatus, mixing or blending applications, where a plurality of particulate materials may be mixed or blended together, or the like.

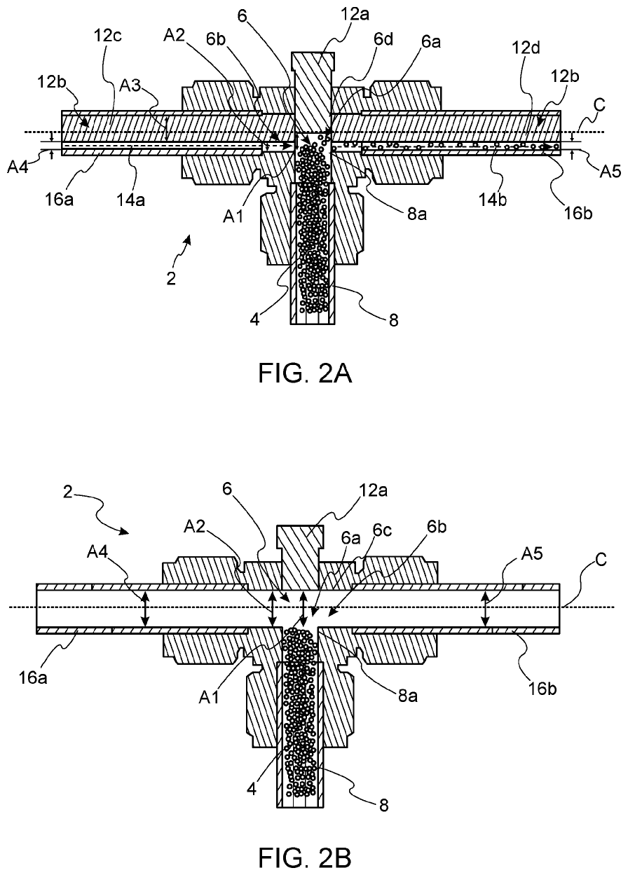

FIGS. 2A and 2B show cross-sectional views of the entrainment region 6 of the apparatus 2 shown in FIG. 1. The entrainment region 6 may comprise a first part 6a. The first part 6a of the entrainment region 6 may comprise a first cross-sectional area A1. The apparatus 2 may comprise a first restriction member 12a. The first restriction member 12a may be provided in the form of a plug or the like. The first restriction member 12a may be moveable into the first part 6a of the entrainment region 6 to adjust the first cross-sectional area A1 of the first part 6a of the entrainment region 6, e.g. based on the particulate material 4. The first restriction member 12a may be moveable between a first position, which is shown in FIG. 2A, and a second position, which is shown in FIG. 2B.

As shown in FIG. 2A, in the first position, the first restriction member 12a may extend or protrude into the first part 6a of the entrainment region 6. In the first position of the first restriction member 12a, the first cross-sectional area A1 of the first part 6a of the entrainment region 6 may be defined by the first restriction member 12a. The first position of the first restriction member 12a may be selected based on the particulate material 4. In other words, the first position of the first restriction member 12a may be different for different particulate materials 4. For example, an extension or protrusion, e.g. a degree or amount thereof, of the first restriction member 12a into the first part 6a of the entrainment region 6 may be selected based on the particulate material 4.

As shown in FIG. 2B, in the second position, the first restriction member 12a may be retracted from the first part 6a of the entrainment region 6. In the second position of the first restriction member 12a, the first cross-sectional area A1 of the first part 6a of the entrainment region 6 may be considered to be maximised and/or defined by the size or dimension of the entrainment region 6, e.g. the first part 6a thereof. The first restriction member 12a may be in line with a wall 6c of the entrainment region 6. When the first restriction member 12a is in the first position, the first cross-sectional area A1 of the first part 6a of the entrainment region 6 may be decreased, e.g. relative to the first cross-sectional area A1 of the first part 6a of the entrainment region 6, when the first restriction member 12a is in the second position. It will be appreciated that the first restriction member 12a may be moved into the second position for some particulate materials 4.

Based on the particulate material 4, the first restriction member 12a may be moveable between the first and the second position to adjust, e.g. to decrease or increase, the first cross-sectional area A1 of the first part 6a of the entrainment region 6. By adjusting the first cross-sectional area A1 of the first part 6a of the entrainment region 6, the properties of gas or gas mixture flowing through the entrainment region 6 may be adjusted, e.g. based on the particulate material. For example, a velocity of the gas or gas mixture flowing through the first part 6a of the entrainment region 6 may be adjusted, e.g. based on the particulate material 4. The first restriction member 12a may allow for an adjustment, e.g. a rough adjustment, of the entrainment energy or entrainment power in the entrainment region 6 based on the particulate material 4.

The wall 6c of the entrainment region 6 may comprise an opening 6d, which can be best seen in FIG. 2A. The first restriction member 12a may be arranged in the opening 6d. The first restriction member 12a may be arranged to be moveable relative to the opening 6d and the wall 6c. The first restriction member 12a and the opening 6d may be configured such that the opening 6d maintains a position of the first restriction member 12a. For example, in some embodiments, a size or dimension of the first restriction member 12c may be selected to correspond, e.g. substantially correspond, to a size or dimension of the opening 6d. For example, a diameter of the first restriction member 12a may correspond, e.g. substantially correspond, to a diameter of the opening 6d. The first restriction member 12a be arranged in the opening 6d such that the first restriction member 12a is moveable between the first and the second position, e.g. by applying a push or pull force to the first restriction member 12a.

Alternatively, the first restriction member 12a may comprise thread, such as a screw thread, configured to engage with a corresponding thread, such as a screw thread, of the opening 6d. In such embodiments, the first restriction member 12a may be arranged in the opening 6d such that the first restriction member 12a is moveable between the first and the second position, e.g. by rotating the first restriction member 12a relative to the opening 6d. By providing the first restriction member 12a and the opening 6d with corresponding threads, movement of the first restriction member between the first and second positions may be facilitated.

The entrainment region 6 may comprise a second part 6b. The second part 6b of the entrainment region 6 may comprise a second cross-sectional area A2. The apparatus 2 may comprise a second restriction member 12b. The second restriction member 12b may be provided in the form of one or more inserts. The second restriction member 12b may be configured to be removeably arranged in the second part 6b of the entrainment region 6. The second restriction member 12b may be configured to adjust the second cross-sectional area A2 of the second part 6b of the entrainment region 6. For example, the second restriction member 12b may be configured to decrease the cross-sectional area A2 of the second part 6b of the entrainment region 6. The second restriction member 12b may be configured to decrease the second cross-sectional area A2 of the second part 6b of the entrainment region by about 2% to 98%, such as by about 50%, 75% or 90%, as will be described below. For example, the second restriction member 12b may be configured to decrease the second cross-sectional area A2 from about 70 mm² to 1.4 mm². It will be appreciated that the apparatus disclosed herein is not limited to the exemplary values of the second cross-sectional area. For example, in other embodiments, the second cross-sectional area of the second part of the entrainment region may be larger or smaller than about 70 mm².

The apparatus 2 may be operable between a first configuration and a second configuration, e.g. based on the particulate material. FIG. 2A shows the first configuration of the apparatus 2. In the first configuration of the apparatus 2, the second restriction member 12b may be arranged in the second part 6b of the entrainment region 6. FIG. 2B shows the second configuration of the apparatus 2. In the second configuration of the apparatus 2, the second restriction member 12b may be absent or removed from the second part 6b of the entrainment region 6. When the apparatus 2 is in the first configuration, the second cross-sectional area A2 of the second part 6b of the entrainment region 6 may be decreased, e.g. relative to the second cross-sectional area A2 of the second part 6b of the entrainment region 6, when the apparatus 2 is in the second configuration.

The second cross-sectional area A2 of the second part 6b of the entrainment region 6 may be adjusted by operating the apparatus 2 between the first and the second configurations. An adjustment of the second cross-sectional area A2 of the second part 6b of the entrainment region may be dependent on a cross-sectional area A3 of the second restriction member 12b. The cross-sectional area A3 of the second restriction member 12b may be selected based on the particulate material 4. For example, the cross-sectional area of the second restriction member may be selected such that second cross-sectional area A2 of the second part 6b of the entrainment region 6 is decreased by about 2% to 98%, such as by about 50%, 75% or 90%, when the apparatus 2 is in the first configuration.

By adjusting the second cross-sectional area A2 of the second part 6b of the entrainment region 6 based on the particulate material 4, the properties of gas or gas mixture flowing through the entrainment region 6 may be adjusted. For example, a velocity of the gas or gas mixture flowing through the second part 6b of the entrainment region 6 may be adjusted, e.g. based on the particulate material 4. The second restriction member 12b may allow for an adjustment, e.g. a rough adjustment, of the entrainment energy or entrainment power the entrainment region 6 based on the particulate material 4.

The second restriction member 12b may be configured to extend along the second part 6b of the entrainment region 6. For example, the second restriction member 12b may be arranged to extend in a direction parallel, e.g. substantially parallel, to a central or longitudinal axis C of the apparatus 2, e.g. the entrainment region 6, e.g. when the apparatus 2 is in the first configuration. The second restriction member 12b may be configured to extend beyond the entrainment region 6.

In the embodiment shown in FIG. 2A, the second restriction member 12b comprises a first part 12c and a second part 12d. The first part 12c and the second part 12d of the second restriction member 12b may be arranged on either side of the first restriction member 6a, e.g. when the apparatus 2 is in the first configuration. The second restriction member 12b, e.g. the first and second parts 12c, 12d thereof, may comprise an elongated shape.

The apparatus 2 may comprise a first conduit 16a configured to direct the gas or gas mixture 14a from a gas or gas mixture supply 17 (shown in FIG. 1) to the entrainment region 6. The gas or gas mixture supply 17 may be part of or comprised in the pharmaceutical manufacturing system 1. The apparatus 2 may comprise a second conduit 16b configured to direct the particulate material entrained in the gas or gas mixture, e.g. the particulate material-gas mixture 14b, from the entrainment region 6 to the separation device 10. The gas 14a and particulate material-gas mixture 14b have been omitted from FIG. 2B for sake of clarity.

The second restriction member 12b may be configured to extend along the first and second conduits 16a, 16b. For example, the first part 12c of the second restriction member 12b may extend along the first conduit 16a. The first part 12c of the second restriction member 12b may be configured to adjust a cross-sectional area A4 of the first conduit 16a. This may allow for an adjustment, e.g. a rough adjustment, of the entrainment energy or entrainment power and/or prevent the formation of a back pressure in the first conduit 16a, which may cause particulate material 4 to enter the first conduit 16a.

The second part 12d of the second restriction member 12b may extend along the second conduit 16b. The second part 12d of the second restriction member 12b may be configured to adjust a cross-sectional area A5 of the second conduit 16b. This may allow for a velocity of the particulate-gas mixture 14b to be maintained, which may prevent settling of particulate material 4 in the second conduit 16b. Although FIG. 2A shows the first and second parts 12c, 12d of the second restriction member 12b as having the same cross-sectional area A2, it will be appreciated that in other embodiments a cross-sectional area of the first part of the second restriction member may be different from a cross-sectional area of the second part of the second restriction member. For example, the cross-sectional area of each of the first and second parts of the second restriction member may be selected based on the particulate material. It will be appreciated that in other embodiments, the second restriction member, e.g. the first and/or second parts thereof, may only extend along a part of the first and/or second conduits.

The second restriction member 12b, e.g. the first and second parts 12c, 12d thereof, may be configured to adjust the cross-sectional areas A4, A5 of the first and second conduits 16a, 16b. In this embodiment, the cross-sectional areas A4, A5 of the first and second conduits 16a, 16b is selected to correspond, e.g. substantially correspond, to the second cross-sectional area A2 of the second part 6b of the entrainment region 6. This may result in a velocity of the gas or gas mixture 14a and the particulate-gas mixture 14b being constant, e.g. substantially constant, in the first conduit 16a, the second conduit 16b, and the second part 6b of the entrainment region 6, respectively.

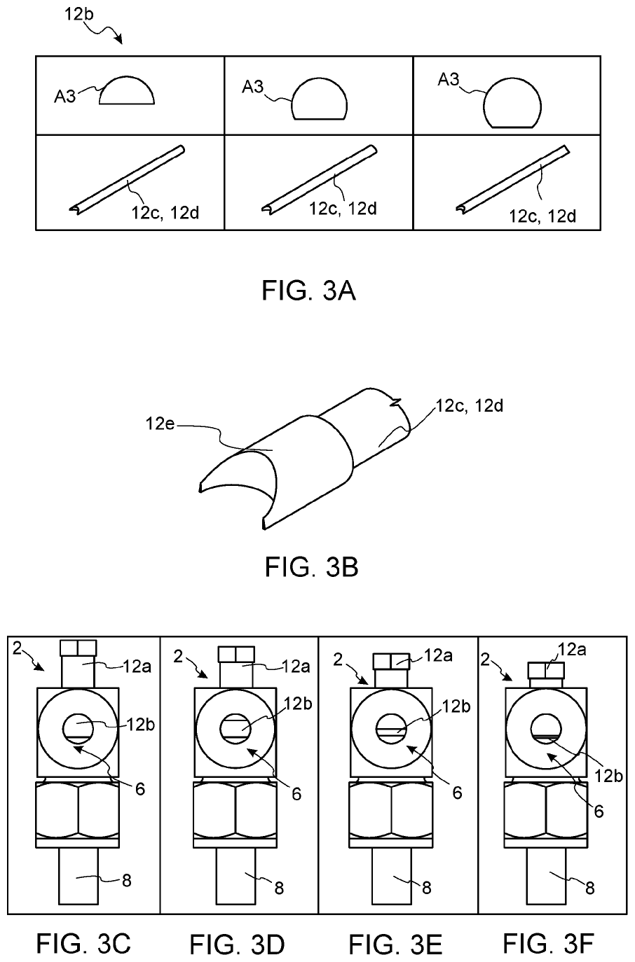

FIG. 3A shows a table of exemplary second restriction members 12b with varying cross-sectional areas for use in the apparatus 2 shown in FIGS. 1 and 2. The top row of FIG. 3A shows cross-sectional views of the second restriction members 12b and the bottom row of FIG. 3A shows perspective view of the second restriction members 12b.

A shape of the cross-sectional area A3 of the second restriction member 12b may correspond, e.g. substantially correspond, to a portion of a shape of the cross-sectional area A2 of the second part 6b of the entrainment region 6. The shape of the cross-sectional area A3 of the second restriction member 12b may correspond to a 50% portion, 75% portion or 90% portion of the shape of the cross-sectional area A2 of the second part 6b of the entrainment region 6. In other words, the second restriction member 12b may be configured to decrease the second cross-sectional area A2 of the second part 6b of the entrainment region 6 by 50%, 75% or 90%. It will be appreciated that in other embodiments, the second restriction member may be configured to decrease the second cross-sectional area A2 of the second part 6b of the entrainment region 6 by a different amount, such as an amount between 2% and 98%.

In the embodiment shown in FIGS. 2A and 2B, the cross-sectional area A2 of the second part 6b of the entrainment region 6 may be circular, e.g. substantially circular. The shape of the cross-sectional area A3 of the second restriction member 12b may correspond to a portion, e.g. a 50% portion, 75% portion, 90% portion or another portion, of a circular shape, as shown in FIG. 3A. A shape of the cross-sectional area A4 of the first and/or second conduit 16a, 16b may correspond, e.g. substantially correspond to the shape the cross-sectional area A2 of the second part 6a of the entrainment region 6. It will be appreciated that in other embodiments, the cross-sectional area of second part of the entrainment region, the first and/or second conduit may have a different shape, which may result in different shape of the cross-sectional area of the second restriction member. For example, in other embodiments, the cross-sectional area of second part of the entrainment region, the first and/or second conduit may be rectangular, hexagonal, square or the like, which may result in a corresponding shape of the second restriction member.

The entrainment region 6, first restriction member 12a, second restriction member 12b first conduit 16a and/or second conduit 16b may be formed using an additive manufacturing process. The entrainment region 6, first restriction member 12a, second restriction member 12b, first conduit 16a and/or second conduit 16b may be formed from a plastic material or from a metal material. The metal material may comprise a metal alloy, such a stainless steel, copper or the like. The plastic material may comprise a polymer material, such as Acrylonitrile butadiene styrene, Polytetrafluoroethylene, or the like, a polyester material, such as Polylactic acid or the like, or other plastic material.

FIG. 3B shows an end portion 12e of the second restriction member 12b. At least one or each of the first and second part 12c, 12d of the second restriction member 12b may comprise the end portion 12e. The end portion 12e may be arranged in the second part 6b of the entrainment region 6. The end portion 12e may be enlarged relative to a remainder of each of the first and second parts 12c, 12d of the second restriction member 12b. The shape of each of the first and second part 12c, 12d of the second restriction member 12b and/or the shape of the end portion 12e of each of the first and second part 12c, 12d of the second restriction member 12b may be selected such that a position of second restriction member 12b in the apparatus 2 may be maintained.

FIGS. 3C to 3F show cross-sectional views of the entrainment region 6 of the apparatus 2 with the first restriction member 12a in different positions. In the embodiment shown in FIGS. 3C to 3F, the apparatus 2 is in the first configuration. Expressed differently, the second restriction member 12b is arranged in the entrainment region 6. In FIG. 3C, the first restriction member 12a is in the second position, as described above. In FIGS. 3D to 3F, the first restriction member 12a is in the first position. In the example shown in FIG. 3D, the first position of the first restriction member 12a is selected such that the first cross-sectional area A1 of the first part 6a of the entrainment region 6 is decreased by about 30%. In the example shown in FIG. 3E, the first position of the first restriction member 12a is selected such that the first cross-sectional area A1 of the first part 6a of the entrainment region 6 is decreased by about 50%. In the example shown in FIG. 3F, the first position of the first restriction member 12a is selected such that the first cross-sectional area A1 of the first part 6a of the entrainment region 6 is decreased by about 66%. It will be appreciated that in other embodiments the first position of the first restriction member may be selected such that the first cross-sectional area of the first part of the entrainment region is decreased by a different amount than the exemplary amounts described above. For example, in other embodiments the first position of the first restriction member may be selected such that the first cross-sectional area of the first part of the entrainment region is decreased by about 95%.

In the embodiment shown in FIGS. 3C to 3F, the first cross-sectional area A1 may be adjusted between about 70 mm² (FIG. 3C) and about 20 mm² (FIG. 3F). It will be appreciated that the apparatus 2 disclosed herein is not limited to the exemplary values of the first cross-sectional area. For example, in other embodiments, the first cross-sectional area of the first part of the entrainment region may be larger or smaller than 70 mm².

Referring to FIGS. 2A and 2B, the supply device 8 may be arranged to supply the particulate material 4 to the first part 6a of the entrainment region 6a. For example, the supply device 8 may be arranged such that an outlet 8a of the supply device 8 is arranged in the first part 6a of the entrainment region and in proximity to the first restriction member 12a. For example, the first restriction member 12a may be arranged opposite the outlet 8a of the supply device 8.

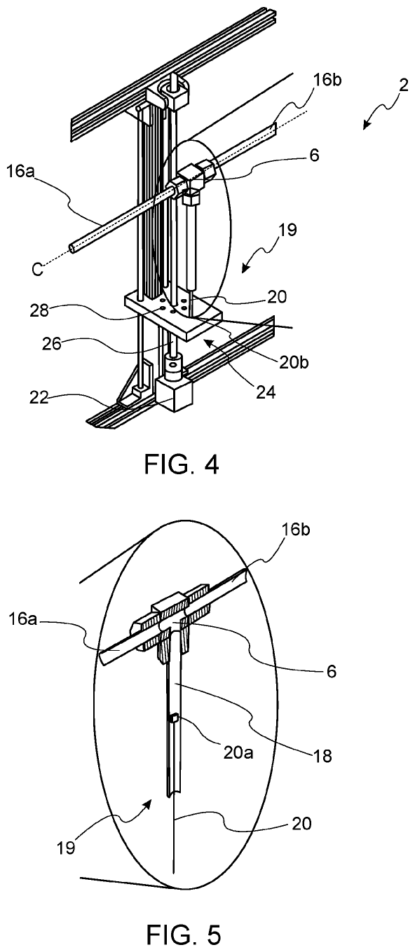

FIG. 4 shows an exemplary supply device 8 for use in the apparatus 2 shown in FIG. 1. FIG. 5 shows a portion of the supply device 8 shown in FIG. 4.

In this embodiment, the supply device 8 may be provided in the form of a particulate material pump. The supply device 8 may comprise a container 18 for holding the particulate material 4. In this embodiment, the container 18 may be provided in the form of a cylinder or barrel or the like. The supply device 8 may comprise a moving arrangement 19 configured to move the particulate material 4 from the container 18 to the entrainment region 6.

The supply device 8 may comprise a piston 20. The piston 20 may be configured to move the particulate material 4 in the container 18 to the entrainment region 6. The piston 20 may be part of or comprised in the moving arrangement 19. The piston 20 may be arranged such that a first end 20a of the piston 20 is moveable within the container 18, e.g. to move the particulate material 4 from the container 18 to the entrainment region 6.

The supply device 8 may comprise an actuator 22. The actuator 22 may be provided in the form of a motor, such as a step motor. The actuator 22 may be part of or comprised in the moving arrangement 19. The actuator 22 may be configured to move, e.g. to rotate, another part of the supply device 8, as will be described below. The actuator 22 may be configured such that one revolution per minute of the actuator 22 is equal to one millimetre per minute of a speed of the piston 20.

The supply device 8 may comprise a coupling arrangement 24 for converting movement of the actuator 22 to movement of the piston 20, e.g. the first end 20a of the piston 20 in the container 18. For example, the coupling arrangement 24 may be configured to convert rotational movement imparted by the actuator 22 into translational movement of the piston 20. The coupling arrangement 24 may be part of or comprised in the moving arrangement 19.

The coupling arrangement 24 may comprise a shaft 26. The shaft 26 may be connected to the actuator 22. The actuator 22 may be configured to rotate the shaft 26. The coupling arrangement 24 may comprise an engagement plate 28 connected to the shaft 26 and configured to engage with the piston 20, e.g. a second end 20b of the piston 20. The shaft 26 may comprise a thread (not shown) configured to cooperate with a thread of the engagement plate 28, e.g. so that when the actuator 22 rotates the shaft 26, the engagement plate 28 moves along the shaft 26. The coupling arrangement 24 may be configured such that movement of the engagement plate 28 causes movement of the piston 20, e.g. the first end 20a thereof, in the container 18. For example, movement of the engagement plate 28 in a first direction causes movement of the first end 20a of the piston 20 towards the entrainment region 6. This may result in particulate material 4 being compressed, moved and/or supplied to the entrainment region 4 for entrainment in the gas or gas mixture 14. Movement of the engagement plate 28 in a second direction causes movement of the first end 20a of the piston 20 away from the entrainment region 6. The second direction may be opposite to the first direction. Movement of the engagement plate 28 in the second direction may allow for removal of the piston 20 from the container 18, e.g. to allow for refilling of the particulate material 4. The supply device 8 shown in FIGS. 4 and 5 may supply the particulate material 4 in one or more batches.

The supply device 8 may be arranged to e.g. perpendicular, e.g. substantially perpendicular, to the longitudinal axis C of the apparatus 2, e.g. the entrainment region 6. The first and second directions described above may be perpendicular, e.g. substantially perpendicular, to the longitudinal axis C of the apparatus 2, e.g. the entrainment region.

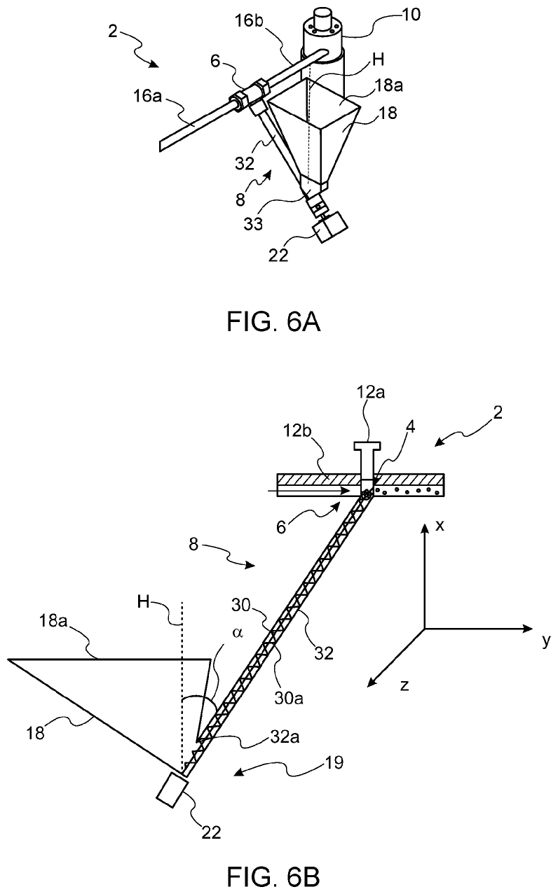

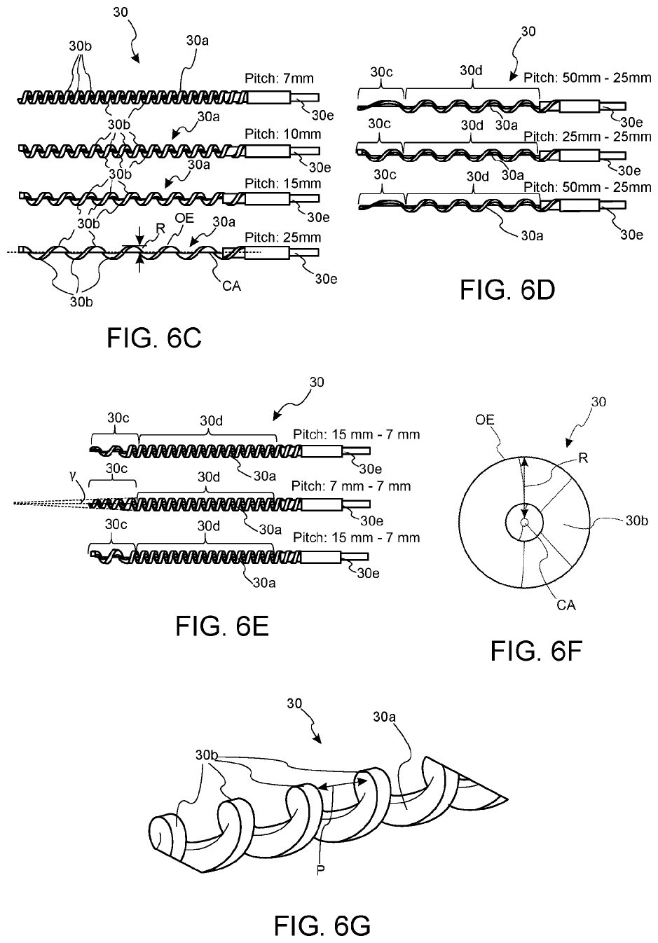

FIGS. 6A and 6B show another exemplary supply device 8 for use in the apparatus 2 shown in FIGS. 1 and 2. In this embodiment, the supply device 8 is configured to allow for a continuous supply of particulate material 4 to the entrainment region 6. However, as will be described below, the supply device 8 may also be used on its own, e.g. without the entrainment region 4.

The supply device 8 may comprise a container 18 for holding the particulate material 4. The container 18 may be provided in the form of a hopper or the like. The supply device 8 may comprise a moving arrangement 19 configured to move the particulate material 4 from the container 18 to the entrainment region 9.

The supply device 8 comprises an actuator 22, which may be provided in the form of a motor or step motor. The supply device 8 comprises a shaft 30 coupled to the actuator 22. The shaft 30 may comprise a helical or spiral structure 30a, which may be arranged along a length of the shaft. The shaft may also be referred to a helical or spiral shaft or helical or spiral member. The helical or spiral structure 30a may be provided in the form of screw thread, spiral screw thread, auger or the like. The shaft 30, e.g. the helical or spiral structure 30a, may comprise a pitch. The pitch of the shaft 30, e.g. helical or spiral structure 30a, may be understood as a distance between adjacent crests or crest portions of the screw thread or spiral screw thread, auger or the like. The pitch of the shaft 30, e.g. helical or spiral structure 30a, may be in the region of 5 mm to 50 mm, such as 7 mm, 10 mm, 15 mm or 25 mm. It will be appreciated that in other embodiments the pitch may be different from the exemplary values disclosed herein. The actuator 22 and the shaft 30 may be part of or comprised in the moving arrangement 19.

The supply device 8 comprises a housing 32. The shaft 30 may be arranged in the housing 32. The container 18 may be connected to an outside of the housing 32. For example, the housing 32 may comprise an opening 32a. The container 18 may be connected to the housing 32 so that particulate material 4 may enter the housing 32, e.g. through the opening 32a thereof. The actuator 22 may be configured to rotate the shaft 30 so that particulate material 4 entering the housing 32 is moved by the helical structure 30a of the shaft 30 to the entrainment region 6. In other words, the shaft 30, e.g. the helical or spiral structure 30a, may act as a conveyor for the particulate material 4 to the entrainment region 6.

The container 18 comprises an opening 18a for filling the particulate material 4 in the container 18. By connecting the container 18 to the outside of the housing 32, the container 18 may be refilled during operation of the apparatus 2, e.g. without affecting an accuracy of the mass flow rate of the particulate material 4. This may also allow for a continuous supply of particulate material 4 to the entrainment region 6.

The supply device 8 may comprise a connecting portion 33. The connecting portion 33 may be configured to connect the container 18 to the housing 32. The connecting portion may be configured to connect the container 18 to the housing such that particulate material 4 may enter the housing 32 through the opening 32a thereof.

The moving arrangement 19, e.g. the shaft 30, housing 32 and/or actuator 22, may be arranged at an angle α relative to a longitudinal axis H of the container 18. The longitudinal axis H of the container 18 may extend in a vertical direction, which is indicated as the x-direction in FIG. 6B. The angle α may be between 0 degrees and 180 degrees. In the embodiment shown in FIGS. 6A and 6B, the angle α is about 60 degrees. By arranging the moving arrangement 19, e.g. the shaft 30, at an angle α relative to the longitudinal axis H of the container 18, variations in the mass flow rate of the particulate material 4 supplied by the supply device 8 may be reduced.

FIGS. 6C to 6G show exemplary shafts 30 for use in a supply device, such as the supply device 8 shown in FIGS. 6A and 6B. The shafts 30 shown in FIGS. 6C to 6G may comprise any of the features of the shaft 30 described above.

For example, FIGS. 6C to 6E show side views of the shafts 30a. FIG. 6F shows a front view of one of the shafts shown in FIG. 6C. Each of the circles around the central axis CA in FIG. 6F is indicative of a gap, which may be necessary for forming the shaft. FIG. 6G shows a perspective view of one of the shafts shown in FIG. 6C. Each of the exemplary shafts 30 shown in FIGS. 6C to 6G comprises a respective helical or spiral structure 30a. Each of the exemplary shafts 30 comprises a plurality of crest portions 30b, which are indicated in FIGS. 6C, 6F and 6G only for sake of clarity. The plurality of crest portions 30b form the helical or spiral structure 30a. Each shaft 30 is configured such that each crest portion extends between a central axis CA and an outer edge OE of the shaft 30. For example, a radius R of each of the plurality of crest portions 30b extends between the central axis CA of each shaft 30 and the outer edge OE of each of shaft 30, as shown in FIGS. 6C and 6F. A diameter of each shaft 30 may be between about 5 mm and 15 mm. As such, the radius R of each shaft 30c may be between 2.5 mm and 7.5 mm, such as between about 4 mm and 4.5 mm, such as 4.3 mm. However, it will be appreciated that in other embodiments the radius or diameter of the shaft may be different from the exemplary values disclosed herein.

Each shaft comprises a configuration between an auger and a spiral screw. For example, each shaft may not have a central shaft or may be considered to be shaft-free. By configuring the helical or spiral structure 30a such that each crest portion extends between the central axis CA and the outer edge OE of the helical or spiral structure 30a, compression of the particulate material, e.g. due to shear stress on a wall of a central shaft may be reduced.

Additionally, a centre of each shaft 30 may be solid and/or not hollow. This may reduce or prevent particulate material dropping into the housing 32, which in turn may minimise variations in a mass flow rate of the particulate material 4 supplied by the supply device 8.

Each shaft 30 is configured such that such that a portion of particulate material (not shown in FIGS. 6C to 6G) is receivable between adjacent crest portions 30b. As described above, a distance between adjacent crest portions 30b may be understood as a pitch P of the helical or spiral structures 30a. The pitch P is indicated in FIG. 6G.

FIG. 6C shows four exemplary shafts 30, each of which has a different pitch. FIG. 6C shows a shaft 30 having a pitch of 7 mm, a shaft 30 having a pitch of 10 mm, a shaft 30 having a pitch of 15 mm and a shaft 30a having a pitch of 25 mm. The pitch of the shaft 30a may be selected based on the particulate material. For example, a shaft 30 having a pitch between 7 mm and 15 mm may aid the supply and/or moving of a cohesive and/or non-flowing particulate material. A shaft 30 having a pitch between 25 mm and 50 mm may aid the supply and/or moving of a cohesive and/or non-flowing particulate material. It will be understood that the shaft 30 disclosed herein is not limited to the exemplary pitch values described herein. In other embodiments, the shaft may comprise a different pitch.

FIG. 6D shows another three exemplary shafts 30. As described above, the pitch of the shaft 30 may be selected based on the particulate material. In addition, a configuration, such as an arrangement or a shape, of the shaft 30 may be selected based on the particulate material. For example, a configuration, such as an arrangement or a shape, of at least a portion of the shaft 30 may be selected based on the particulate material. In this embodiment, the portion comprises an end portion 30c of the shaft 30. The end portion 30c may be or comprise a free end of the shaft 30 and/or a portion of the shaft 30 proximal to the entrainment region 6 or another location, such as a desired location or a location the particulate material is to be moved to.

As shown in FIG. 6C, the configuration, e.g. the arrangement or shape, of the end portion 30c may be the same as configuration, e.g. an arrangement or shape, of a remainder 30d of the shaft 30. For example, the pitch P of the shaft 30 may be constant, e.g. along a length of the central axis CA, e.g. as shown in FIG. 6C. Alternatively, the pitch P of the shaft 30, e.g. the helical or spiral structure 30a, may change or vary along a length of the central axis CA. As such, as a configuration, e.g. an arrangement or shape, of the end portion 30c may be different relative to a configuration, e.g. an arrangement or shape, of a remainder 30d of the shaft 30. For example, a pitch P of the end portion 30c may be different relative to a pitch of the remainder 30d of the shaft 30. The pitch P of the end portion may be larger relative to the pitch P of the remainder 30d of the shaft 30.

For example, the pitch of the end portion 30c of the shafts 30 shown on the top and bottom of FIG. 6D is about 50 mm, whereas the pitch of the remainder 30d of each of these shafts 30 is about 25 mm. However, it can be seen that a radius of the crest portions 30b of end portion 30c of the shaft 30 shown on the top of FIG. 6D is different relative to a radius of the crest portions 30b of the remainder 30d of the shaft 30. For example, the radius of the crest portions 30b of end portion 30c of the shaft 30 may gradually decrease relative to the radius of the crest portions 30b of the remainder 30d of the shaft 30. For example, the shaft 30 may be configured such that the end portion 30c tapers, e.g. towards the free end of the shaft 30. An angle γ of the taper may be between 2° and 3°, such as about 2.5°. However, it will be appreciated that in other embodiments, the angle of the taper may be between 2° and 10°, such as about 5°. The angle γ of the taper is indicated in FIG. 6E. The shaft 30 comprising a tapered end portion 30c may also be referred to as a compression shaft, which may aid the supply and/or moving of a non-flowing particulate material. The shaft 30 without the tapered end portion 30c may also be referred to as a non-compression shaft, which may aid the supply and/or moving of a cohesive particulate material.

The pitch of the shaft 30 shown in the middle of FIG. 6D is constant along the length of the central axis CA. However, it can be seen that a radius of the crest portions 30b of the end portion 30c of the shaft 30 shown in the middle of FIG. 6D gradually decreases relative to the radius of the crest portions of the remainder 30d of the shaft 30. For example, this shaft 30 may also be configured such that the end portion 30c tapers, as described above.

FIG. 6E shows another three exemplary shafts 30. The pitch of each of the three exemplary shafts 30 is decreased relative to the three exemplary shafts 30 shown in FIG. 6D. For example, the pitch of the end portion 30c of the shaft 30 shown on the top and bottom of FIG. 6E is about 15 mm, whereas the pitch of the remainder 30d of these shafts 30 is about 7 mm. However, it can be seen that the radius of the crest portions 30b of the end portion 30c of the shaft 30 shown on the top of FIG. 6E gradually decreases relative to the radius of the crest portions of the remainder 30d of the shaft 30. The pitch of the helical or spiral structure 30a shown in the middle of FIG. 6E is constant along the length of the central axis. However, it can be seen that a radius of the crest portions 30b of end portion 30c of the shaft 30 shown in the middle of FIG. 6E gradually decreases relative to the radius of the crest portions of the remainder 30d of the shaft 30. As such, each of the shafts 30 shown on the top and in the middle of FIG. 6E are configured such that the respective end portion 30c tapers, as described above.

It will be appreciated that in other embodiments, the pitch of the end portion may be smaller relative to the pitch of the remainder of the shaft.

Each of the shafts 30 may comprise a connection portion 30e configured to connect each shaft 30 to a respective actuator 22. Each shaft 30 may be configured such that each helical or spiral structure 30 extends from a respective connection portion 30e. The helical or spiral structure 30a and the connection portion 30e may be coaxially arranged.

The shafts 30 described herein may minimise variations of the mass flow rate of particulate material supplied by the supply device 8.

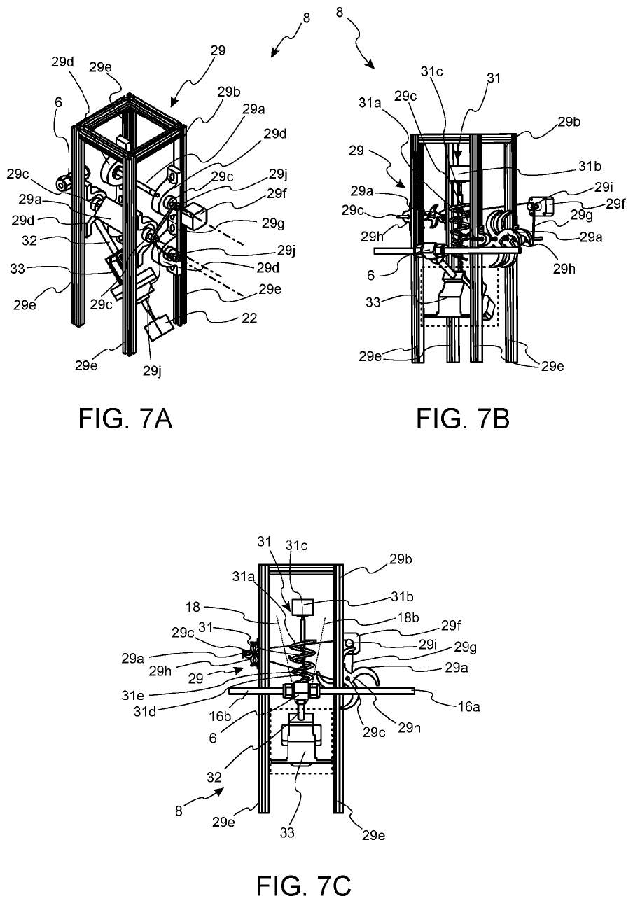

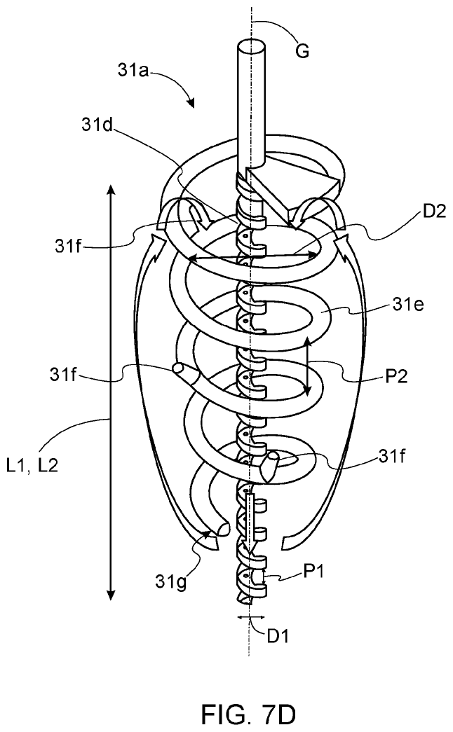

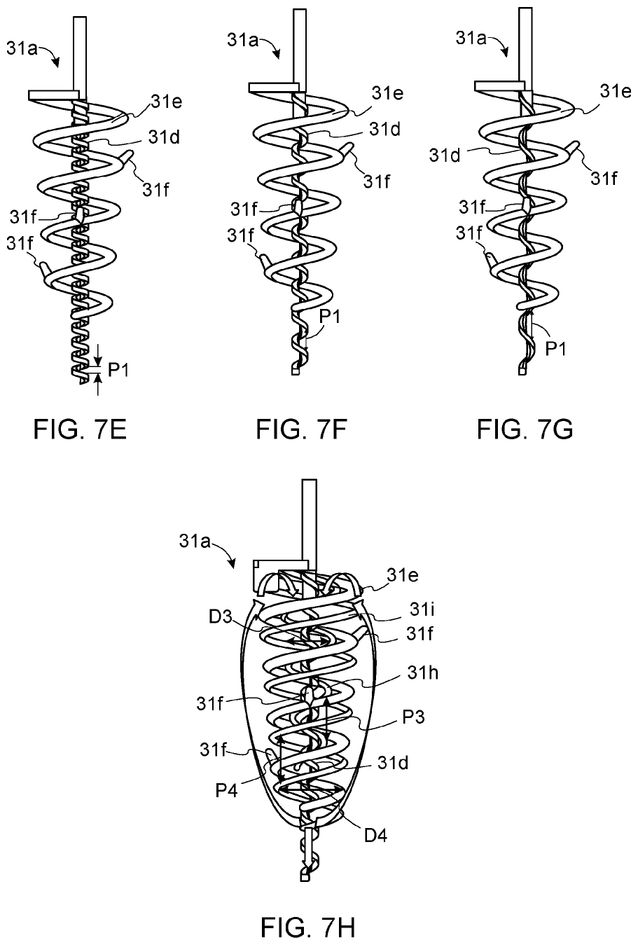

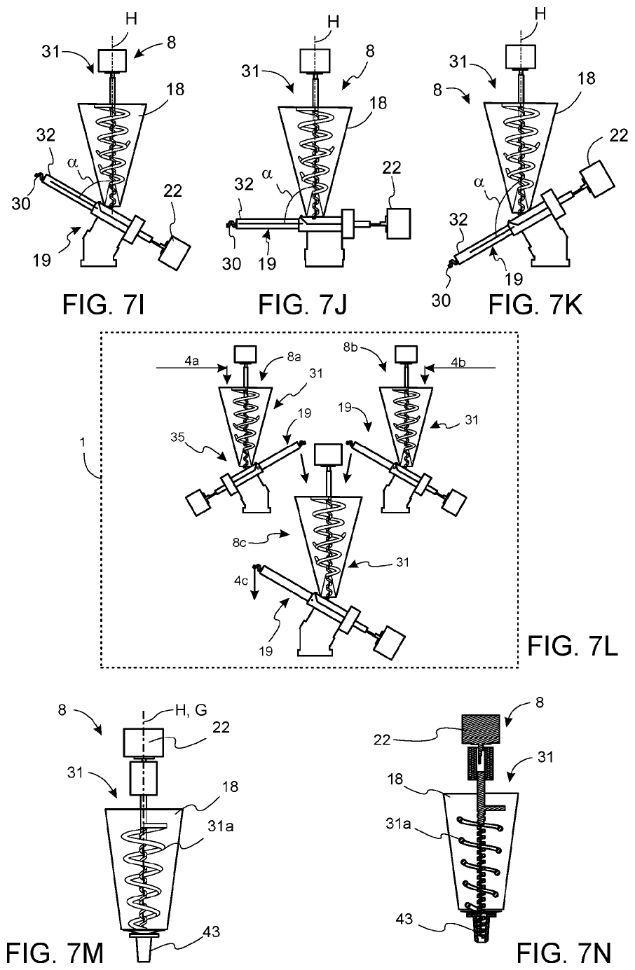

FIGS. 7A to 7C show other exemplary supply devices 8 for use in the apparatus 2 shown in FIGS. 1 and 2. The supply devices 8 shown in FIGS. 7A to 7C may be similar to the supply devices 8 shown in FIGS. 4 to 6B. As such, the supply devices 8 shown in FIGS. 7A to 7C may comprise any of the features of the supply devices 8 shown in FIGS. 4 to 6B. Only differences will be described in the following.

The container 18 comprises one or more walls 18b. In some embodiments, at least one of the walls 18b of the container 18 may be formed from a flexible material. The flexible material may comprise a plastic material, such as polyethylene or the like, or a polymer material, such polyurethane or the like. In such embodiments, the supply device 8 may comprise a support arrangement 29 configured to support and/or move the at least one of the walls 18b of the container 18. For example, the support arrangement 29 may be configured to move the at least one of the walls 18b to aid movement of the particulate material in the container 18. The support arrangement 29 may be configured to engage with and/or to support the at least one of the walls 18b to prevent arching of the at least one of the walls 18b. This may reduce accumulation of the particulate material 4 on one or more walls 18b of the container 18. The container 18 and the walls thereof are indicated by the dashed lines in FIG. 7C.

The support arrangement 29 may comprise one or more supporting elements 29a. The supporting elements 29a may be provided in the form of plates, blades, paddles or the like. Each supporting element 29a may comprise a bearing. The support arrangement 29 may comprise a frame 29b. The support elements 29a may be moveably coupled to the frame 29b. For example, the support arrangement 29 may comprise one or more shafts 29c. One or more support elements 29a may be mounted on a respective shaft 29c. Each shaft 29c may be moveably connected to the frame 29b. The support arrangement 29 may comprise one or more connecting elements 29d, which may be provided in the form of one or more brackets. Each connecting element 29d may comprise or define a bearing. The connecting elements 29d may be configured to moveably connect each shaft 29c to the frame 29b. For example, a pair of connecting elements 29d may be configured to connect a shaft 29c to the frame 29b.

The frame 29b may comprise a plurality of legs 29e, four of which are shown in FIGS. 7A to 7C. The pair of connecting elements 29d may be configured to moveably connect the respective shaft 29c to the frame 29b such that the shaft 29c spans across a pair of legs 29e of the frame 29b.

The frame 29b may be arranged such that the frame 29b surrounds the container 18. Expressed differently, the frame 29b may be arranged such that the container 18 is located inside the frame 29b and/or the support elements 29a can engage with an outside of the at least one of the walls 18b of the container 18. The pair of connecting elements 29d may be configured to moveably connect the shaft 29c to the frame 29b, e.g. the legs 29e thereof, such that the support elements 29a engage with the at least one of the walls 18b of the container 18.

The support arrangement 29 may comprise an actuator 29f, such as a motor or step motor the like. The actuator 29f may be configured to move, e.g. rotate, the shafts 29c and the support elements 29a mounted thereon. For example, the actuator 29f may be connected to the frame 29b, e.g. a leg 29e thereof. The actuator 29f may be coupled to one or more of the shafts 29c to move, e.g. rotate, the shafts 29c.

For example, as shown in FIG. 7A, the actuator 29f may be connected to a first shaft 29c to move, e.g. rotate, the first shaft 29c. The actuator 29f may be coupled to the remaining shafts 29c, e.g. by a first coupling element 29g. The first coupling element 29g may be provided in the form of a belt or band. The support arrangement 29 may comprise one or more second coupling elements 29j. The second coupling elements 29j may be provided in the form of pulleys, wheels or the like. The second coupling element 29j may be configured to engage with the first coupling element 29g. Each second coupling element 29j may be mounted on a respective shaft 29c. The first and second coupling elements 29g, 29j may be configured to transfer movement, e.g. rotational movement, of the first shaft 29c, which may be imparted by the actuator 29f, to each of the remaining shafts 29c. The second coupling elements 29j have been indicated in FIG. 7A only for sake of clarity. However, it will be appreciated that the supply device shown in FIGS. 7B and 7C may also comprise the second coupling elements. It will be appreciated that in other embodiments the support arrangement may comprise one or more different coupling elements. For example, in other embodiments, the coupling elements may be provided in the form of cog wheels, gears or the like.

In the embodiment shown in FIG. 7A, the support elements 29a are provided in the form of paddles or plates. In this embodiment, the support arrangement comprises three shafts 29c. Each support element 29a is mounted to a respective shaft 29c. Each shaft 29c is connected to the frame 29b by a pair of connecting elements 29d. Two of the shafts 29c are connected to one side of the frame and the remaining shaft 29c is connected opposite to the two shafts 29c.

In the embodiments shown in FIGS. 7B and 7C, the supporting elements 29a are provided in the form of blades of a propeller 29h. In this embodiment, the support arrangement 29 comprises two shafts 29c. The two shafts 29c are connected to opposite sides of the frame 29b, e.g. by the connecting elements 29d. Two propellers 29h comprising the support elements 29a are mounted on one of the two shafts. Three propellers 29h comprising the support elements 29a are mounted on the other of the two shafts 29c. It will be appreciated that in other embodiments more than or less than two or three propellers or support elements may be mounted on a shaft. In this embodiment, the support elements 29a mounted on one of the two shafts 29c have a different size, e.g. a larger size, than the support elements 29a mounted on the other of the two shafts 29c. It will be appreciated that in other embodiments, the support elements are of the same size.

In this embodiment, a further shaft 29i is connected to the actuator 29f. The actuator 29f is coupled to each of the two shafts 29c by the first and second coupling elements 29g, 29j. The first and second coupling elements 29g, 29j may be configured to transfer movement, e.g. rotational movement, of the further shaft 29i, which may be imparted by the actuator 29f, to each of the two shafts 29c.

As shown in FIG. 7C, the support elements 29a may be arranged, e.g. coupled, to the frame 29b so as to engage the at least one of the walls 18b of the container 18. The support elements 29b may be configured to move the at least one of the walls 18b of the container 18, e.g. to aid movement of the particulate material 4 in the container 18. For example, movement of the support elements 29a, as described above, may cause movement of the at least one of the walls 18b of the container 18. This may reduce accumulation of the particulate material on the walls 18b of the container 18.

The support elements 29a may be configured to support the at least one of the walls 18b of the container 18. As described above, the at least one of the walls 18b of the container 18 may be formed from the flexible material. By engaging the support elements 29a with the at least one of the walls 18b of the container 18, arching of the at least one of the walls 18b of the container may be reduced or prevented. This may also reduce accumulation of the particulate material 4 on the at least one of the walls 18b of the container 18.

Although FIGS. 7A to 7C show the support arrangement 29 as comprising two or three shafts, it will be appreciated that in other embodiments, the support arrangement may comprise a shaft and a support element mounted thereon. In such other embodiments, the actuator may be coupled or connected to the shaft and/or the shaft may be connected to the frame by a pair of connecting elements.

The supply device 8 may comprise an agitating device 31. FIGS. 7B and 7C shown an exemplary supply device 8 comprising the agitating device 31. The agitating device 31 may be configured to move the particulate material 4 in the container 18. The agitating device 31 may be configured to agitate the particulate material 4, e.g. to aid movement of the particulate material 4 in the container 18. The agitating device 31 may be configured to regulate a supply of particulate material 4 from supply device 8. For example, the agitating device 31 may be configured to move a portion of the particulate material 4 towards the moving arrangement 19. The agitating device may be configured to regulate or control an amount of the particulate material 4, e.g. a mass flow rate of the particulate material 4, moved to the moving arrangement 19.

By providing the supply device 8 with an agitating device 31, an accuracy in supplying the particulate material 4 by the supply device 8 may be improved. The agitating device 31 may aid the supply of a cohesive particulate material 4.

At least a portion 31a of the agitating device 31 may be arranged in the container 18. The portion 31a of the agitating device 31 may be or comprise a spiral or helical portion. The agitating device 31 may be configured such that the portion 31a of the agitating device is moveable, e.g. rotatable, in the container 18. For example, the agitating device 31 may comprise an actuator 31b. The actuator 31b may be provided in the form of a motor or step motor. The agitating device 31 may comprise a shaft 31c. The shaft 31c may be configured to couple the portion 31a of the agitating device 31 to the actuator 31b. The actuator 31b may be configured to move, e.g. rotate, the shaft 31c. Movement, e.g. rotation, of the shaft 31c may cause movement, e.g. rotation of the portion 31a of the agitating device 31, thereby agitating the particulate material 4 in the container 18. It will be appreciated that in other embodiments, the actuator may be differently arranged relative to the agitating device. In such other embodiments, the actuator is configured to move or rotate the portion of the agitating device.

FIG. 7D shows the portion 31a of the agitating device 31 shown in FIGS. 7B and 7C. The portion 31a of the agitating device 31 may comprise a first or inner spiral portion 31d. The portion 31a of the agitating device 31 may comprise a second or outer spiral or helical portion 31e. The first or inner spiral portion and the second or outer spiral portion may be coaxially arranged. The first or inner spiral portion 31d may comprise a first diameter D1. The first or inner spiral portion 31d may be configured such that the first diameter D1 is constant, e.g. substantially constant, along a length L1 of the first or inner spiral portion 31d.

The second or outer spiral or helical portion 31e may comprise a second diameter D2. The second or outer spiral portion 31e may be configured such that the second diameter D2 changes, e.g. decreases, along a length L2 of the second or outer spiral portion. For example, the second diameter D2 may decrease, e.g. gradually decrease, in a direction towards the moving arrangement 19 or a free end 31g of the second or outer spiral portion 31e. For example, the second or outer spiral portion 31e may be configured to taper, e.g. towards the free end 31g of the second or outer spiral portion 31e. An angle of the taper may be between 2° and 10°, such as about 5°. However, it will be appreciated that in other embodiments the taper angle of the second or outer spiral portion may be different from the exemplary values disclosed herein.

The second diameter D2 measured at a top or distal to the free end 31g of the second or outer spiral portion 31e may be between about 30 mm and 80 mm, such as about 50 mm.

The first diameter D1 may be different from the second diameter D2. For example, the first diameter D1 may be smaller than the second diameter D2. For example, the first diameter D1 may be between about 5 mm and 15 mm, such as about 8.5 mm. The second or outer helical or spiral portion 31e may be arranged to surround the first or inner spiral portion 31d. It will be appreciated that in other embodiments, the portion may comprise a single spiral portion or more than two spiral portions. Additionally, in other embodiments, the first or inner spiral portion may be configured such that the first diameter changes, e.g. decreases, along a length of the first or inner spiral portion. For example, the first diameter may decrease, e.g. gradually decrease, in a direction towards the moving arrangement or a free end of the first or inner spiral portion. In such other embodiments, the first or inner spiral portion may be configured to taper, e.g. towards the free end of the first or inner spiral portion. An angle of the taper may be between 2° and 10°, such as about 2.5° or 5°. Alternatively or additionally, the first or inner spiral portion may be configured such that at least a portion, such as an end portion, of the first or inner spiral portion comprises a radius that is different from a radius of a remainder of the first or inner spiral portion. For example, the first or inner spiral portion may comprise any of the features of any of the shafts, e.g. the helical or spiral structure, described above in relation to FIGS. 6B to 6G.

The first or inner spiral portion 31d may comprise a first pitch P1. The second or outer spiral or helical portion 31e may comprise a second pitch P2. The first pitch P1 may be different from the second pitch. For example, the first pitch P1 may be smaller than the second pitch P2. The first pitch P1 may be between about 5 mm and about 50 mm, such as 7 mm, 10 mm or 15 mm. The second pitch P2 may be between about 20 mm and 30 mm, such as 25 mm. The term “pitch” may be understood as a distance between adjacent crests or crest portions of the inner or outer spiral portions 31d, 31e. The terms “pitch” and “distance between adjacent crest portions” may be interchangeably used. The first and/or second pitch P1, P2 and/or the first and/or second diameter D1, D2 may be selected based on the particulate material.

The agitating device 31 may be configured to move at least some or a portion of the particulate material 4 in the container 18 in a first direction, e.g. towards the moving arrangement 19. The agitating device 31 may be configured to move at least some or a portion of the particulate material 4 in the container 18 in a second direction, e.g. away from the moving arrangement 19. The first and second directions may be parallel, e.g. substantially parallel, to a longitudinal axis G of the agitating device 31. The first direction may be opposite to the second direction. For example, the first or inner spiral portion 31d may be configured to move the portion of the particulate material 4 in the first direction. For example, the first pitch P1 and/or the first diameter D1 of the first or inner spiral portion 31d may be selected such that first or inner spiral portion 31d moves the particulate material 4, e.g. the portion thereof, in the first direction. The second or outer spiral portion 31e may be configured to move the portion of the particulate material 4 in the second direction. For example, the second pitch P2 and/or the second diameter D2 of the second or outer spiral portion 31e may be selected such that second or outer spiral portion 31e moves the particulate material 4, e.g. the portion thereof, in the second direction.

The first or inner spiral portion 31d may be configured to move the particulate material 4, e.g. the portion thereof, towards the moving arrangement 19. The first or inner spiral portion 31d may be configured to regulate or control an amount of the particulate material to the moving arrangement 19, e.g. the shaft 30 thereof. The second or outer spiral portion 31e may be configured to move the particulate material 4, e.g. the portion thereof, away from the moving arrangement 19. This may allow for circulation, e.g. circulation in the vertical direction or direction of the longitudinal axis G of the agitating device 31, of the particulate material 4 in the container 18. The agitating device 31 may homogenise a density of the particulate material 4 in the container 18 and/or prevent the formation of rat holes in the particulate material 4 and/or bridging of the particulate material in the container 18.

The second or outer spiral portion 31e may additionally be configured to move the particulate material 4, e.g. the portion thereof, towards the first or inner spiral portion 31d. It will be appreciated that in other embodiments, the first or inner spiral portion and/or the second or outer spiral portion may have a different configuration, e.g. a different pitch and/or diameter.

The agitating device 31 may comprise a plurality agitating elements 31f, three of which are shown in FIG. 7D. It will be appreciated that in other embodiments, the agitating device 31 may comprise more or less than three agitating elements. The agitating elements 31f may be part of or comprised in the second or outer spiral portion 31e. The agitating elements 31f may be provided in the form of protrusions. For example, the agitating elements 31f may be arranged to extend or protrude from the second or outer spiral portion 31e. The agitating elements 31f may be configured to help the movement of the particulate material 4, e.g. the portion thereof.

FIGS. 7E to 7G show three exemplary respective portions 31a for use in an agitating device 31 of a supply device, such as the supply device 8 shown in FIGS. 7A to 7C.

Each of the portions 31a shown in FIGS. 7E to 7G is similar to the portion 31a of the agitating device 31 described above. As such, any features of the portion 31a described above may also apply to each of the portions 31a shown in FIGS. 7E to 7G.

The first or inner spiral portion 31d of the portion 31a shown in FIG. 7E may be configured such that the first or inner spiral portion 31d comprises a first pitch of about 7 mm. The first or inner spiral portion 31d of the portion 31a shown in FIG. 7F may be configured such that the first or inner spiral portion 31d comprises a first pitch of about 10 mm. The first or inner spiral portion 31d of the portion 31a shown in FIG. 7G may be configured such that the first or inner spiral portion 31d comprises a first pitch of about 15 mm. For example, a first or inner spiral portion 31d having a first pitch P1 of 7 mm, 10 mm or 15 mm may aid the supply and/or moving of a cohesive and/or non-flowing material. It will be appreciated that the first or inner spiral portion is not limited to the first pitch values disclosed herein. For example, in other embodiments, the first or inner spiral portion may comprise a different first pitch. The first or inner spiral portion 31d may comprise any of the features of any of the shafts 30, e.g. the helical or spiral structure 30a, described above.

FIG. 7H shows another exemplary portion 31a of the agitating device 31 for use in any of the supply devices 8 shown in FIGS. 7A to 7C. The portions 31a shown in FIG. 7H is similar to the portions 31a of the agitating device 31 described above. As such, any features of the portion 31a described above may also apply to the portion 31a shown in FIG. 7H.

In the embodiment shown in FIG. 7H, the portion 31a comprises a third spiral portion 31h. The third spiral portion 31h is arranged between the first or inner spiral portion 31d and the second or outer spiral portion 31e. The third spiral portion 31h may be coaxially arranged with the first or inner spiral portion and the second or outer spiral portion. The third spiral portion 31h may comprise a third diameter D3 and/or a third pitch P3. The third spiral portion 31h may be configured such that the third diameter D3 changes, e.g. decreases, along a length of the third spiral portion 31h. For example, the third diameter D3 may decrease, e.g. gradually decrease, in a direction towards the moving arrangement or a free end of the third spiral portion. For example, the third spiral portion 31h may be configured to taper, e.g. towards the free end of the third spiral portion 31h. An angle of the taper may be between 2° and 10°, such as about 5°. However, it will be appreciated that in other embodiments the taper angle of the third spiral portion may be different from the exemplary values disclosed herein.

Alternatively, the third spiral portion may be configured such that the third diameter is constant, e.g. substantially constant, along a length of the third spiral portion.

In this embodiment, the third pitch P3 is different from the first pitch P1. For example, the third pitch P3 is larger than the first pitch P1. The third pitch P3 may be the same as the second pitch P2. For example, the third pitch P3 may be between about 20 mm and 30 mm, such as 25 mm. It will be appreciated that in other embodiments, the third pitch may be the same as the first pitch.

The third diameter D3 may be different from the first diameter D1 and the second diameter D2. For example, the third diameter D3 may be smaller than the second diameter D2. The third diameter may be larger than the first diameter D1. The third diameter D3 measured at a top or distal to the free end of the third spiral portion 31h may be about 20 mm to 50 mm, such as about 30 mm. The third spiral portion 31e may be arranged to surround the first or inner spiral portion 31d. The second outer spiral portion 31e may be arranged to surround the third spiral portion 31h. The third diameter D3 and/or third pitch P3 may be selected based on the particulate material.

In this embodiment, the portion 31a comprises a fourth or further outer spiral portion 31i. The fourth or further outer spiral portion 31i is arranged to surround the first or inner spiral portion 31d and/or the third spiral portion 31h. The fourth or further outer spiral portion 31i may be offset in a direction along the longitudinal axis G of the agitating device 31, e.g. relative to the second or outer spiral portion 31e. The fourth or further outer spiral portion 31i may comprise a fourth diameter D4 and/or a fourth pitch. The fourth diameter and/or the fourth pitch may be the same as the second diameter and/the second pitch. The fourth or further outer spiral portion 31i extends parallel, e.g. substantially parallel (or in a direction parallel) to the second or outer spiral portion 31e.

The fourth or further outer spiral portion 31i may be configured such that the fourth diameter D4 changes, e.g. decreases, along a length of the fourth or further outer spiral portion 31i. For example, the fourth diameter D4 may decrease, e.g. gradually decrease, in a direction towards the moving arrangement or a free end of the fourth spiral or further outer portion. For example, the fourth or further outer spiral portion 31i may be configured to taper, e.g. towards the free end of the fourth or further outer spiral portion 31i. An angle of the taper may be between 2° and 10°, such as about 5°. However, it will be appreciated that in other embodiments the taper angle of the fourth or further outer spiral portion may be different from the exemplary values disclosed herein.

The fourth diameter D4 and/or the fourth pitch P4 may be selected based on the particulate material.

The first or inner spiral portion 31d may be configured to move a portion of the particulate material 4 in the first direction, as described above. The second or outer spiral portion 31e and the fourth or further outer spiral portion 31i may be configured to move a portion of the particulate material 4 in the second direction. For example, the second pitch P2, fourth pitch P4, second diameter D2 and/or the fourth diameter D4 of the second or outer spiral portion 31e and fourth of further outer spiral portion 31i, respectively, may be selected such that the second or outer spiral portion 31e and the fourth or further spiral portion move the portion of the particulate material 4 in the second direction.

As described above, the first or inner spiral portion 31d may be configured to move the particulate material 4, e.g. the portion thereof, towards the moving arrangement 19. The second or outer spiral portion 31e and fourth or further spiral portion 31i may be configured to move the particulate material 4, e.g. the portion thereof, away from the moving arrangement 19. This may allow for increased circulation, e.g. circulation in the vertical direction or direction of the longitudinal axis G of the agitating device 31, of the particulate material 4 in the container 18. The agitating device 31 may be configured to homogenise a density of the particulate material in the container and/or prevent the formation of rat holes in the particulate material and/or bridging of the particulate material in the container 18.

The second or outer spiral portion 31e and fourth or further outer spiral portion 31i may additionally be configured to move the particulate material 4, e.g. the portion thereof, towards the first or inner spiral portion 31d and third spiral portion 31h. The third spiral portion 31h may be configured to move the particulate material 4, e.g. the portion thereof, towards the first or inner spiral portion 31d.

It will be appreciated that the third spiral portion and/or the fourth or further outer spiral portion may increase a circulation, e.g. a vertical circulation, of the particulate material 4 in the container 18. This may further homogenise a density of the particulate material in the container and/or prevent the formation of rat holes in the particulate material and/or bridging of the particulate material in the container 18, as described above.

By selecting one or more of the first diameter D1, first pitch P1, second diameter D2, second pitch P2, third diameter D3, third pitch P3, fourth diameter D4 and/or the fourth pitch P4 based on the particulate material, the agitating device 31 may be used with a range of particulate materials, e.g. having a range of different properties. It will be appreciated that in other embodiments, the first or inner spiral portion, the second or outer spiral portion, third spiral portion and/or fourth or further outer spiral portion may have a different configuration, e.g. a different pitch and/or diameter. Additionally, the portion of the agitating device may comprise more or less than four spiral portions. It will be appreciated that the first or inner spiral portion, the second or outer spiral portion, third spiral portion and/or fourth or further outer spiral portion are not limited to having the exemplary diameter and/or pitch values disclosed herein and that they may have a different configuration, e.g. a different pitch and/or diameter values.

FIGS. 7I to 7K each show a supply device 8 comprising an agitating device 31 with a moving arrangement 19 arranged at a different angle α. The supply devices 8 shown in FIGS. 7I to 7K may comprise any of the features of the supply device described above. As described above, the moving arrangement 19, e.g. the shaft 30, housing 32 and/or actuator 22, may be arranged at the angle α relative to the longitudinal axis H of the container 18. The angle α may be between 0 degrees and 180 degrees. In the embodiment shown in FIG. 7I, the angle is about 60 degrees. In the embodiment shown in FIG. 7J, the angle is about 90 degrees. In the embodiment shown in FIG. 7K, the angle is about 120 degrees. The angle may be selected based on the particulate material 4 and/or to reduce variations in the mass flow rate of the particulate material 4 supplied by the supply device 8. For the measurements disclosed herein an angle of 60 degrees was selected.

It will be appreciated that the support arrangement 29 and/or the agitating device 31 shown in FIGS. 7B and 7D may also be used with any of the supply devices shown in FIGS. 6A to 7A.

Although the supply device 8 shown in FIGS. 6A, 6B, 7B and 7C is being described as being part or comprised in the apparatus 2, it will be appreciated that in other embodiments the supply device may be used or provided on its own, e.g. without an entrainment region and/or a separation device, or with another apparatus or device. In such other embodiments, the moving arrangement may be configured to move the particulate material from the container, e.g. to a location or desired location. The location or desired location may be or comprise a part of one or more manufacturing systems described herein, the other device or apparatus and/or a location at which a product comprising the particulate material is or is to be manufactured.

FIG. 7L shows an exemplary system 35 for blending or mixing a plurality of particulate materials. The system 35 comprises a plurality of supply devices, three of which are shown in FIG. 7L. Each supply device 8a, 8b, 8c may be or comprise any of the features of the supply device 8, as described above. Although three supply devices 8a, 8b, 8c are shown in FIG. 7L, it will be appreciated that in other embodiment the system may comprise more or less than three supply devices.

The system 35 may be configured to blend or mix a first particulate material 4a supplied by a first supply device 8a with a second particulate material 4b supplied by a second supply device 8b. For example, the first and second particulate material 4a, 4b may be different. The first and second supply devices 8a, 8b may be arranged to supply the first and second particulate materials 4a, 4b, respectively, at or approximately at a target mass flow rate into a container 18c of a third supply device 8c. The third supply device 8c may be configured to mix or blend the first and second particulate materials 4a, 4b. The third supply device 8c may also be referred to as a blending or mixing device. The third supply device 8c may be configured to supply the mixed or blended particulate material 4c to the entrainment region 18 or another location, e.g. the location or desired location, mentioned above, or another device at or approximately at a target mass flow rate. As such, the third supply device may act as both a blender or mixing device and a supply device of the mixed or blended particulate material 4c. The agitating device 31 and/or moving arrangement 19 of the third supply device 8c may allow for uniform and/or efficient blending or mixing of the first and second particulate materials 4a, 4b. The third supply device 8c may allow for a continuous and/or consistent supply of the blended or mixed particulate material 4c.

The moving arrangement 19 of each of the first and second supply device 8a, 8b is arranged at an angle of about 60 degrees, as described above in relation to FIG. 7I. This may allow for a space-efficient and/or cost-saving arrangement of the first, second and third supply devices 8a, 8b, 8c relative to each other. However, it will be appreciated that in other embodiments, the moving arrangement may be arranged at a different angle relative to the longitudinal axis of the container, e.g. based on the particulate material.

The use of the first, second and third supply devices 8a, 8b, 8c may enable the system 35 to use a wide range of particulate materials, e.g. having a wide range of properties. This may make the system useful for pharmaceutical and/or chemical applications, e.g. where particulate materials having a wide range of properties may be common.

FIGS. 7M and 7N show another exemplary supply device 8. FIG. 7M shows a side view of the supply device 8 and FIG. 7N shows a cross-sectional view of the supply device 8. The supply device 8 is similar to any of the exemplary supply devices described above. As such, any features of any of the supply devices described above may also apply to the supply device 8 shown in FIGS. 7M and 7N.

In this embodiment, the supply device 8 comprises an outlet 43. The outlet 43 is configured to supply the particulate material from the container 18. The outlet 43 may be provided in the form of a nozzle or the like. The agitating device 31 may be configured to move a portion of the particulate material 4 towards the outlet 43. The agitating device may be configured to regulate or control an amount of the particulate material 4, e.g. a mass flow rate of the particulate material 4, moved to the outlet 43. The outlet 43 and agitating device 31 may be coaxially arranged. This may allow for the use of the supply device 8 in a vertical arrangement or orientation. For example, the supply device 8 is configured to supply the particulate material in a direction parallel, e.g. substantially parallel, to a longitudinal axis H, G of the container 18 and/or the agitating device 31. This may allow for the use of the supply device in applications or system where space is limited and/or a vertical supply of the particulate material is desired. For example, a vertical supply of the particulate material may find applicability in a number of applications, such as pharmaceutical, food processing and/or chemical applications. One or more parts or all of the supply device 8 may be formed using an additive manufacturing process. The one or more parts or all of the supply device 8 may be formed from a plastic material or from a metal material. The metal material may comprise a metal alloy, such a stainless steel or the like. The plastic material may comprise a polymer material, such as Acrylonitrile butadiene styrene or the like, a polyester material, such as Polylactic acid or the like, or other plastic material. For example, the one or more parts include at least one of: one or more parts of the coupling arrangement 24, the container 18, the housing 32, one or more parts of the support arrangement 29, one or more parts of the agitating device 31, such as the portion 31a, and/or one or more parts of the moving arrangement 19, such as the shaft 30. For example, the first or inner spiral portion 31d may be formed separately from the second or outer spiral portion 31e, third spiral portion 31h and/or the fourth or further outer spiral portion 31i using the additive manufacturing process.

It will be appreciated that the supply device 8 and/or the system 35 described herein may be part of a pharmaceutical manufacturing system 1, which indicated in FIG. 7L by the dotted box. The pharmaceutical manufacturing system 1 may be configured to manufacture a drug or drug product. In such embodiments, the particulate material 4 may comprise an active ingredient or substance, such as a high-potency active pharmaceutical ingredient or the like. The pharmaceutical manufacturing system 1 may be or comprise a pharmaceutical 3D printing or a pharmaceutical additive manufacturing system. It will be appreciated that the supply device 8 and/or system 35 disclosed is not limited to being part of or used in a pharmaceutical manufacturing system. For example, in other embodiments, the supply device and/or system may be part of a food and/or beverage manufacturing system, a cosmetic product manufacturing system, a chemical system, such as a chemical reactor and/or the like. In such other embodiments, the particulate material may comprise a food ingredient or substance, a cosmetic ingredient or substance, a particulate reactant or particulate catalyst and/or the like. In such other embodiments, the manufacturing system may comprise a 3D printing manufacturing system or an additive manufacturing system.

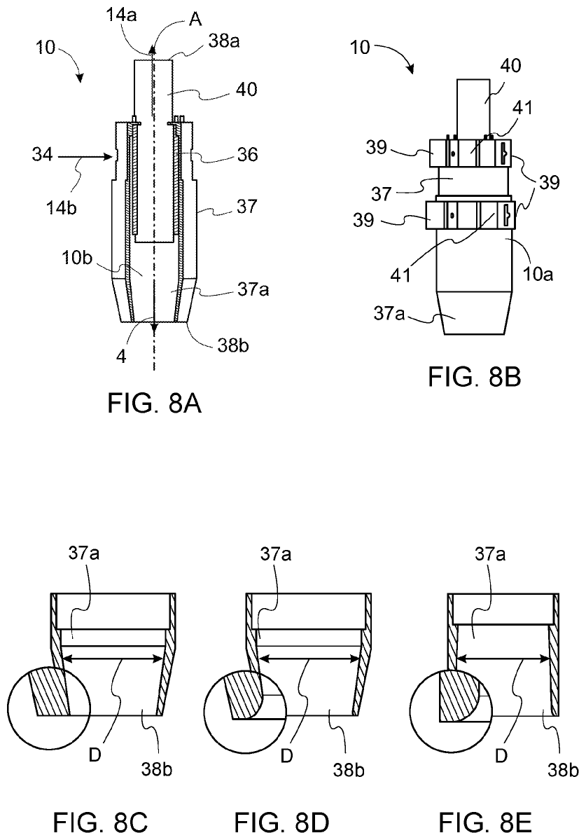

FIG. 8A shows an exemplary separation device 10 for use in the apparatus 2 shown in FIG. 1. As described above, the separation device 10 may be configured to separate the particulate material 4 from the gas or gas mixture 14a. The separation device 10 may be provided in the form of a cyclone separation device. The separation device 10 may be configured to receive the particulate material 4 entrained in the gas or gas mixture. The particulate material 4 entrained in the gas or gas-mixture may be referred to the in the following as the particulate material-gas mixture 14b, from the entrainment region 6. For example, the separation device 10 may comprise an inlet 34 for receiving the particulate material-gas mixture 14b from the entrainment region 6.

The separation device 10 may be configured to separate the particulate material 4 from the gas 14a using cyclonic separation. The separation device 10 may be configured to direct the particulate material-gas mixture 14b on a helical path, thereby using the inertia of the particulate material 4 to separate the particulate material 4 from the gas 14a. For example, the separation device 10 may comprise one or more guide members 36 for directing the particulate material-gas mixture 14b on the helical path. In this embodiment, the guide members 36 are provided in the form of baffle rods. For example, the separation device 10 may comprise eight guide members 36. However, it will be appreciated that in other embodiments, the guide members may be provided in the form of one or more baffles, such as one or more baffle plates, vanes or the like, and/or there may be less or more than eight guide members. The guide members 36 may be arranged to extend parallel to a longitudinal or central axis A, which is indicated in FIG. 8A by the dotted line, of the separation device 10. By providing the guide members 36 in the form of baffle rods, a separation efficiency of the separation device 10 may be increased.

The separation device 10 may comprise a housing 37. The housing may comprise a conical part 37a. The conical part 37a of the housing may be configured to change, e.g. decrease or increase, a rotational radius of the helical path of the particulate material-gas mixture 14b. As such, the conical part 37a may allow for separation of smaller particles from the particulate material-gas mixture.

The separation device 10 may comprise a first outlet 38a for discharging the gas or gas mixture 14a separated from the particulate material-gas mixture 14b. The separation device 10 may comprise a second outlet 38b for discharging the particulate material 4. The particulate material 4 separated from the particulate material-gas mixture 14b may be discharged from the separation device 10 due to gravitational forces acting on the particulate material 4. The first outlet 38a and the second outlet 38b may be arranged on opposing sides of the housing 37. For example, the second outlet 38b may be part of the conical part 37a of the housing 37. The conical part 37a of the housing 37 may define a bottom portion of the housing 37. The first outlet 38a may be part of a top portion of the housing 37. The separation device 10 may comprise a conduit 40. The conduit 40 may be arranged to direct the gas or gas mixture 14a separated from the particulate material-gas mixture 14b from an interior of the separation device 10, e.g. the housing 37, to the first outlet 38a.

FIG. 8B shows another exemplary separation device 10 for use in the apparatus 2 shown in FIG. 1. The separation device shown in FIG. 8B is similar to the separation device 10 shown in FIG. 8A. As such, the separation device shown in FIG. 8B may comprise any of the feature of the separation device 10 shown in FIG. 8A. Only differences will be described in the following.

In the embodiment shown in FIG. 8B, the separation device 10 may comprise one or more vibration devices 39, four of which are shown in FIG. 8B. However, it will be appreciated that in other embodiments, the separation device may comprise more or less than four vibration devices.

The vibration devices 39 may be configured to vibrate the separation device 10. It will be appreciated that in some embodiments, the vibration devices may be configured to cause vibration of only a part of the separation device, such as the housing. The vibration devices 39 may be provided in the form of a vibration motor, ultrasound vibrator or the like. By providing the separation device 10 with one or more vibration devices 39 fouling and/or accumulation of the particulate material 4 separated from the gas or gas mixture in the separation device 10 may be reduced.

The separation device 10 may comprise one or more mounting elements 41, two of which are shown in FIG. 8B. However, it will be appreciated that in other embodiments, the separation device may comprise more or less than two mounting elements. The mounting elements 41 may be configured to connect the vibration devices 39 to the separation device 10, e.g. the housing 37 thereof. For example, the mounting elements 41 may be configured to connect the vibration devices 39 to an outer surface 10a of the separation device 10. The mounting elements 41 may be part of or comprised in the housing 37 of the separation device 10. The mounting elements 41 may be configured to arrange the vibration devices 39 circumferentially on the outer surface 10a of the separation device 10, e.g. the housing 37 thereof. For example, the mounting elements 41 may comprise a ring shape. The mounting elements may define a plurality of locations for connecting a plurality of vibration devices 39. One or more vibration devices 39 may be connected to the mounting elements 41, e.g. using a fastener, such as a bolt, screw or the like. The mounting elements 41 may allow a location and/or number of vibration devices 39 on the outer surface 10a of the separation device 10 to be varied. In the embodiment shown in FIG. 8B, two vibration devices 39 are connected to the outer surface 10a of the separation device 10, e.g. the housing 37 thereof, by each mounting element 41. However, it will be appreciated that in other embodiments, more or less than two vibration devices may be connected to the separation device by each mounting element.

FIGS. 8C to 8E show exemplary embodiments of a portion of the separation device 10 shown in FIGS. 8A and 8B. The portion is or comprises the conical part 37a of the housing 37 of the separation device 10. A shape and/or size of the conical part 37a may be configured based on the particulate material 4. The inventors have found that a shape and/or size of the conical part 37a of the housing 37 may influence the variation of the mass flow rate of the particulate material 4. As described above, the conical portion 37a may comprise or define the second outlet 38b of the separation device 10. The second outlet 38b of the separation device 10 may be defined by an edge of the conical part 37a.

In the embodiment shown in FIG. 8C, the conical part 37a is configured to taper inwardly towards the second outlet 38b of the separation device 10. Expressed differently, the conical part 37a may be configured such that a diameter D of the conical part 37a decreases towards second outlet 38b of the separation device 10. The second outlet 38b of the separation device 10 may be defined by a flat edge of the conical part 37a.

The conical part 37a shown in FIG. 8D is similar to the conical part shown in FIG. 8C. However, the second outlet 38b of the separation device 10 may be defined by a radiused, rounded or curved edge of the conical part 37a. The edge of the conical part 37a may be curved outwardly.

In the embodiment shown in FIG. 8D, the conical part 37a is configured to taper outwardly towards the second outlet 38b of the separation device 10. Expressed differently, the conical part 37a may be configured such that a diameter D of the conical part 37a increases towards second outlet 38b of the separation device 10. In this embodiment, the second outlet 38b of the separation device 10 may be defined by a radiused, rounded or curved edge of the conical part 37a, as described in relation to FIG. 8D.

The inventors have found that a variation of the mass flow rate of the particulate material 4 may be reduced for a separation device comprising the conical part 37a shown in FIG. 8E compared to a variation of the mass flow rate of the particulate material 4 for a separation device comprising the conical part 37a shown in FIG. 8C or FIG. 8D. In addition, the inventors have found that a variation of the mass flow rate of the particulate material 4 may be reduced for a separation device comprising the conical part 37a shown in FIG. 8D compared to a variation of the mass flow rate of the particulate material 4 for a separation device comprising the conical part 37a shown in FIG. 8C. The reduction in the variation of the mass flow rate of the particulate material 4 may be due to a decrease in the accumulation of the particulate material at the edge of the conical part 37a, e.g. the second outlet 38b of the separation device 10. By providing the conical portion 37a with a radiused, curved or rounded edge, as described above, the accumulation of the particulate material 4 at the edge of the conical part 37a, e.g. the second outlet 38b of the separation device 10, may be reduced. Additionally, by configuring to the conical part 37a to taper outwardly towards the second outlet 38b, the accumulation of the particulate material 4 at the edge of the conical part 37a, e.g. the second outlet 38b of the separation device 10, may be reduced further.

The separation device 10 may comprise an inner surface 10b. The inner surface 10b of the separation device 10 may be polished and/or coated with an antistatic coating. This may reduce friction and/or static electricity, which in turn may reduce adhesion of particulate material 4 on the inner surface 10b of the separation device 10.

It will be appreciated that in other embodiments the separation device may comprise a different configuration from that disclosed herein. For example, in other embodiments, the separation device may comprise a plurality of conical parts and/or be provided in the form of a multicyclone separation device.

The separation device 10 may be or comprise a modular separation device. This may allow for adjustments of one or more parts of the separation device 10. For example, this may allow a shape or size of the conical portion 37a to be varied or adjusted, as described above in relation to FIGS. 8C to 8E, e.g. based on the particulate material 4. This may additionally or alternatively allow for a diameter of the separation device 10 may adjusted or varied, e.g. based on the particulate material 4.

One or more parts or all of the separation device 10 may be formed using an additive manufacturing process. One or more parts or all of the separation device 10 may be formed from a plastic material or from a metal material. The metal material may comprise a metal alloy, such a stainless steel or the like. The plastic material may comprise a polymer material, such as Acrylonitrile butadiene styrene or the like, a polyester material, such as Polylactic acid or the like, or other plastic material. For example, the one or more parts of the separation device 10 may include at least one of: the conical portion 37a, guide member 36, the mounting elements 41, the housing 37 and/or the first outlet 38a.

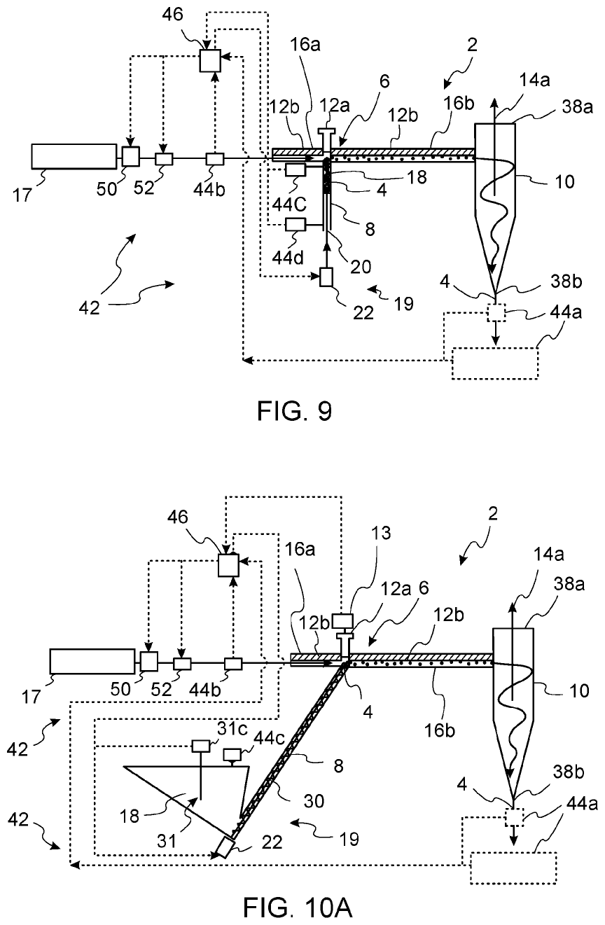

The apparatus 2 may comprise a control system 42. FIGS. 9 to 12 show exemplary control systems for use in or with the apparatus 2. The control system 42 may be configured to control the properties of the gas or gas mixture flowing through the entrainment region 6, e.g. based on the target mass flow rate. The properties of the gas or gas mixture may comprise a pressure of the gas or gas mixture 14 in the entrainment region 6 and/or a flow rate of the gas or gas mixture 14a in the entrainment region 6. A velocity of the gas or gas mixture 14a in the entrainment region 6 may depend on the pressure and/or the flow rate of the gas or gas mixture 14a. As such, by controlling or adjusting the pressure and/or the flow rate of the gas or gas mixture 14a in the entrainment region, the velocity of the gas or gas mixture 14a in the entrainment region 6 may be controlled or adjusted. This in turn may allow for control or adjustments, e.g. fine adjustments, of the entrainment energy or entrainment power in the entrainment region 6.

The control system 42 may be configured to set the properties of the gas or gas mixture to one or more selected values. The selected values of the properties of the gas or gas mixture 14a, e.g. the pressure of the gas or gas mixture 14a and/or the flow rate of the gas or gas mixture 14a, flowing through in the entrainment region 6 may be selected, e.g., based on the particulate material 4 and/or the target mass flow rate of the particulate material. For example, the pressure of the gas or gas mixture 14a flowing through the entrainment region 6 may be selected to be between about 0 Pa and 150 kPa. The flow rate of the gas or gas mixture 14a flowing through the entrainment region 6 may be selected to be between about 3×10⁻⁵ m³/s (2 l/min) and 4×10⁻⁴ m³/s (25 l/min). It will be appreciated that in other embodiments, a different pressure and/or flow rate of the gas or gas mixture flowing through the entrainment region than that disclosed herein may be selected. For example, in embodiments where an increased (target) mass flow rate of the particulate material is necessary, an increase in the entrainment energy or entrainment power may be required. This in turn may require an increase in the pressure and/or flow rate of the gas or gas mixture flowing through the entrainment region.

Each of the exemplary control systems 42 shown in FIGS. 9 to 12 may comprise a first sensor 44a. The first sensor 44a may be configured to sense a first signal. The first signal may be indicative of a mass flow rate of the particulate material 4, such as a mass flow rate of the particulate material 4 separated from the gas or gas mixture. The control system 42 may be configured to determine the mass flow rate of the particulate material 4 based on the sensed first signal. The control system 42 may be configured to compare the determined mass flow rate of the particulate material 4 to the target mass flow rate. Based on the comparison between the determined mass flow rate and the target mass flow rate, the control system 42 may be configured to adjust the mass flow rate of the particulate material 4 supplied by the supply device 8.

The control system 42 may be configured to determine a target flow rate (and/or target pressure) of the gas or gas mixture 14a flowing through the entrainment region 6, based on a result of the comparison between the determined mass flow rate of the particulate material 4 and the target mass flow rate.

The control system 42 may comprise a second sensor 44b. The second sensor 44b may be configured to sense a second signal. The second signal may be indicative of the flow rate (and/or pressure) of the gas or gas mixture 14a flowing through the entrainment region 6. The control system 42 may be configured to determine the flow rate (and/or pressure) of the gas or gas mixture 14a flowing through the entrainment region 6 based on the sensed second signal. The control system 42 may be configured to compare the determined flow rate (and/or pressure) to the target flow rate (and/or target pressure).

Based on a result of the comparison between the determined flow rate (and/or pressure) and the target flow rate (and/or target pressure), the control system 42 may be configured to adjust the properties of the gas or gas mixture 14a flowing through entrainment region 6 and/or the mass flow rate of the particulate material 4 supplied by the supply device 8.

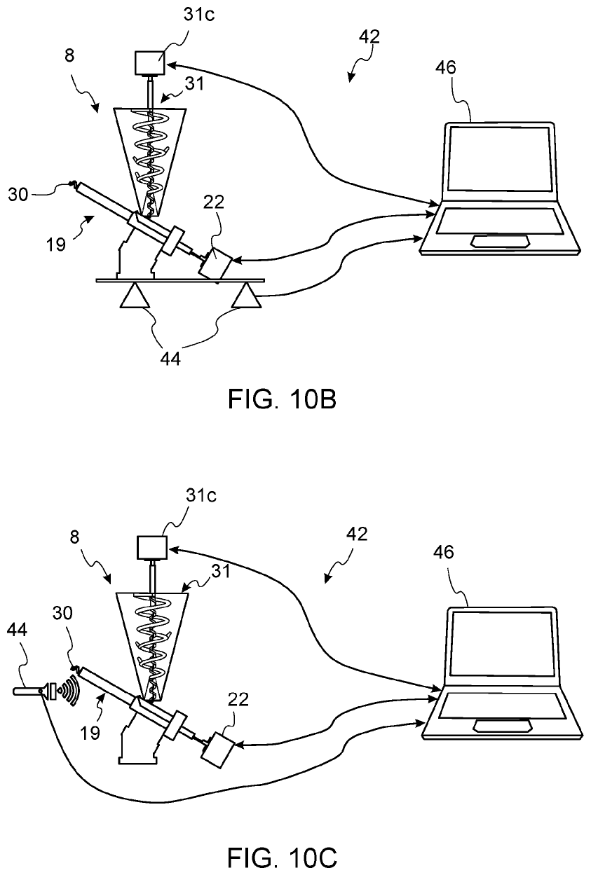

Referring to FIGS. 9 and 10A, the apparatus 2 shown in FIG. 9 comprises the supply device 8, as described above in relation to FIGS. 4 and 5. The apparatus 2 shown in FIG. 10A comprises the supply device 8, as described above in relation to FIGS. 6A and 6B.

The first sensor 44a may be provided in the form of a scale or balance, such as a validation balance. In this embodiment, the first sensor 44a may be configured to measure a weight of particulate material 4 at timed intervals. For example, the first sensor 44a may be configured to measure the weight of the particulate material every second. The weight of the particulate material 4 measured at the timed intervals may be converted to the mass flow rate of the particulate material 4. The sensor 44 may be arranged in proximity to the second outlet 38b of the separation device 10 to sense the first signal indicative. The first sensor 44a may be arranged in proximity of the second outlet 38b of the separation device 10 to receive the separated particulate material 4.

Alternatively, the first sensor 44a may be provided in the form of a terahertz, capacitance sensor or the like. When the first sensor is provided in the form of a terahertz, capacitance sensor or the like, the first sensor 44a may be arranged in a stream of separated particulate material 4 from the second outlet 38b of the separation device 10 to sense the first signal.

FIGS. 1, 9 and 10A show the first sensor 44a as being provided in the form of the validation balance, which is indicated by a dashed box in FIGS. 9 and 10A. FIGS. 9 and 10A also show the first sensor 44a as being provided in the form of the terahertz, capacitance sensor or the like, which is indicated by the dotted box.

The control system 42 comprises a controller 46. The first signal may be transmitted from the first sensor 44a to the controller 46. The controller 46 may be configured to compare the first signal to a setpoint. The setpoint may be indicative of the target mass flow rate. The controller 46 may be configured to convert the setpoint to the target flow rate (and/or the target pressure).

The second signal may be transmitted from the second sensor 44b to the controller 46. The controller 46 may be configured to determine the flow rate (and/or pressure) of the gas or gas mixture 14a flowing through the entrainment region 6 based on the sensed second signal. The controller 46 may be configured to compare the determined flow rate (and/or pressure) of the gas or gas mixture 14a to the target flow rate (and/or target pressure).

As described above, the first conduit 16a may be configured to connect the apparatus 2 to the gas or gas mixture supply system 17. The gas or gas mixture supply system 17 may be configured to supply the gas or gas mixture 14a to the apparatus 2. The control system 42 may comprise a pressure controller 50. The pressure controller 50 may be configured to control the pressure of the gas or gas mixture 14a supplied by the gas or gas mixture supply system 17 to the apparatus 2. For example, the pressure controller 50 may be provided in the form of a pressure regulator valve.

The control system 42 may comprise a gas or gas mixture flow controller 52. For example, the gas or gas mixture flow controller may be provided in the form of control valve. The gas or gas mixture flow controller 52 may be configured to control the flow rate of the gas or gas mixture 14a supplied by the gas or gas mixture supply system 17 to the apparatus 2. The controller 46 may be configured to adjust the pressure and/or the flow rate of the gas or gas mixture 14a based on a result of the comparison between the determined flow rate (and/or pressure) of the gas or gas mixture and the target flow rate (target pressure). The controller 46 may be configured transmit a signal to the pressure controller 50 and/or the gas or gas mixture flow controller 52 to adjust the pressure and/or the flow rate of the gas or gas mixture 14a to the target pressure and/or target flow rate of the gas or gas mixture, respectively.

The control system 42 may be configured to control a mass flow rate of the particulate material supplied by the supply device 8, e.g. based on the target mass flow rate. For example, the control system 42 may be configured to control the operation of the supply device 8. For example, the control system 42 may be configured to control the moving arrangement 19, e.g. the actuator 22. For example, the control system 42 may be configured to control a speed or velocity of the moving arrangement 19, such as a speed or velocity of the piston 20 or a speed or velocity, e.g. a rotational speed or velocity, of the shaft 30. The control system 42 may be configured to control the rate or speed of the particulate material 4 being supplied to the entrainment region 6, such as the speed or velocity of the moving arrangement 19, e.g. based on the result of the comparison between the determined mass flow rate of the particulate material and the target mass flow rate. For example, based on the result of the comparison between the determined mass flow rate of the particulate material and the target mass flow rate, the controller 46 may be configured to transmit a signal to the moving arrangement 19, e.g. the actuator 22, to adjust the rate or speed of the particulate material 4 being supplied to the entrainment region 6 to a target rate or speed.

Referring to FIG. 9, the control system 42 may comprise a third sensor 44c and a fourth sensor 44d. The third and fourth sensor 44c, 44d may be configured to sense a third signal. The third signal may be indicative of a level of the particulate material 4 in the container 18 of the supply device 8. For example, the third and fourth sensor 44c, 44d may each be provided in the form of a proximity sensor. The third and fourth sensors 44c, 44d may be configured to transmit the third signal to the controller 46. The controller 46 may be configured to start or stop operation of the apparatus 2 based on the third signal transmitted by the third and fourth sensor 44c, 44d. For example, the operation of the apparatus 2 may be started or stopped by opening or closing the control valve of the gas or gas mixture flow controller 52 and/or the pressure regulator valve of the pressure controller 50.

It will be appreciated that in other embodiments, the control system may comprise only one of the third and fourth sensors. For example, the control system 42 shown in FIG. 10A comprises the third sensor 44c. The third sensor 44c may be configured to sense the third signal indicative, which is indicative of a level of the particulate material 4 in the container 18. The third sensor 44c may be provided in the form of a level transmitter. The third sensor 44c may be configured to transmit the third signal to the controller. Based on the third signal, the container 18 may be refilled with particulate material 4 during the operation of the apparatus 2. This may allow for continuous operation of the apparatus 2.

The control system 42 may be configured to control the agitating device 31. For example, the control system 42 may be configured to control a speed or velocity, e.g. a rotational speed or velocity, of the agitating device 31, which is indicated in FIGS. 10 and 12. The control system 42 may be configured to control the actuator 31c of the agitating device 31. For example, the control system 42 may be configured to control a speed or velocity, e.g. a rotational speed or velocity, of the portion 31a of the agitating device 31. The control system 42 may be configured to control the agitating device 31, e.g. the actuator 31c and/or the portion 31a thereof, based on the particulate material 4 and/or the target mass flow rate of the particulate material 4. For example, the control system 42 may be configured to set the speed or velocity of the agitating device 31, e.g. the actuator 31c and/or the portion 31a, based on the particulate material 4 and/or the target mass flow rate of the particulate material 4. The control system 42 may be configured to adjust the speed or velocity of the agitating device 31, e.g. the actuator 31c and/or the portion 31a, based on the particulate material 4 and/or the target mass flow rate of the particulate material 4. For example, based on the comparison between the determined mass flow rate and the target mass flow rate, the control system 42 may be configured to adjust the speed or velocity of the agitating device 31, e.g. the actuator 31c and/or the portion 31a. The controller 46 may be configured to transmit signal to the actuator 31c of the agitating device 31. The signal may be indicative of the speed or velocity of the agitating device 31, e.g. actuator 31c and/or the portion 31a. By controlling the speed or velocity of the agitating device 31 and/or the moving arrangement 19, variations in the mass flow rate of the particulate material 4 supplied by the supply device 8 may be reduced.

It will be appreciated that in other embodiments the control system may be part of the supply device. In such other embodiments, the supply device may be provided or used on its own, e.g. without an entrainment region and/or a separation device, or with another apparatus or device, as described above. In such other embodiments, the control system may be configured to control the moving arrangement, e.g. the actuator thereof, and/or the agitating device, e.g. the actuator thereof, as described above.

As described above, the supply device 8 may comprise the control system 42. FIGS. 10B and 10C show an exemplary control system 42 for use in or with the supply device. The control system 42 shown in similar to the control system described above and below. As such, any features of the control system described above and below may also apply to the control system shown in FIGS. 10B and 10C. The control systems 42 shown in FIGS. 10B and 10C comprises at least one sensor 44. The sensor 44 may be configured to sense a first signal. The first signal may be indicative of a mass flow rate of the particulate material 4 supplied by the supply device 8.

In the embodiment shown in FIG. 10B, the control system 42 comprises two sensors. However, it will be appreciated that in other embodiments, the control system may comprise more or less than two sensors.

The sensors 44 may each be provided in the form of a scale or balance, such as a load cell, load cell transducer or the like. The sensors 44 may be configured to measure a weight of the supply device 8 including the particulate material 4 over time. The first signal sensed by each sensor may be indicative of the measured weight of the supply device 8 over time. The control system 42 may be configured to determine a loss of weight over time based on the first signal.

In the embodiment shown in FIG. 10C, the control system comprise a sensor 44. The sensor is provided in the form of a mass flow sensor, such as a terahertz, a capacitance sensor, a radar sensor or the like. However, it will be appreciated that in other embodiments another sensor, such as a scale or balance, may be used.

The first signal sensed by the sensor 44 may be indicative of a mass flow rate of the particulate material supplied by the supply device 8.

Referring to FIGS. 10B and 10C, the control system 42 may be configured to determine the mass flow rate of the particulate material 4 based on the sensed first signal. For example, the control system 42 may be configured to determine a mass flow rate of the particulate material supplied by the supply device 8 based on the determined loss of weight or the sensed mass flow rate of the particulate material.

The control system 42 may be configured to compare the determined mass flow rate of the particulate material 4 to a target mass flow rate. Based on the comparison between the determined mass flow rate and the target mass flow rate, the control system 42 may be configured to adjust the mass flow rate of the particulate material 4 supplied by the supply device 8.

The control system 42 comprises a controller 46. The first signal may be transmitted from the sensor 44 to the controller 46. The controller 46 may be configured to compare the first signal to a setpoint. The setpoint may be indicative of the target mass flow rate. The controller 46 may be configured to convert the setpoint to the target flow rate.

Based on the determined target mass flow rate, the control system 42 may be configured to control the moving arrangement 19, e.g. the actuator 22. For example, the control system 42 may be configured to control a speed or velocity of the moving arrangement 19, such as a speed or velocity, e.g. a rotational speed or velocity, of the shaft 30. For example, based on the result of the comparison between the determined mass flow rate of the particulate material and the target mass flow rate, the controller 46 may be configured to transmit a second signal to the moving arrangement 19, e.g. the actuator 22, to adjust the velocity or speed of the shaft 30.

The control system 42 may be configured to control the agitating device 31. For example, the control system 42 may be configured to control a speed or velocity, e.g. a rotational speed or velocity, of the agitating device 31. The control system 42 may be configured to control the actuator 31c of the agitating device 31. For example, the control system 42 may be configured to control a speed or velocity, e.g. a rotational speed or velocity, of the portion 31a of the agitating device 31. The control system 42 may be configured to control the agitating device 31, e.g. the actuator 31c and/or the portion 31a thereof, based on the particulate material 4 and/or the target mass flow rate of the particulate material 4. For example, the control system 42 may be configured to set the speed or velocity of the agitating device 31, e.g. the actuator 31c and/or the portion 31a, based on the particulate material 4 and/or the target mass flow rate of the particulate material 4. The control system 42 may be configured to adjust the speed or velocity of the agitating device 31, e.g. the actuator 31c and/or the portion 31a, based on the particulate material 4 and/or the target mass flow rate of the particulate material 4. For example, based on the comparison between the determined mass flow rate and the target mass flow rate, the control system 42 may be configured to adjust the speed or velocity of the agitating device 31, e.g. the actuator 31c and/or the portion 31a. The controller 46 may be configured to transmit a third signal to the actuator 31c of the agitating device 31. The third signal may be indicative of the speed or velocity of the agitating device 31, e.g. actuator 31c and/or the portion 31a. By controlling the speed or velocity of the agitating device 31 and/or the moving arrangement 19, variations in the mass flow rate of the particulate material 4 supplied by the supply device 8 may be reduced.

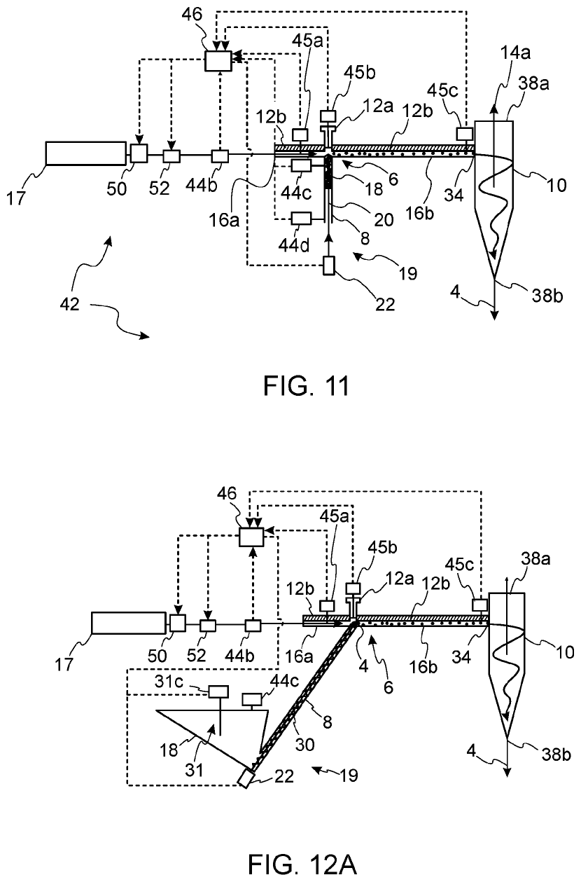

FIGS. 11 and 12 show another exemplary control system 42 for use in or with the apparatus 2. The control system 42 shown in FIGS. 11 and 12 is similar to the control system 42 shown in FIGS. 9 and 10A. As such, the control system 42 shown in FIGS. 11 and 12 may comprise any of the features of the control system described above in relation to FIGS. 9 and 10A.

The apparatus 2 shown in FIG. 11 comprises the supply device 8, as described above in relation to FIGS. 4 and 5. The apparatus 2 shown in FIG. 12 comprises the supply device 8, as described above in relation to FIGS. 6A and 7C.

The exemplary control system 42 shown in FIGS. 11 and 12 is similar to the control system shown on FIGS. 9 and 10A. Only differences between the control system shown in FIGS. 11 and 12 and the control system shown in FIGS. 9 and 10A will be described in the following.

In the embodiment shown in FIGS. 11 and 12, the control system 42 comprises a plurality of first sensors. In this embodiment, the control system 42 comprises three first sensor 45a, 45b, 45c. However, it will be appreciated that in other embodiments, the control system may comprise more or less than three sensors. Each of the first sensors 45a, 45b, 45c may be provided in the form of a pressure sensor. Each of the first sensors 45a, 45b, 45c may be configured to sense a first signal. The first signals from the first sensors 45a, 45b, 45c may be indicative of a mass flow rate of the particulate material 4, such as a mass flow rate of the particulate material 4 separated from the gas or gas mixture. The control system 42 may be configured to determine the mass flow rate of the particulate material 4 based on the sensed first signal from each first sensors 45a, 45b, 45c.

For example, each of the first sensors 45a, 45b, 45c may be configured to transmit the respective first signal to the controller 46. The control system 42, e.g. the controller 46, may be configured to determine a mass flow rate of the particulate material 4, based on the first signals from the sensors 45a, 45b, 45c. The control system 42, e.g. the controller 46, may be configured to compare the determined mass flow rate of the particulate material 4 to the setpoint. Based on a result of the comparison between the determined mass flow rate and the setpoint, the control system, e.g. the controller 46, may be configured to determine a target flow rate (and/or target pressure) of the gas or gas mixture. The control system 42, e.g. the controller 46, may be configured to compare the determined target flow rate (and/or target pressure) of the gas or gas mixture to the flow rate (or pressure) of the gas or gas mixture 14a determined from the second signal of the second sensor 44b, as described above. Based on a result of the comparison between the target flow rate (and/or target pressure) of the gas or gas mixture and the determined flow rate (and/or pressure) of the gas or gas mixture 14a, the controller 46 may be configured transmit the signal to the pressure controller 50 and/or the gas or gas mixture flow controller 52 to adjust the pressure and/or the flow rate of the gas or gas mixture flow to a target pressure and/or target flow rate of the gas or gas mixture, respectively, as described above.

In the embodiment shown in FIGS. 11 and 12, the first sensor 45a, 45b, 45b may be arranged so that a differential pressure in the apparatus 2 may be determined by the control system 42, e.g. the controller 46. For example, one of the first sensors 45a, 45b, 45c may be arranged to sense a signal indicative of a pressure of the gas or gas mixture 14a in the first conduit 16a. Another one of the first sensors 45a, 45b, 45c may be arranged to sense a signal indicative of a pressure of the gas or gas mixture 14a at the location of the first restriction member 12a. Yet another one of the first sensors 45a, 45b, 45c may be arranged to sense a signal indicative of a pressure of the particulate material-gas mixture 14b in in the second conduit 16b, e.g. in proximity of the inlet 34 of the separation device 10.

In some embodiments, the/each first signal may be indicative of a mass flow rate of the particulate material entrained in the gas or gas mixture. For example, in embodiments where separation of the particulate material from the gas or gas mixture is not necessary, the first sensor may be provided in the form of pressure sensor, terahertz sensor, capacitance sensor or the like. The first sensor may be arranged to sense the first signal at or in proximity to the first restriction member and/or in the second conduit. Additionally or alternatively, the control system may comprise the plurality of first sensors as described above.

In some embodiments, the control system 42 may be configured to move the first restriction member 12a between the first position and the second position. For example, the apparatus 2 may comprise an actuator 13, such as a motor or step motor, configured to move the first restriction member 12a between the first and second positions. The control system 42, e.g. the controller 46, may be configured to transmit a signal to the actuator 13 to move the first restriction member 12a between the first and second positions. The control system 42, e.g. the controller 46, may be configured to control and/or adjust the first position of the first restriction member 12a in the first part 6a of the entrainment region 6, e.g. based on the particulate material and/or the target mass flow rate. For example, based on the comparison between the determined mass flow rate and the target mass flow rate, the control system 42, the controller 46, may be configured to adjust and/or control the first position of the first restriction member 12a in the first part 6a of the entrainment region 6 and/or move the first restriction member 12a between the first and second positions. Although the actuator 13 is only shown in FIG. 10A, it will be appreciated that any of the features described above may also apply to any of the control systems 42 shown in FIG. 9, 11 or 12.

It will be appreciated that the controller 46 may be provided in the form of a data processing device, such as a mobile phone, smartphone, PDA, tablet computer, laptop computer, and/or the like. The data processing device may comprise a processor configured to perform any of the functions of the controller 46 and/or the control system described above.

The following description summarises results of measurements of one or more mass flow rates of particulate materials 4 supplied by the apparatus 2 and associated parameters. The measurements were performed for particulate materials comprising microcrystalline cellulose (MCC), paracetamol (APAP), croscarmellose sodium (CCS) and crospovidone (XPVP). Microcrystalline cellulose, croscarmellose sodium and crospovidone may be considered as free or easy flowing particulate materials relative to paracetamol, which may be considered as a cohesive material. Microcrystalline cellulose has a volume mean diameter that is larger than a volume mean diameter of crospovidone and paracetamol. Croscarmellose sodium has the smallest volume mean diameter relative to the remaining exemplary particulate material described herein.

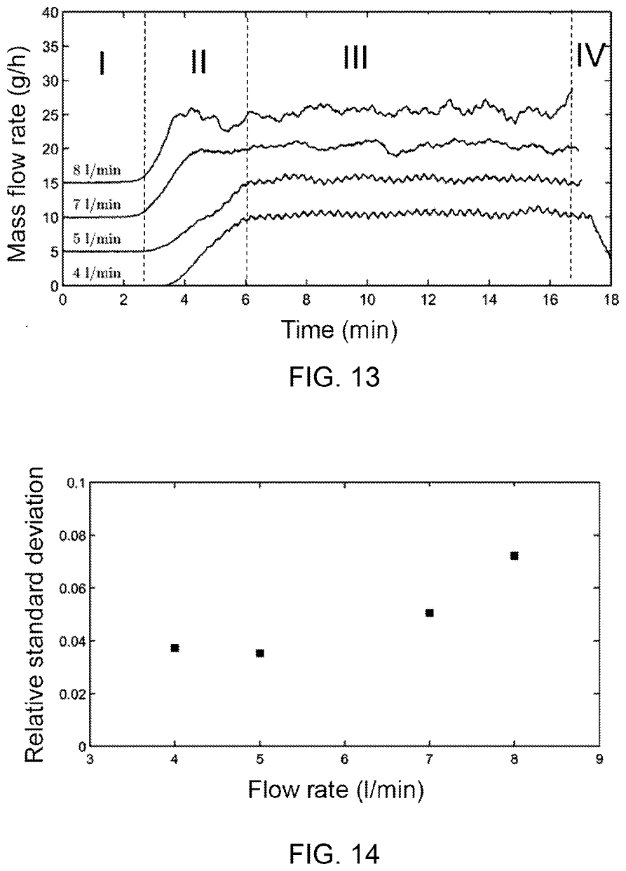

FIG. 13 shows a graph of mass flow rates of the particulate material 4 supplied by the apparatus 2 over time for different flow rates of the gas or gas mixture. The apparatus 2 comprises the supply device 8 described above in relation to FIGS. 4 and 5. In the following description, the gas or gas mixture was provided in the form of air. In this example, the particulate material 4 comprises microcrystalline cellulose. The mass flow rate of the particulate material 4 supplied by the apparatus 2 was determined for flow rates of the gas or gas mixture of about 0.24 m³/h (4 l/min), 0.3 m³/h (5 l/min), 0.42 m³/h (7 l/min) and 0.48 m³/h (8 l/min). A pressure of the gas or gas mixture in the apparatus was about 25 kPa. A speed of the piston 20 was selected as about 7 mm/min.

In the example shown in FIG. 13, the first restriction member 12a was in the second position. The second restriction member 12b was selected to decrease the cross-sectional area of the second part 6b of the entrainment region 6 and the first and second conduits 16a, 16b by 50%.

As can be seen in FIG. 13, there may be four phases I to IV when supplying the particulate material using the apparatus 2.

In phase I, the particulate material 4 may be compressed by the piston 20 in the container 18. It will be appreciated that this phase may differ or be absent when the apparatus 2 comprises one of the other exemplary supply devices 8 disclosed herein. A duration of this phase may depend on the speed of the piston 20. For example, a particulate material, such as paracetamol, with a higher compressibility relative to another particulate material, such as microcrystalline cellulose, may require a higher speed of the piston 20 relative to the other particulate material to achieve the same mass flow rate. As such, the duration of phase I may be longer for the particulate material than the other particulate material.

In phase II, some particles of the particulate material 4 may become entrained in the gas or gas mixture flowing through the entrainment region 6 and subsequently be separated from the gas or gas mixture in the separation device 10. A duration of this phase may depend on a flow rate of the gas or gas mixture, speed of the piston 20 and/or a size or dimension of the separation device 10. The duration of this phase may also depend on the properties of the particulate material 4. For example, for a particulate material, such as paracetamol, with a higher cohesive force and/or a smaller size of the particle relative to another particulate material, such as microcrystalline cellulose, the duration of this phase may be longer than for the other particulate material. For the particulate material with the smaller size of particles, a time required for settling of the particles may be longer than for the other particulate material.

In phase III, the mass flow rate of the particulate material is nearly constant and the apparatus 2 may stably supply the particulate material 4.

In phase IV, the operation of the supply device 8 has been stopped.

FIG. 14 shows a graph of relative standard deviations determined for the mass flow rates shown in FIG. 13 over the flow rate of the gas or gas mixture. The relative standard deviation may also be referred to as the coefficient of variation. The relative standard deviation may be defined by the ratio of the standard deviation to the mean. The relative standard deviation or coefficient of variation may be indicative of a precision and/or repeatability of a measurement. In other words, the relative standard deviation or coefficient of variation may determine if the standard deviation of a set of measured data is small or large relative to the mean. For example, the higher the relative standard deviation is, the higher is the scatter or more spread out are the results. A lower relative standard deviation may be indicative of a higher precision of the measurement of the data.

It can be seen from FIG. 14 that the relative standard deviation is smaller for the flow rates of the gas or gas mixture of 0.24 m³/h (4 l/min) and 0.3 m³/h (5 l/min) compared to the flow rates of the gas or gas mixture of 0.42 m³/h (7 l/min) and 0.48 m³/h (8 l/min). In other words, variations in the mass flow rate of the particulate material 4 were reduced by adjusting the flow rate of the gas or gas mixture 14a. This may lead to stable mass flow rate of the particulate material 4. In this example, the variations in the mass flow rate of the particulate material 4 were reduced by reducing the flow rate of the gas or gas mixture. However, it will be appreciated that in other embodiments, the variations in the mass flow rate of the particulate material 4 may be reduced by selecting an optimal flow rate and/or pressure of the gas or gas mixture flowing through the entrainment region.

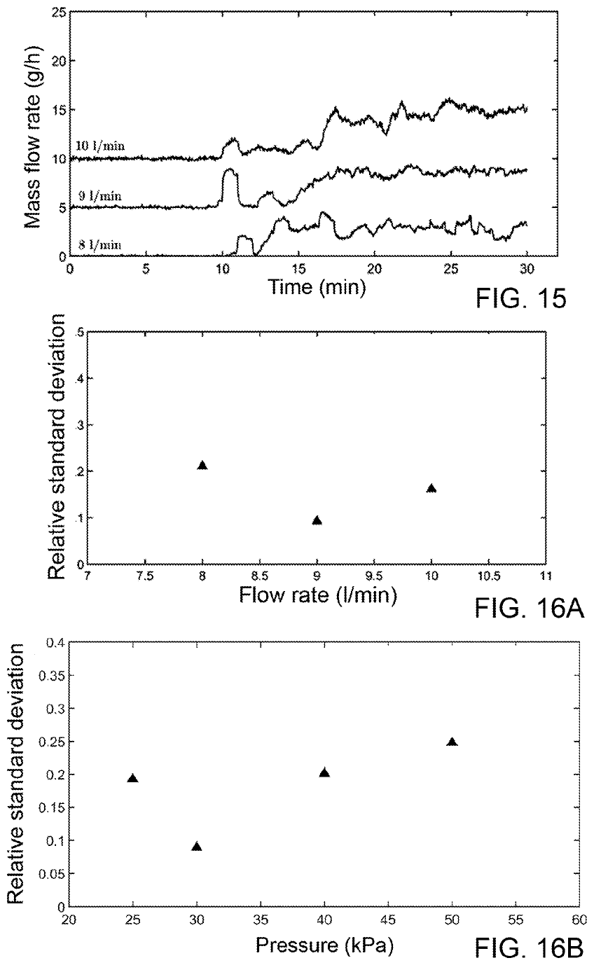

FIG. 15 shows a graph of mass flow rates of the particulate material 4 supplied by the apparatus 2 over time for different flow rates of the gas or gas mixture. In this example, the apparatus 2 comprises the supply device 8 described above in relation to FIGS. 4 and 5. In this example, the particulate material 4 comprises paracetamol. The mass flow rate of the particulate material 4 supplied by the apparatus 2 was determined for flow rates of the gas or gas mixture of about 0.48 m³/h (8 l/min), 0.54 m³/h (9 l/min) and 0.6 m³/h (10 l/min). A pressure of the gas or gas mixture in the apparatus was about 30 kPa. A speed of the piston 20 was selected to be about 4 mm/min.

In the example shown in FIG. 15, the first restriction member 12a was in the first position. An extension or first position of the first restriction member 12a was selected so that the first cross-sectional area A1 of the first part 6a of the entrainment region 6 was decreased by 50%. In the example shown in FIG. 15, the second restriction member 12b was selected to decrease the second cross-sectional area A2 of the second part 6b of the entrainment region 6 and the first and second conduits 16a, 16b by 90%. As described above, paracetamol particles may be considered as having a higher cohesive force relative to microcrystalline cellulose particles. As such, a higher entrainment energy or entrainment power may be necessary to entrain paracetamol particles in the gas or gas mixture 14a relative to an entrainment energy or entrainment power necessary to entrain microcrystalline cellulose particles in the gas or gas mixture 14a. By decreasing the first and second cross-sectional areas A1, A2 of the first and second parts 6a, 6b of the entrainment region 6, the velocity of the gas or gas mixture may be increased, e.g. for a constant flow rate of the gas or gas mixture 14a. This may result in an increase of the entrainment energy or entrainment power in the entrainment region 6. In this example, the pressure of the gas or gas mixture 14a flowing through the entrainment region 6 was increased compared to the pressure of the gas or gas mixture 14a used in the example of microcrystalline cellulose above, e.g. to cause an increase of the entrainment energy or entrainment power.

FIG. 16A shows a graph of relative standard deviations determined for the mass flow rates shown in FIG. 15 over the flow rate of the gas or gas mixture. It can be seen from FIGS. 15 and 16 that the relative standard deviation is smaller for the flow rates of the gas or gas mixture of about 0.54 m³/h (9 l/min) compared to the flow rates of the gas or gas mixture of 0.48 m³/h (8 l/min) and 0.6 m³/h (10 l/min). As such, variations in the mass flow rate of the particulate material 4 may be reduced by adjusting the flow rate of the gas or gas mixture. This may lead to stable mass flow rate of the particulate material 4.

FIG. 16B shows a graph of relative standard deviations of determined mass flow rates over the pressure of the gas or gas mixture 14a flowing through the entrainment region 6. The relative standard deviations shown in FIG. 16B were determined for mass flow rates of the particulate material 4 measured at a flow rate of the gas or gas mixture of about 0.54 m³/h (9 l/min), as shown in FIG. 15. It can be seen from FIG. 16B that the relative standard deviation is smaller for a pressure of about 30 kPa compared to the pressures of the gas or gas mixture of 25 kPa, 40 kPa and 50 kPa.

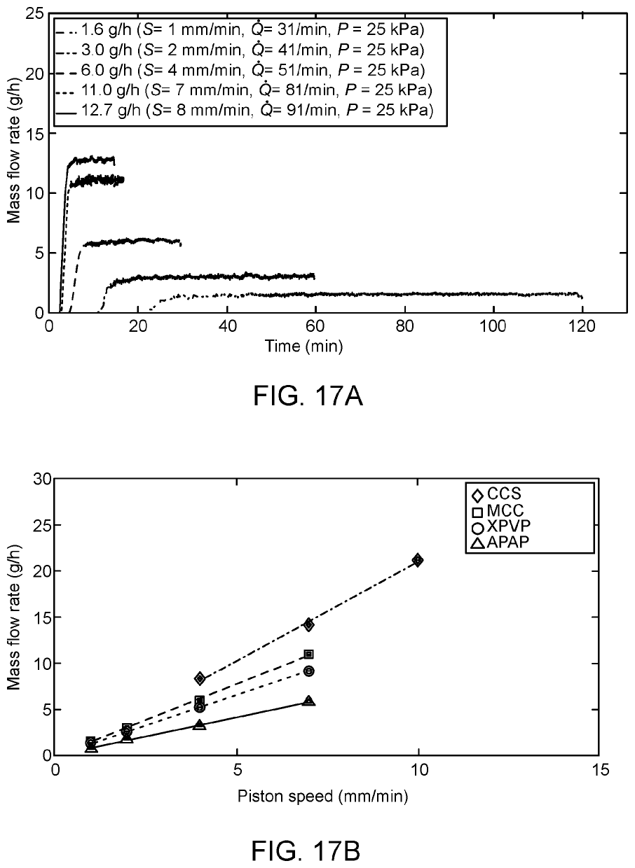

FIG. 17A shows a graph of mass flow rates of a particulate material for different piston speeds S and different flow rates Q of the gas or gas mixture. In this example, the particulate material 4 comprises microcrystalline cellulose. A pressure of the gas or gas mixture 14a flowing through the entrainment region 6 was about 25 kPa. As can be seen from FIG. 17A, by increasing the speed to the piston 20, the mass flow rate of the particulate material 4 supplied by the apparatus 2 increases, e.g. from 4.4×10⁻⁷ kg/s (1.6 g/h) to 3.5×10⁻⁶ kg/s (12.7 g/h). At a piston speed of about 1 mm/min, the apparatus 2 may supply the particulate material 4 for about 80 minutes.

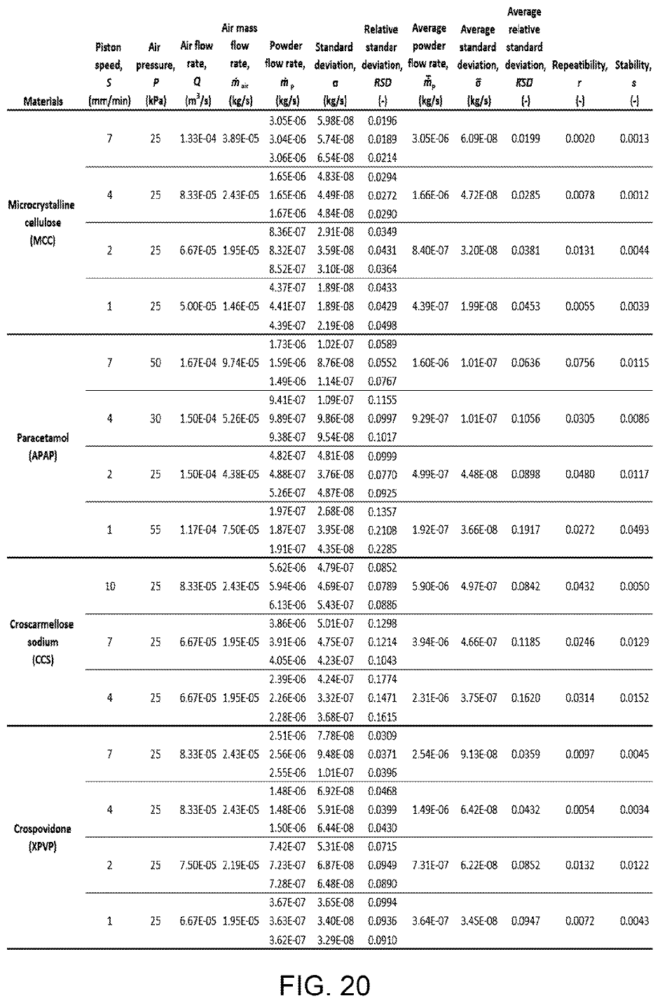

FIG. 17B shows a graph of mass flow rates of different particulate materials 4 supplied by the apparatus 2 over the speed of the piston 20. In this example, the particulate materials comprise microcrystalline cellulose, paracetamol, croscarmellose sodium and crospovidone. The flow rates and pressure of the gas or gas mixture used to measure the mass flow rates for each of the different particulate materials at the different speeds of the piston 20 are summarised in FIG. 20. The mass flow rates for microcrystalline cellulose were measured using the first position of the first restriction member 12a and the second restriction member 12b, as described above in relation to FIG. 13. For croscarmellose sodium and crospovidone, the first position of the first restriction member 12a was selected so that the first cross-sectional area A1 was reduced by 50%. The second restriction member 12b was selected to decrease the second cross-sectional area A2 by 75%. The mass flow rates for paracetamol were measured using the first position of the first restriction member 12a and the second restriction member 12b, as described above in relation to FIG. 15. As can be seen from FIG. 17B, by increasing the speed to the piston, the mass flow rate of the particulate material 4 supplied by the apparatus 2 increases, e.g. increases linearly.

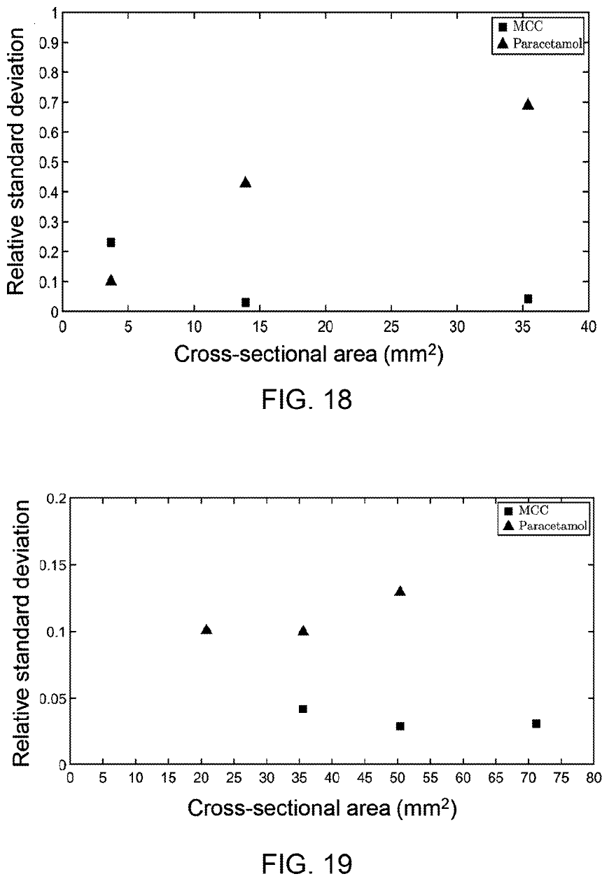

FIG. 18 shows a graph of the relative standard deviations of mass flow rates over the second cross-sectional area A2 of the second part 6b of the entrainment 6. The relative standard deviations were determined for measurements of the mass flow rate of different particulate materials 4 using the apparatus 2 with a second restriction member 12b configured to decrease the second cross-sectional area A2 of the second part 6b of the entrainment region 6 by 90%, a second restriction member 12b configured to decrease the second cross-section area A2 of the second part 6b of the entrainment region 6 by 75% and a second restriction member 12b configured to decrease the second cross-section area A2 of the second part 6b of the entrainment region 6 by 50%. In this example, the particulate materials 4 comprise microcrystalline cellulose and paracetamol. The first restriction member 12a was in the second position. The mass flow rates for paracetamol were measured using a flow rate of the gas or gas mixture of 0.54 m³/h (9 l/min) and a pressure of the gas or gas mixture of about 30 kPa. The mass flow rates for microcrystalline cellulose were measured using a flow rate of the gas or gas mixture of about 0.3 m³/h (5 l/min) and a pressure of the gas or gas mixture of about about 25 kPa.

As described above, paracetamol may be considered as a cohesive particulate material, whereas microcrystalline cellulose may be considered as free flowing compared to paracetamol. From FIG. 18, it can be seen that for paracetamol, a reduction in the second cross-sectional area A2 results in a reduction of the relative standard deviation. The relative standard deviation for microcrystalline cellulose increases when cross-sectional area A3 of the second restriction member 12b is increased from 75% to 90%. By decreasing the second cross-sectional area A2 of the second part 6b of the entrainment region 6, the velocity of the gas or gas mixture may be increased, e.g. for a constant flow rate of the gas or gas mixture. This may result in an increase of the entrainment energy or entrainment power in the entrainment region 6. In embodiments where the apparatus 2 is used in the second configuration, e.g. without the second restriction member 12b, an increase of the flow rate of the gas or gas mixture flowing through the entrainment region 6 may be required to achieve a desired velocity of the gas or gas mixture. However, this increase in the flow rate of the gas or gas mixture may cause an excess of entrainment energy or entrainment power, which may lead to variations of the mass flow rate of the particulate material 4. However, the second restriction member 12b may allow for an adjustment, e.g. a rough adjustment, of the velocity of the gas or gas mixture and/or the entrainment energy or entrainment power in the entrainment region 6 based on the particulate material 4, which may reduce or prevent the creation of excess of entrainment energy or entrainment power.

FIG. 19 shows a graph of the relative standard deviations of mass flow rates over the first cross-sectional area A1 of the first part 6a of the entrainment region 6. The relative standard deviations were determined for measurements of the mass flow rate of different particulate materials 4 with the first restriction member 12a in second position and in the first position. The first position of the first restriction member 12a was selected such that the first restriction member 12a reduces the first cross-sectional area A1 of the first part 6a of the entrainment region 6 by about 66%, 50% and 33%. The particulate materials 4 comprise paracetamol and microcrystalline cellulose. In this example, the second restriction member 12b was selected to reduce the second cross-sectional area of the second part 6b of the entrainment bed 6 by 90% for paracetamol and by 75% for microcrystalline cellulose. The flow rates and pressures of the gas or gas mixture were the same as those described above in relation to FIG. 18.

As can be seen from FIG. 19, the relative standard deviation of the mass flow rates depends on the first position of the first restriction member 12a, e.g. an extension of the first restriction member 12a into the first part 6a of the entrainment region 6. For example, the relative standard deviation may be minimised for paracetamol, when the first position of the first restriction member 12a is selected to decrease the first cross-sectional area A1 of the first part 6a of the entrainment region by 50%. The relative standard deviation may be minimised for microcrystalline cellulose, when the first position of the first restriction member 12a is selected to decrease the first cross-sectional area A1 of the first part 6a of the entrainment region by 33%. When the first position of the first restriction member 12a is selected to decrease the first cross-sectional area A1 below an optimal value for a particular particulate material 4, the velocity of the gas or gas mixture may increase, e.g. for a constant flow rate of the gas or gas mixture, which in turn may cause an increase of the entrainment energy or entrainment power. The increased velocity of the gas or gas mixture and the increased entrainment energy or entrainment power may cause turbulences in the entrainment region 6. The turbulences may dislodge excess particulate material from the supply device 8, which may result in excess particular material becoming entrained in the gas or gas mixture, causing variations in the mass flow rate of the particulate material 4.

When the first position of the first restriction member 12a is selected to increase the first cross-sectional area A1 above an optimal value for a particular particulate material 4, the velocity of the gas or gas mixture may decrease, e.g. for a constant flow rate of the gas or gas mixture, which in turn may cause a decrease of the entrainment energy or entrainment power. This in turn may cause particulate material 4 to become accumulated in the entrainment region 6 or other parts of the apparatus 2, which may cause a blockage. As such, the first restriction member 12a may allow for an adjustment, e.g. a rough adjustment, of the velocity of the gas or gas mixture and/or the entrainment energy or entrainment power in the entrainment region 6 based on the particulate material 4.

FIG. 20 shows a table summarising the measurements of the mass flow rates for the different particulate materials supplied by the apparatus 2. As described above, the particulate materials include: microcrystalline cellulose and paracetamol, croscarmellose sodium and crospovidone. The apparatus 2 may supply the particulate material 4 with a mass flow rate in a range of about 1.9×10⁻⁷ kg/s to 5.8×10⁻⁶ kg/s (0.7 g/h to 21 g/h) with a relative standard deviation of less than 5% to 20%, depending on the particulate material 4.

When microcrystalline cellulose is used as the particulate material 4, the apparatus 2 may supply the particulate material 4 with a mass flow rate was in the range of about 4.4×10⁻⁷ kg/s to 3×10⁻⁶ kg/s (1.6 g/h to 11 g/h) with a relative standard deviation of less than 5%.

FIG. 20 also summarises a repeatability of the mass flow rate measurements. The repeatability may be defined as the ratio of the standard deviation of the mass flow rates of replicated measurements over the average of the mass flow rate. A low value may be indicative of a repeatability of the measurements. When microcrystalline cellulose is used as the particulate material 4, the apparatus 2 may supply the particulate material 4 with high repeatability, e.g. less than 1.5%.

FIG. 20 also summarises a stability of the mass flow rate measurements. The stability may be defined as the standard deviation of relative standard deviations of replicated measurements. A low value may be indicative of a high stability. When microcrystalline cellulose is used as the particulate material 4, the apparatus 2 may supply the particulate material 4 with high stability, e.g. less than 0.5%.

FIG. 20 shows that when paracetamol is used as the particulate material 4, the apparatus 2 may supply the particulate material 4 with a repeatability of less than 8% and stability of less than 5%. When paracetamol is used as the particulate material 4, the apparatus 2 may supply the particulate material 4 with a mass flow rate was in the range of about 1.9×10⁻⁷ kg/s to 1.6×10⁻⁶ kg/s (0.7 g/h to 5.8 g/h) with a relative standard deviation of less than 20%.

When croscarmellose sodium is used as the particulate material 4, the apparatus 2 may supply the particulate material 4 with a mass flow rate was in the range of about 2.2×10⁻⁶ kg/s to 5.8×10⁻⁶ kg/s (8 g/h to 21 g/h) with a relative standard deviation of less than 16%, a repeatability of less than 5% and a stability of less than 1.5%.

When crospovidone is used as the particulate material 4, the apparatus 2 may supply the particulate material 4 with a mass flow rate was in the range of about 3.6×10⁻⁷ kg/s to 2.6×10⁻⁶ kg/s (1.3 g/h to 9.2 g/h) a relative standard deviation of less than 10%, a repeatability of less than 1.5% and a stability of less than 1.3%.

The measurements of the mass flow rate of the particulate material 4 supplied by the apparatus 2 shown in FIG. 20 have each been repeated three times.

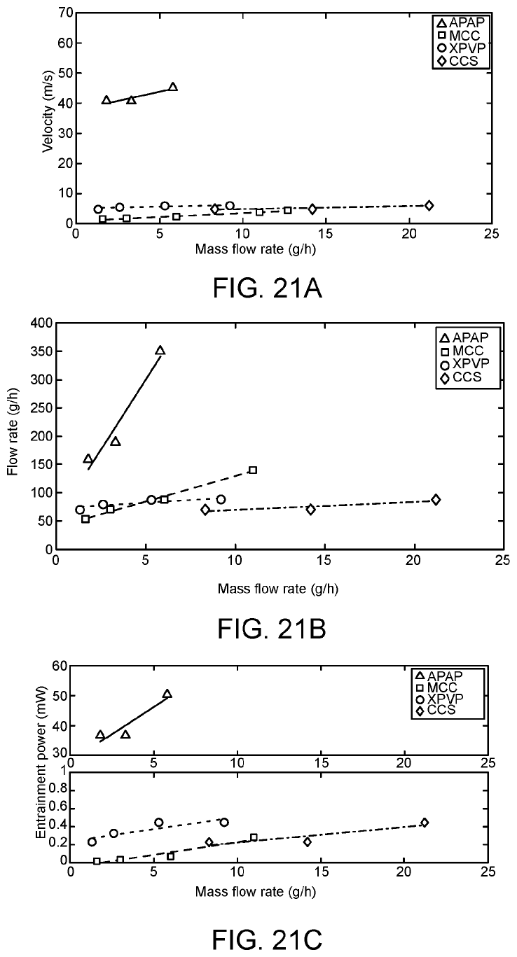

FIG. 21A shows a graph of the velocity of the gas or gas mixture flowing through the entrainment region 6 over the mass flow rates for the different particulate materials 4 described herein. The mass flow rates for the different materials were measured using the first position of the first restriction member 12a and the second restriction member 12b, as described above in relation to FIGS. 15 and 17B. The velocity of the gas or gas mixture 14a flowing through the entrainment region 6 and the mass flow rates for the different particulate materials shown in FIG. 21A are based on the values summarised in FIG. 20. Each line in FIG. 21A corresponds to a line fitted to the measured data. It can be seen from FIG. 21A that the mass flow rate for each particulate material 4 depends on the velocity of the gas or gas mixture flowing through the entrainment region 6. For example, with increasing or decreasing velocity of the gas or gas mixture flowing through the entrainment region 6, the mass flow rate increases or decreases for each particulate material 4.

FIG. 21B shows a graph of the flow rate of the gas or gas mixture flowing through the entrainment region over the mass flow rates for the different particulate materials 4 described herein. The mass flow rates for the different materials were measured using the first position of the first restriction member 12a and the second restriction member 12b, as described above in relation to FIGS. 15 and 17B. The flow rate of the gas or gas mixture 14a flowing through the entrainment region 6 and the mass flow rates for the different particulate materials shown in FIG. 21B are based on the values summarised in FIG. 20. Each line in FIG. 21B corresponds to a line fitted to the measured data. It can be seen from FIG. 21B that the mass flow rate for each particulate material 4 depends on the flow rate of the gas or gas mixture flowing through the entrainment region 6. For example, with increasing or decreasing flow rate of the gas or gas mixture flowing through the entrainment region 6, the mass flow rate increases or decreases for each particulate material.

FIG. 21C shows a graph of the entrainment power over the mass flow rate for the different particulate materials 4 described herein. The mass flow rates for the different materials were measured using the first position of the first restriction member 12a and the second restriction member 12b, as described above in relation to FIGS. 15 and 17B. The entrainment power was determined based on the values summarised in FIG. 20. The mass flow rates for the different particulate materials shown in FIG. 21C are based on the values summarised in FIG. 20. Each line in FIG. 21C corresponds to a line fitted to the measured data. It can be seen from FIG. 21B that the mass flow rate for each particulate material 4 depends on the entrainment power. For example, with increasing or decreasing entrainment power, the mass flow rate increases or decreases for each particulate material.

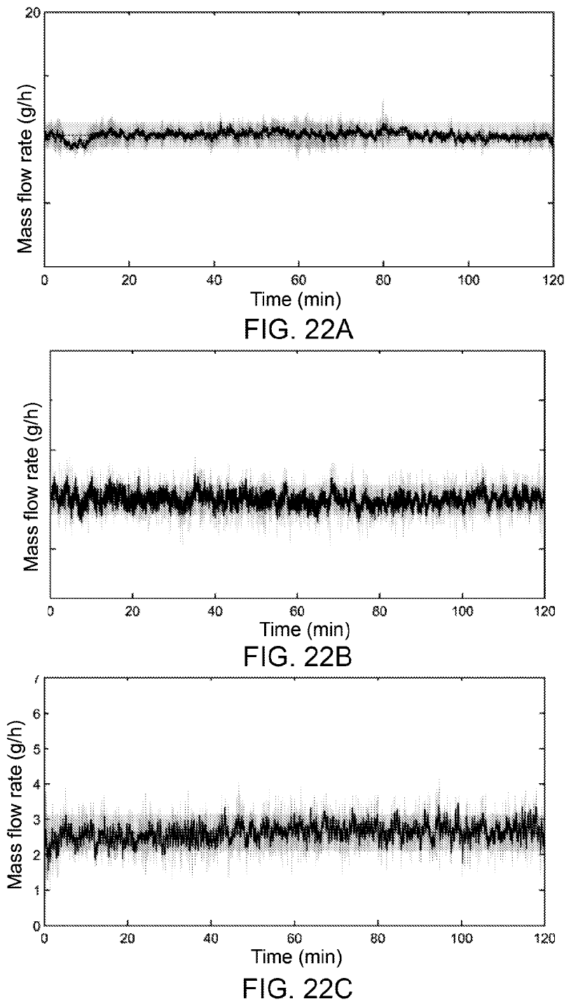

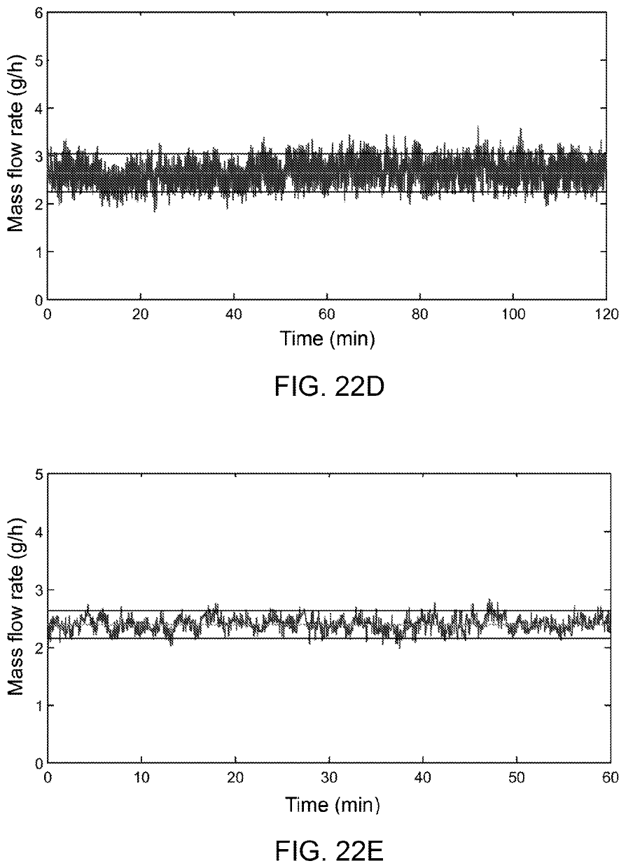

FIGS. 22A to 22C each show a graph of the mass flow rate of a particulate material 4 supplied by the supply device 8 shown in FIGS. 6A, 6B, 7B and 7C over time. In this example, the mass flow rate of the particulate material 4 was measured directly from the supply device 8. The particulate material 4 comprises paracetamol. The dark grey line in each of FIGS. 22A to 22C indicates the measured mass flow rate. The light grey line in each of FIGS. 22A to 22C indicates the standard deviation. The dashed line in each of FIGS. 22A to 22C indicates the median or average of the measured mass flow rate of the particulate material 4.

In FIG. 22A, the mass flow rate of the particulate material 4 was determined for a speed or velocity of the moving arrangement 19, e.g. shaft 30, of 10 revolutions per minute and a speed or velocity of the agitating device 31, e.g. shaft 31c, of 10 revolutions per minute. A median of the mass flow rate of the particulate material was determined as 2.8×10⁻⁶ kg/s (10.3 g/h) with a relative standard deviation of around 6%, with a stability of less than 0.2% and a repeatability of about 2.8%.

In FIG. 22B, the mass flow rate of the particulate material was determined for a speed or velocity of the moving arrangement 19, e.g. shaft 30, of 5 revolutions per minute and a speed or velocity of the agitating device 31, e.g. shaft 31c, of 5 revolutions per minute. A median of the mass flow rate of the particulate material was determined as 1.1×10⁻⁶ kg/s (4 g/h) with a relative standard deviation of about 14%, with a stability of less than 0.1% and a repeatability of about 5%.

In FIG. 22C, the mass flow rate of the particulate material was determined for a speed or velocity of the moving arrangement 19, e.g. shaft 30, of 3 revolutions per minute and a speed or velocity of the agitating device 31, e.g. shaft 31c, of 3 revolutions per minute. A median of the mass flow rate of the particulate material was determined as 7×10⁻⁷ kg/s (2.6 g/h) with a relative standard deviation of about 17%, with a stability of less than 1.3% and a repeatability of about 2%.

From FIGS. 22A to 22C, it can be seen that the supply device 8 as shown in FIGS. 6A, 6B, 7B and 7C may allow for continuous supply of the particulate material 4 with a very high accuracy, e.g. without the provision of an entrainment region. It will be appreciated that the accuracy may be improved and/or the variations of the mass flow rate of the particulate material may be reduced or minimised by using the supply device 8 as part of the apparatus 2. This may be due to entrainment region 6 of the apparatus 2, as described above.

FIGS. 22D and 22E each show a graph of the mass flow rate of another particulate material 4 supplied by the supply device 8 shown in FIGS. 6A, 6B, 7B and 7C over time. As described in relation to FIGS. 22A to 22C, the mass flow rate of the particulate material 4 was measured directly from the supply device 8. The particulate material 4 comprises magnesium stearate. The dark grey line in each of FIGS. 22D and 22E indicates the measured mass flow rate. The solid black line in each of FIGS. 22D and 22E indicates the standard deviation. The dashed line in each of FIGS. 22D and 22E indicates the median or average of the measured mass flow rate of the particulate material 4.

In FIG. 22D, the mass flow rate of the particulate material 4 was determined for a speed or velocity of the moving arrangement 19, e.g. shaft 30, of 5 revolutions per minute and a speed or velocity of the agitating device 31, e.g. portion 31c, of 5 revolutions per minute. A median of the mass flow rate of the particulate material was determined as 7.2×10⁻⁷ kg/s (2.6 g/h) with a relative standard deviation of around 11%.

In FIG. 22E, the mass flow rate of the particulate material 4 was determined for a speed or velocity of the moving arrangement 19, e.g. shaft 30, of 10 revolutions per minute and a speed or velocity of the agitating device 31, e.g. portion 31c, of 5 revolutions per minute. A median of the mass flow rate of the particulate material was determined as 6.7×10⁻⁷ kg/s (2.4 g/h) with a relative standard deviation of around 5%.

From FIGS. 22D and 22E, it can be seen that by adjusting the speed or velocity of the moving arrangement 19, e.g. shaft 30, variations of the mass flow rate of the particulate material 4 supplied by the supply device 8 may be reduced. In this example, the speed or velocity of the moving arrangement 19, e.g. shaft 30, was increased, which did not change the mass flow rate of the particulate material 4. This may be due to the agitating device, which may regulate the supply of particulate material 4 from the container 18 to the moving arrangement 19, e.g. shaft 30. Expressed differently, the agitating device 31 may aid to regulate the mass flow rate of the particulate material supplied by the supply device 8.

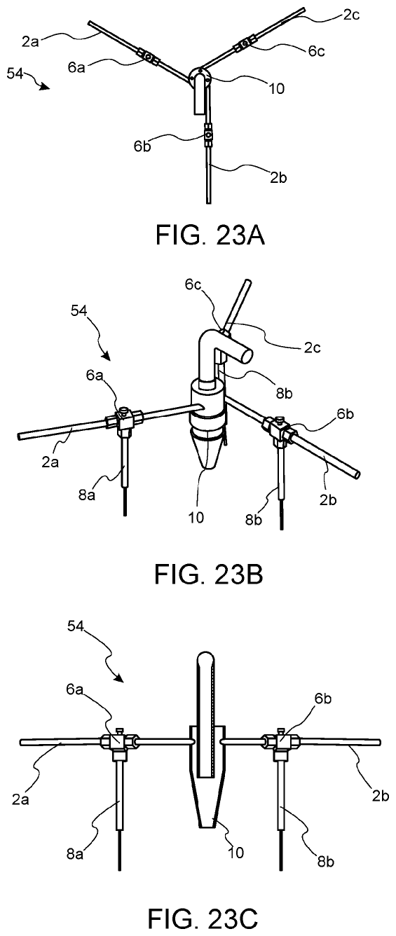

FIGS. 23A to 23C show an exemplary system 54 for blending or mixing a plurality of particulate materials. FIG. 23A shows a plan view of the system 54. FIG. 23B shows a perspective view of the system 54. FIG. 23C shows a sectional view of the system 54.

The system 54 comprises a plurality of apparatuses 2a, 2b 2c for supplying a particulate material at a target mass flow rate, three of which are shown in FIGS. 23A to 23C. Each apparatus 2a, 2b, 2c may be or comprise the apparatus 2, as described above. Although three apparatuses 2a, 2b, 2c are shown in FIGS. 23A to 23C, it will be appreciated that in other embodiment the system may comprise more or less than three apparatuses.

The system 54 comprises a blending or mixing device. In this embodiment, the blending or mixing device may be provided in the form of the separation device 10. However, it will be appreciated that in other embodiments, the system may comprise another blending or mixing device, for example, a blending or mixing vessel, in which the particulate material may not be separated from the gas or gas mixture. The separation device shown in FIGS. 23A to 23C may be or comprise the separation device 10, as described above. Each apparatus 2a, 2b, 2c is connected to the separation device 10.

The system 54 may be configured to blend or mix a particulate material 4 supplied by one 2a of the apparatuses 2a, 2b, 2c with a particulate material 4b supplied by at least one other 2b of the apparatuses 2a, 2b, 2c. For example, each apparatus 2a, 2b, 2c may be configured to supply a different particulate material 4a, 4b, 4c. The separation device 10 may be configured to receive the particulate material 4a, 4b, 4c entrained in the gas or gas mixture from the entrainment region 6a, 6b, 6c of at least one or each apparatus 2a, 2b, 2c. The separation device 10 may be configured to separate the particulate material 4a, 4b, 4c from the gas or gas mixture. The separation device 10 may be configured to blend or mix the particulate materials 4a, 4b, 4c from two or more of the apparatuses 2a, 2b, 2c with each other.

Although FIGS. 23A to 23C show each apparatus 2a, 2b, 2c as comprising a respective supply device 8a, 8b, 8c, as shown in FIGS. 4 and 5, it will be appreciated that in other embodiments at least one or all of the apparatuses of the system may comprise any of the supply devices shown in FIGS. 6A to 7C.

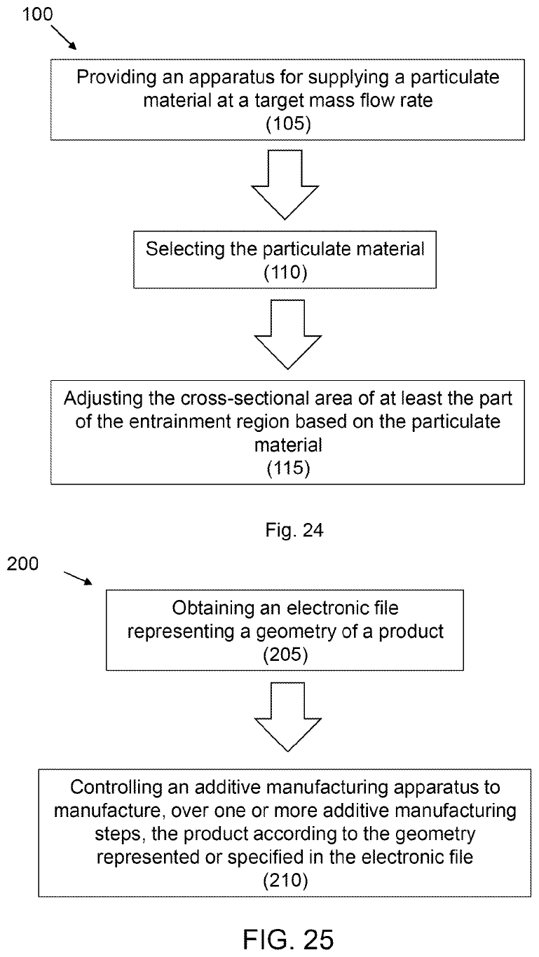

FIG. 24 shows an exemplary flow diagram outlining the steps of a method 100 of using an apparatus for supplying a particulate material at a target mass flow rate. The apparatus may comprise the apparatus 2 described above. The method 100 may be part of a manufacturing method, such as a pharmaceutical manufacturing method, a food and/or beverage manufacturing method, a cosmetic product manufacturing method or the like.

In step 105, the method 100 comprises providing the apparatus 2.

In step 110, the method 100 comprises selecting the particulate material 4. The method 100 may comprise filling the supply device 8, e.g. the container 18, with the particulate material 4.

In step 115, the method 100 comprises adjusting the cross-sectional area of at least the part of the entrainment region 6 based on the particulate material 4. The part of the entrainment region 6 may comprise the first part 6a and/or the second part 6b of the entrainment region 6, as described above.

The step 115 of adjusting the cross-sectional area of at least the part of the entrainment region may comprise moving the first restriction member 12a between the first position and the second position. The step 115 of adjusting the cross-sectional area of at least the part of the entrainment region may comprise selecting an extension or protrusion, e.g. a degree or amount thereof, of the first restriction member 12a into the first part 6a of the entrainment region 6, e.g. based on the particulate material 4.

The step 115 of adjusting the cross-sectional area of at least the part of the entrainment region may comprise selecting a second restriction member 12b, e.g. based on the particulate material 4. The step 115 of adjusting the cross-sectional area of at least the part of the entrainment region 6 may comprise arranging the selected second restriction member 12b in the second part 6a of the entrainment region 6. The step of selecting a second restriction member 12b may comprise selecting a cross-sectional area A3 of the second restriction member 12b, e.g. based on the particulate material.

The method 100 may comprise selecting one or more properties of the gas or gas mixture. The one or more properties of the gas or gas mixture may be selected based on the particulate material 4, e.g. the properties thereof. For example, for a first particulate material, a higher entrainment energy or entrainment power may be required than for a second particulate material. As such, a velocity of the gas or gas mixture in the entrainment region 6 may be selected to be higher for the first particulate material. The first particulate material may comprise a cohesive particulate material. The second particulate material may comprise a free flowing material, e.g. relative to the first particulate material.

The method 100 may comprise controlling the one or more properties of the gas or gas mixture flowing through the entrainment region 6. The method 100 may comprise selecting and/or controlling the mass flow rate of the particulate material 4 supplied by the supply device 8 based on the target mass flow rate. For example, the method 100 may comprise selecting a speed at which the moving arrangement 19 moves the particulate material 4 from the container 18 to the entrainment region 6. This may include selecting a speed of the piston and/or the actuator 22.

The method 100 may comprise receiving a first signal, e.g. from a first sensor 44a. The method may comprise receiving a plurality of first signals from a plurality of first sensors 4a. The first signal, the plurality of first signals or each first signal of the plurality of first signals may be indicative of a mass flow rate of the particulate material. The method 100 may comprise determining the mass flow rate of the particulate material, e.g. based on the first signal, the plurality of first signals or each first signal of the plurality of first signals. As described above, the mass flow rate of the particulate material may comprise a mass flow rate of the particulate material entrained in the gas or gas mixture and/or a mass flow rate of the particulate material separated from the gas or gas mixture.

The method 100 may comprise comparing the determined mass flow rate of the particulate material to the target mass flow rate. The method 100 may comprise determining a target flow rate and/or target pressure of the gas or gas mixture flowing through the entrainment region 6, e.g. based on a result of the comparison between the determined mass flow rate of the particulate material and the target mass flow rate.

The method 100 may comprise receiving a second signal, e.g. from a second sensor 44b. The second signal may be indicative of the flow rate or a pressure of the gas or gas mixture flowing through the entrainment region 6. The method 100 may comprise determining the flow rate or pressure of the gas or gas mixture flowing through the entrainment region 6, e.g. based on the second signal. The method 100 may comprise comparing the determined flow rate or pressure to the target flow rate or target pressure. The method 100 may comprise adjusting at least one of: the one or more properties of the gas or gas mixture flowing through entrainment region, and a mass flow rate of the particulate material supplied by the supply device, e.g. based on a result of the comparison between the determined flow rate or pressure and the target flow rate or target pressure. By adjusting the one or more properties, e.g. the flow rate and/or the pressure, of the gas or gas mixture 14a flowing through entrainment region 6, the velocity of the gas or gas mixture 14a in the entrainment region 6 may be controlled or adjusted. This in turn may allow an adjustment, e.g. a fine adjustment, of the entrainment energy.

The method 100 may comprise controlling a speed or velocity of the moving arrangement 19 and/or a speed or velocity of the agitating device 31. The method 100 may comprise adjusting the speed or velocity of the moving arrangement and/or the speed or velocity of the agitating device, e.g. based on the result of the comparison between the determined mass flow rate of the particulate material and the target mass flow rate.

The method 100 may comprise separating the particulate material from the gas or gas mixture, e.g. using the separation device 10.

As described above, one or more parts of the apparatus 2 may be formed using an additive manufacturing process. The apparatus 2 may be or comprise a modular apparatus. This may allow parts of the apparatus 2 to be formed separately or independently, to be modified and/or replaced.

A common example of additive manufacturing is 3D printing; however, other methods of additive manufacturing are available. Rapid prototyping or rapid manufacturing are also terms, which may be used to describe additive manufacturing processes.

As used herein, “additive manufacturing” refers generally to manufacturing processes or methods wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process or method may allow an example of the disclosure to be integrally formed and include a variety of features not possible when using prior manufacturing methods.

Additive manufacturing methods described herein may enable manufacture to any suitable size and shape with various features, which may not have been possible using prior manufacturing methods. Additive manufacturing may create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure may include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes.

The additive manufacturing processes or methods described herein may be used for forming components using any suitable material. For example, the material may be plastic, metal, composite, concrete, ceramic, polymer, epoxy, photopolymer resin, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in additive manufacturing processes which may be suitable for the fabrication of examples described herein.

As noted above, the additive manufacturing process or method disclosed herein may allow a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although some components described herein may be constructed entirely by additive manufacturing processes or methods, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on three-dimensional (3D) information, for example a three-dimensional computer model (or design file), of the component.

Accordingly, examples or embodiments described herein not only include products or components as described herein, but also methods of manufacturing such products or components via additive manufacturing and computer software, firmware or hardware for controlling the manufacture of such products via additive manufacturing.

The structure of the product or one or more parts thereof may be represented digitally in the form of a design file. A design file, or computer aided design (CAD) file, is a configuration file that encodes one or more of the surface or volumetric configuration of the shape of the product or one or more parts thereof. That is, a design file may represent the geometrical arrangement or shape of the product or one or more parts thereof.

Design files may take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats may include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files may be produced using modelling (e.g. CAD modelling) software and/or through scanning the surface of a product to measure the surface configuration of the product.

Once obtained, a design file may be converted into a set of computer executable instructions that, once executed by a processer, may cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from the inventor(s), a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus may be instructed to print out the product or one or more parts thereof. These may be printed either in assembled or unassembled form. For instance, different sections of the product or one or more parts thereof may be printed separately (as a kit of unassembled parts) and then subsequently assembled. Alternatively, the different parts may be printed in assembled form.

FIG. 25 shows an exemplary flow diagram outlining the steps of a method 200 of manufacturing a product via additive manufacturing. In step 205, the method 200 may comprise obtaining an electronic file representing a geometry of a product. The product is at least a part of the apparatus 2 described above. Additionally or alternatively, the product may be at least a part of the supply device 8 described above. In step 210, the method may comprise controlling an additive manufacturing apparatus to manufacture, over one or more additive manufacturing steps, the product according to the geometry represented or specified in the electronic file. The electronic file may be or comprise the design file described herein.

The method 200 may include the steps of obtaining the design file, representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself may automatically cause the production of the product once input into the additive manufacturing apparatus. Accordingly, in this embodiment, the design file itself may be considered computer executable instructions that may cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification may be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification may be realized using one or more computer programs, i.e., one or more modules of computer program instructions, encoded on computer-readable storage medium for execution by, or to control the operation of, data processing apparatus. Alternatively or in addition, the program instructions may be encoded on an artificially-generated propagated signal, e.g., a machine-generated electrical, optical, or electromagnetic signal that is generated to encode information for transmission to suitable receiver apparatus for execution by a data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

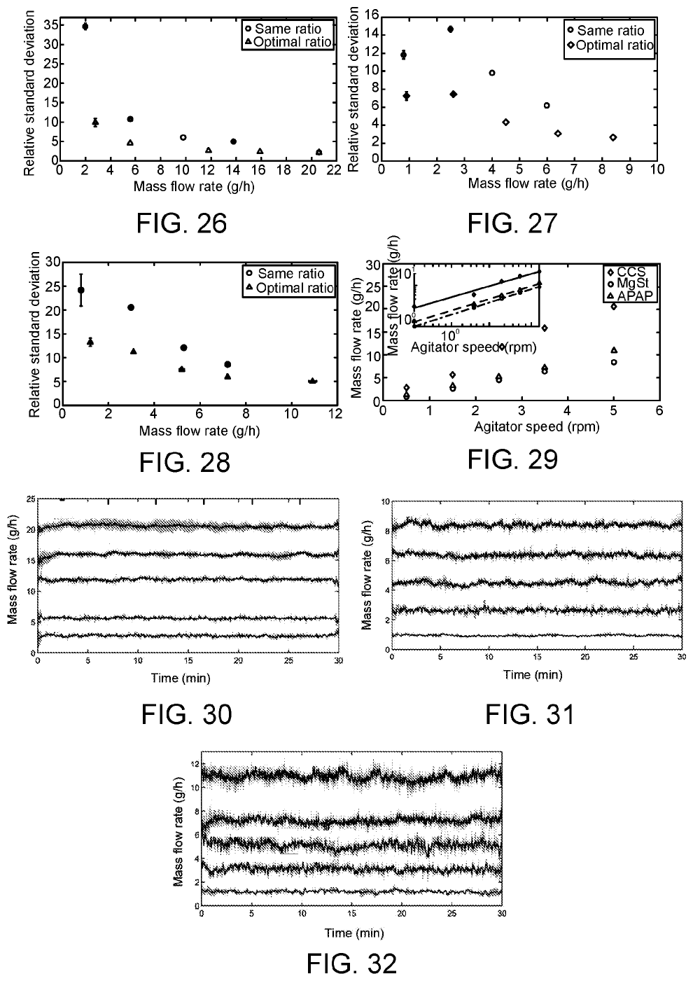

FIGS. 26 to 28 each show a graph of a relative standard deviation that was determined for mass flow rates of different particulate materials supplied by the supply device 8 shown in FIGS. 6A, 6B, 7A, 7B, 7C and 7I to 7K.

The mass flow rate of the particulate materials were measured directly from the supply device 8. In this example, the particulate material includes croscarmellose sodium, magnesium stearate and paracetamol. In this example, the agitating device 31 was configured to include the first or inner spiral portion 31d and the second or outer spiral portion 31e, as for example shown in FIG. 7D. The first diameter D1 of the first or inner spiral portion 31d was selected as about 8.5 mm. The first pitch P1 of the first or inner spiral portion 31 was selected as about 10 mm. The second diameter D2 of the second or outer spiral portion was selected as about 50 mm, as described above. The second pitch P2 was selected as about 25 mm. A pitch of the shaft 30 was selected as about 7 mm for croscarmellose sodium and about 25 mm for magnesium stearate and paracetamol.

FIG. 26 shows relative standard deviations for the measured mass flow rates of croscarmellose sodium. FIG. 27 shows relative standard deviations for the measured mass flow rates of magnesium stearate. FIG. 28 shows relative standard deviations for the measured mass flow rates of paracetamol.

The mass flow rate were measured three times to determine the relative standard deviations. The vertical error bars in FIGS. 26 to 28 are indicative of a standard deviation of each of the determined relative standard deviations. The horizontal error bars in FIGS. 26 to 28 are indicative of a standard deviation of each of the measured mass flow rates. The vertical and horizontal error bars may be considered as being indicative of a stability and repeatability of the measured mass flow rates of the particulate material supplied by supply device 8.

The relative standard deviation was determined for each mass flow rate for two ratios of the speed or velocity of the shaft 30 relative to a speed or velocity of the agitating device 31. The relative standard deviation was determined for the shaft 30 and the agitating device 31 having the same speed or velocity. This is referred to in FIGS. 26 to 28 as the “same ratio”. The relative standard deviation was also determined for a speed or velocity of the shaft 30 being 0.5 revolutions per minute higher than a speed or velocity of the agitating device 31. This is referred to in FIGS. 26 to 28 as “optimal ratio”. It can be seen from FIGS. 26 to 28 that the relative standard deviation is decreased for the measured mass flow rates supplied at the optimal ratio relative to the relative standard deviations for the measured mass flow rates supplied at the same ratio. As such, at the optimal ratio, variations of the mass flow rate of the particulate material supplied by the supply device may be reduced.

FIG. 29 shows a graph of a mass flow rate of different particulate materials over a speed or velocity of the agitating device 31. The speed or velocity of the shaft 30 was selected to 0.5 revolutions per minute higher than the speed or velocity of the agitating device 31. The measurements of the mass flow rate of the different particulate materials were repeated three times. In this example, the particulate material includes croscarmellose sodium (CCS), magnesium stearate (MgSt) and paracetamol (APAP). It can be seen from FIG. 29 that the mass flow rate of each of the particulate materials linearly depends on the speed or velocity of the agitating device 31. For example, the mass flow rate of each of the particulate materials linearly increases with increasing speed or velocity of the agitating device 31. This may allow for a prediction of a required speed or velocity of the agitating device 31 to achieve a desired mass flow rate (e.g. the target mass flow rate) of a particulate material. As such, a speed or velocity of the agitating device 31 may be selected based on a target mass flow rate of the particulate material 4.

FIGS. 30 to 32 each show a graph of mass flow rates of a particulate material 4 supplied by the supply device 8 shown in FIGS. 6A, 6B, 7A, 7B and 7C and 7I to 7K over time. In this example, the mass flow rate of the particulate material 4 was measured directly from the supply device 8. The dark grey line in each of FIGS. 30 to 32 indicates the measured mass flow rate. The light grey line in each of FIGS. 30 to 32 indicates the standard deviation. It can be seen from these figures that the mass flow rate of the respective particulate material for different speeds or velocities of the agitating device 31 and the shaft 30 is consistent, e.g. substantially consistent over time.

In the example shown in FIG. 30, the particulate material comprises croscarmellose sodium. A median of the mass flow rate of the particulate material was determined as about 5.7×10⁻⁶ kg/s (20.6 g/h) with a relative standard deviation of about 2.3%, with a stability of about 0.5% and a repeatability of about 0.4% for a speed or velocity of the agitating device 31 and the shaft 30 of 5 revolutions per minute.

A median of the mass flow rate of the particulate material was determined as about 4.4×10⁻⁶ kg/s (15.9 g/h) with a relative standard deviation of about 2.4%, with a stability of about 0.4% and a repeatability of about 0.6% for a speed or velocity of the agitating device 31 of 3.5 revolutions per minute and a speed or velocity of the shaft 30 of 4 revolutions per minute.

A median of the mass flow rate of the particulate material was determined as about 3.3×10⁻⁶ kg/s (11.8 g/h) with a relative standard deviation of about 2.6%, with a stability of about 0.02% and a repeatability of about 0.8% for a speed or velocity of the agitating device 31 of 2.5 revolutions per minute and a speed or velocity of the shaft 30 of 3 revolutions per minute.

A median of the mass flow rate of the particulate material was determined as about 1.6×10⁻⁶ kg/s (5.6 g/h) with a relative standard deviation of about 4.6%, with a stability of about 0.2% and a repeatability of about 0.2% for a speed or velocity of the agitating device 31 of 1.5 revolutions per minute and a speed or velocity of the shaft 30 of 2 revolutions per minute.

A median of the mass flow rate of the particulate material was determined as about 7.8×10⁻⁷ kg/s (2.8 g/h) with a relative standard deviation of about 10%, with a stability of about 1.1% and a repeatability of about 4.6% for a speed or velocity of the agitating device 31 of 0.5 revolutions per minute and a speed or velocity of the shaft 30 of 1 revolutions per minute.

The measurements of the mass flow rates of croscarmellose sodium are summarised in the table shown in FIG. 33.

In the example shown in FIG. 31, the particulate material comprises magnesium stearate. A median of the mass flow rate of the particulate material was determined as about 2.3×10⁻⁶ kg/s (8.4 g/h) with a relative standard deviation of about 2.7%, with a stability of about 0.07% and a repeatability of about 0.4% for a speed or velocity of the agitating device 31 and the shaft 30 of 5 revolutions per minute.

A median of the mass flow rate of the particulate material was determined as about 1.8×10⁻⁶ kg/s (6.4 g/h) with a relative standard deviation of about 3%, with a stability of about 0.06% and a repeatability of about 0.6% for a speed or velocity of the agitating device 31 of 3.5 revolutions per minute and a speed or velocity of the shaft 30 of 6 revolutions per minute.

A median of the mass flow rate of the particulate material was determined as about 1.3×10⁻⁶ kg/s (4.5 g/h) with a relative standard deviation of about 4%, with a stability of about 0.1% and a repeatability of less than 0.9% for a speed or velocity of the agitating device 31 of 2.5 revolutions per minute and a speed or velocity of the shaft 30 of 5 revolutions per minute.

A median of the mass flow rate of the particulate material was determined as about 7.2×10⁻⁷ kg/s (2.6 g/h) with a relative standard deviation of about 7.5%, with a stability of about 0.1% and a repeatability of about 0.3% for a speed or velocity of the agitating device 31 of 1.5 revolutions per minute and a peed or velocity of the shaft 30 of 2 revolutions per minute.

A median of the mass flow rate of the particulate material was determined as about 2.5×10⁻⁷ kg/s (0.9 g/h) with a relative standard deviation of about 7%, with a stability of about 0.4% and a repeatability of about 2% for a speed or velocity of the agitating device 31 of 0.5 revolutions per minute and a speed or velocity of the shaft 30 of 1.5 revolutions per minute.

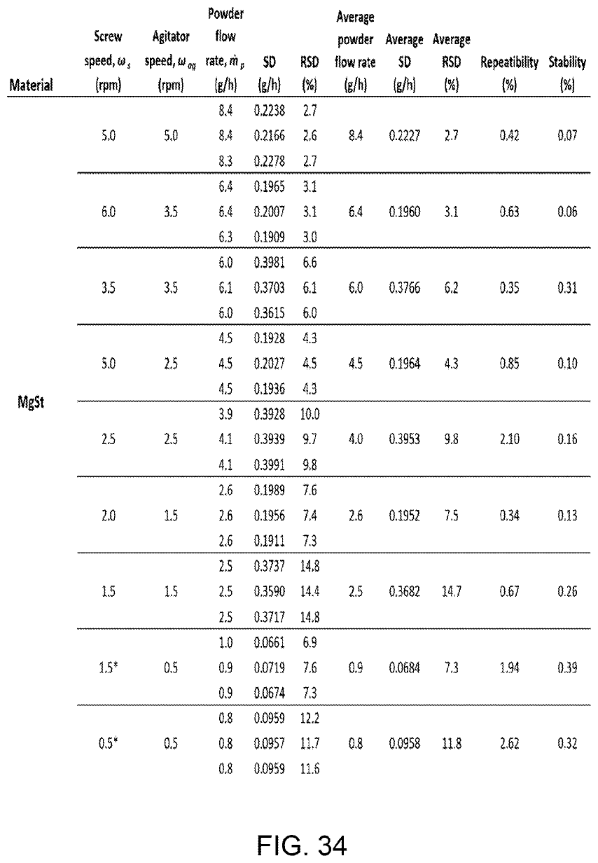

The measurements of the mass flow rates of magnesium stearate are summarised in the table shown in FIG. 34.

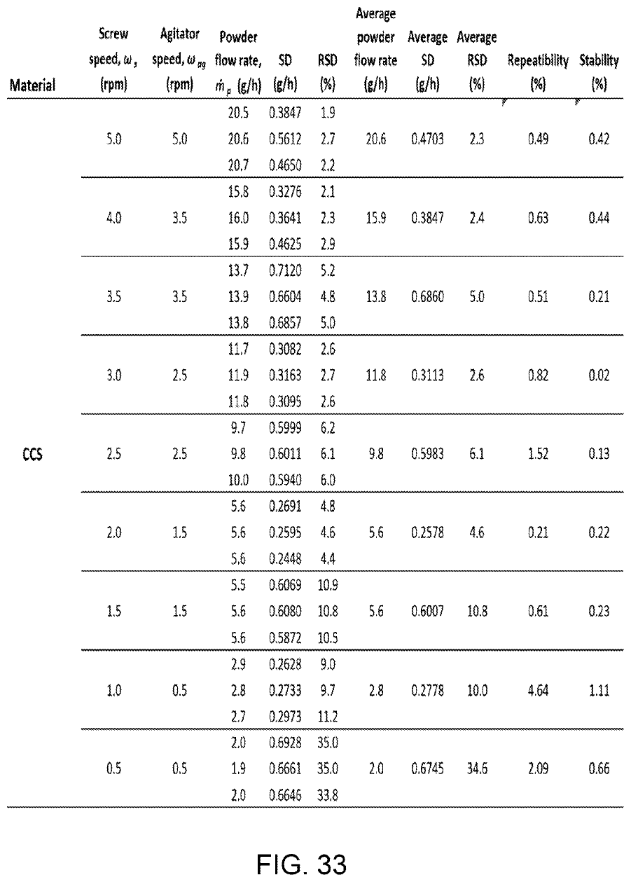

In the example shown in FIG. 32, the particulate material comprises paracetamol. A median of the mass flow rate of the particulate material was determined as about 3×10⁻⁶ kg/s (10.9 g/h) with a relative standard deviation of about 5%, with a stability of about 4% and a repeatability of about 1.4% for a speed or velocity of the agitating device 31 and the shaft 30 of 5 revolutions per minute.

A median of the mass flow rate of the particulate material was determined as about 2×10⁻⁶ kg/s (7.2 g/h) with a relative standard deviation of about 6%, with a stability of about 1.6% and a repeatability of about 0.2% for a speed or velocity of the agitating device 31 of 3.5 revolutions per minute and a speed or velocity of the shaft 30 of 4 revolutions per minute.

A median of the mass flow rate of the particulate material was determined as about 1.4×10⁻⁶ kg/s (5.2 g/h) with a relative standard deviation of about 7.5%, with a stability of about 2.3% and a repeatability of about 2.5% for a speed or velocity of the agitating device 31 of 2.5 revolutions per minute and a speed or velocity of the shaft 30 of 3 revolutions per minute.

A median of the mass flow rate of the particulate material was determined as about 8.6×10⁻⁷ kg/s (3.1 g/h) with a relative standard deviation of about 11%, with a stability of about 0.5% and a repeatability of about 1.2 m % for a speed or velocity of the agitating device 31 of 1.5 revolutions per minute and a speed or velocity of the shaft 30 of 2 revolutions per minute.

A median of the mass flow rate of the particulate material was determined as about 3.3×10⁻⁷ kg/s (1.2 g/h) with a relative standard deviation of about 13%, with a stability of about 0.3% and a repeatability of about 7.6% for a speed or velocity of the agitating device 31 of 0.5 revolutions per minute and a speed or velocity of the shaft 30 of 1 revolutions per minute.

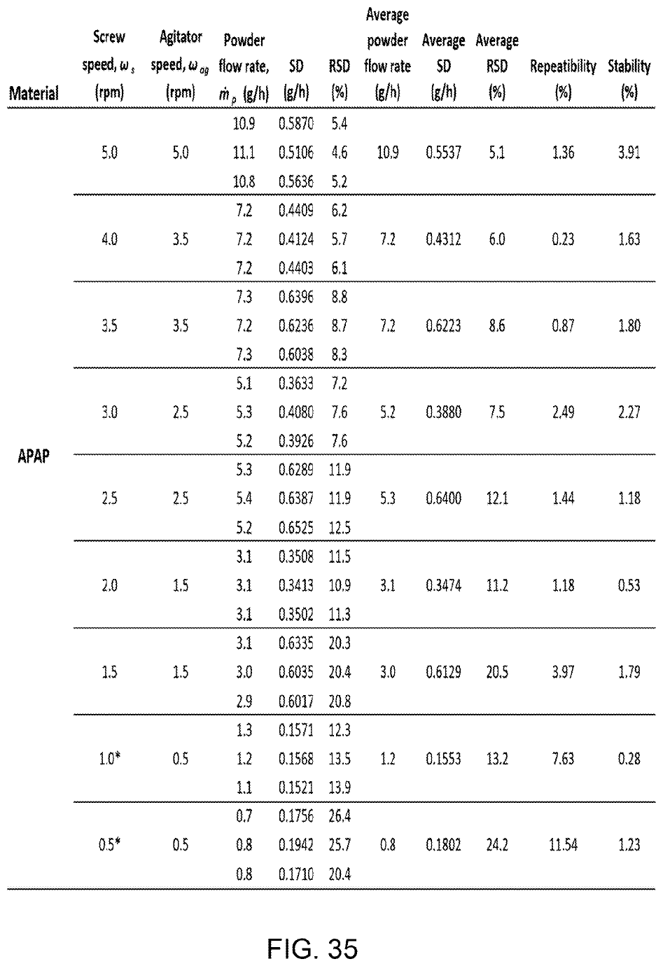

The measurements of the mass flow rate of paracetamol are summarised in the table shown in FIG. 35.

From FIGS. 30 to 35 it can be seen that the supply device 8 may be used to consistently and continuously supply, e.g. paracetamol with mass flow rates between about 3.3×10⁻⁷ kg/s and 3×10⁻⁶ kg/s (1.2 g/h and 10.9 g/h), magnesium stearate with mass flow rates between about 2.5×10⁻⁷ kg/s and 2.3×10⁻⁶ kg/s (0.9 g/h and 8.4 g/h) and croscarmellose sodium with mass flow rates between about 7.8×10⁻⁷ kg/s and 5.7×10⁻⁶ kg/s (2.8 g/h and 20.6 g/h).

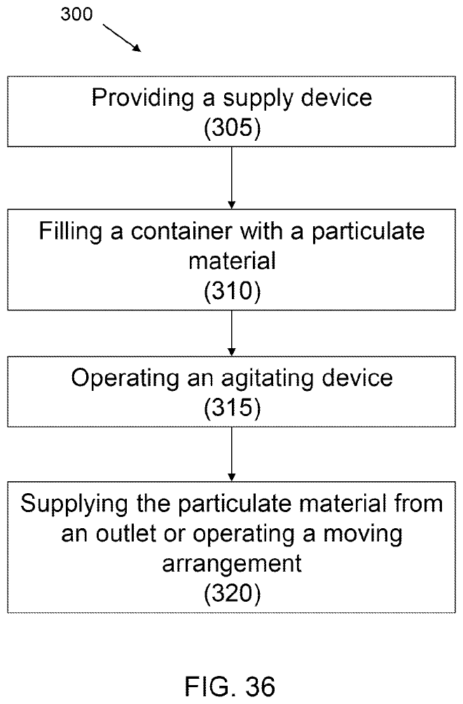

FIG. 36 shows an exemplary flow diagram outlining the steps of a method 300 of using a supply device for supplying a particulate material at approximately or at a target mass flow rate. The supply device may comprise the supply device 8 described above. The method 300 may be part of a manufacturing method, such as a pharmaceutical manufacturing method, a food and/or beverage manufacturing method, a cosmetic product manufacturing method or the like.

In step 305, the method 300 comprises providing the supply device 8.

In step 310, the method 300 comprises filling the container 18 with the particulate material 4. The container 18 may be filled with the particulate material up to a pre-determined level.

In step 315, the method 300 comprise operating the agitating device 31 to move the particulate material 4 in the container 18. For example, operating the agitating device may comprise moving, e.g. rotating, the portion 31a in the container 18. Step 315 may comprise selecting a speed or velocity of the agitating device 31, e.g. based on the particulate material 4 and/or the target mass flow rate.

In step 320, the method 300 comprises supplying the particulate material from the outlet 43. For example, the agitating device 31 may be configured to move a portion of the particulate material 4 towards the outlet 43. The agitating device may be configured to regulate or control an amount of the particulate material 4, e.g. a mass flow rate of the particulate material 4, to the outlet 43.

Alternatively, in step 320, the method 300 comprises operating the moving arrangement to move the particulate material 4 from the container 18 to a desired location at approximately or at the target mass flow rate. For example, operating the moving arrangement may comprise moving, e.g. rotating, the shaft 30. Step 320 may comprise selecting a speed or velocity of the moving arrangement, e.g. the shaft 30, based on the particulate material 4 and/or the target mass flow rate.

The method 300 may comprise refilling the container 18 with the particulate material 4, e.g. when a level of the particulate material 4 in the container has decreased, e.g. to below a threshold level, e.g. a pre-determined threshold level. For example, the threshold level may be about one third of a container level.

It will be appreciated that the terms “product” or “component” may be interchangeably used. The product or component mentioned above may comprise at least a part of the apparatus disclosed herein.

The terms “gas or gas mixture flowing through the entrainment regions” and gas or gas mixture in the entrainment region” may be interchangeably used.

It will be understood that references to a plurality of features may be interchangeably used with references to singular forms of those features, such as for example “at least one” and/or “each”. Singular forms of a feature, such as for example “at least one” or “each,” may be used interchangeably.

Although the disclosure has been described in terms of embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. An agitating device for moving a particulate material in a container, the device comprising:
a first spiral or helical portion; and
a second spiral or helical portion configured to surround the first spiral or helical portion, wherein the first spiral or helical portion is configured to move at least a portion of the particulate material in the container in a first direction and the second spiral or helical portion is configured to move at least a portion of the particulate in the container in a second direction, the first and second directions being parallel to a longitudinal axis of the agitating device and the first direction being opposite to the second direction.

2. The device of claim 1, wherein the first spiral or helical portion comprises a first diameter and a first pitch and the second spiral or helical portion comprises a second diameter and a second pitch, the first and second diameters being different, the first and second pitches being different and at least one of the first diameter, the second diameter, the first pitch and the second pitch being selected based on the particulate material.

3. The device of claim 2, wherein at least one of the first and second spiral or helical portions are configured such that at least one of the first and second diameters changes along a length of the first and second spiral or helical portions, respectively.

4. The device of claim 1, wherein the device comprises at least one of:
a third spiral or helical portion, the third spiral or helical portion being arranged between the first and second spiral or helical portions; and/or
a fourth spiral or helical portion, the fourth spiral or helical portion being arranged to surround the first and/or third spiral or helical portions.

5. The device of claim 4, wherein the third spiral or helical portion comprises a third diameter and a third pitch and/or the fourth spiral or helical portion comprises a fourth diameter and a fourth pitch, at least one of the third and fourth pitches being selected based on the particulate material; and optionally wherein at least one of the third and fourth spiral or helical portions is configured such that at least one of the third and fourth diameters changes along a length of the third and fourth spiral or helical portions, respectively.

6. The device of claim 1, wherein the first spiral or helical portion comprises a plurality of crest portions, wherein the first helical or spiral portion is configured such that each crest portion extends between a central axis and an outer edge of the first helical or spiral portion.

7. A helical or spiral member for moving a particulate material, the helical or spiral member comprising:
a plurality of crest portions, wherein the helical or spiral member is configured such that each crest portion extends between a central axis and an outer edge of the helical or spiral member, wherein a distance between adjacent crest portions of the plurality of crest portions and a shape of at least a portion of the helical or spiral member is selected based on the particulate material.

8. The helical or spiral member of claim 7, wherein the portion comprises an end portion of the helical or spiral member and the helical or spiral member is configured such that:
the shape of the end portion is the same as a shape of a remainder of the helical or spiral member; or
the shape of the end portion is different relative to the shape of the remainder of the helical or spiral member.

9. The helical or spiral member of claim 8, wherein when the shape of the end portion is different relative to the shape of the remainder of the helical or spiral member, the helical or spiral member is configured such that:
a distance between two or more adjacent crest portions of the end portion is different relative to a distance between two or more adjacent crest portions of the remainder of the helical or spiral member; and/or
a radius of one or more crest portions of the end portion is different relative to a radius of one or more crest portions of the remainder of the helical or spiral member.

10. A supply device for supplying a particulate material at approximately or at a target mass flow rate, the device comprising:
a container for holding the particulate material; and
an agitating device for moving the particulate material in the container according to claim 1, at least a portion of the agitating device being arranged in the container;
wherein:
the device comprises an outlet configured to supply the particulate material from the container at approximately or at the target mass flow rate; or
the container is connected to a moving arrangement configured to move the particulate material from the container to a desired location at approximately or at the target mass flow rate.

11. The supply device of claim 10, wherein the moving arrangement is arranged at an angle relative to a longitudinal axis of the container.

12. The supply device of claim 11, wherein the moving arrangement is arranged at an angle between 0 degrees and 180 degrees relative to the longitudinal axis of the container.

13. The supply device of claim 10, wherein the moving arrangement comprises a helical or spiral member, wherein the helical or spiral member is configured to receive at least a portion of particulate material from the container and to move the particulate material from the container to the desired location.

14. The supply device of claim 13, wherein the helical or spiral member comprises a helical or spiral member for moving a particulate material, the helical or spiral member comprising:
a plurality of crest portions, wherein the helical or spiral member is configured such that each crest portion extends between a central axis and an outer edge of the helical or spiral member, wherein a distance between adjacent crest portions of the plurality of crest portions and a shape of at least a portion of the helical or spiral member is selected based on the particulate material.

15. The supply device of claim 10, wherein the supply device comprises a housing, at least a part of the moving arrangement being arranged in the housing, the container being connected to an outside of the housing.

16. The supply device of claim 10, wherein the device comprises a control system, the control system being configured to control at least one of:
a speed or velocity of the moving arrangement; and
a speed or velocity of the agitating device.

17. The supply device of claim 16, wherein the control system comprises a sensor configured to sense a signal, the signal being indicative of a mass flow rate of the particulate material supplied by the supply device, the control system being configured to at least one of:
determine the mass flow rate of the particulate material supplied by the supply device based on the sensed signal;
compare the determined mass flow rate of the particulate material to a target mass flow rate;
adjust at least one of:
the speed or velocity of the moving arrangement; and
the speed or velocity of the agitating device,
based on a result of the comparison between the determined mass flow rate of the particulate material and the target mass flow rate.

18. The supply device of claim 17, wherein one of more walls of the container are formed from a flexible material and the supply device comprises a support arrangement configured to support and/or move at least one of the one or more walls of the container.

19. A method of using a supply device for supplying a particulate material at approximately or at a target mass flow rate, the method comprising:
providing the supply device according to claim 10;
filling the container with a particulate material;
operating the agitating device to move the particulate material in the container;
supplying the particulate material from the outlet, or
operating the moving arrangement to move the particulate material from the container to a desired location at approximately or at the target mass flow rate.

20. A manufacturing system comprising a device for supplying a particulate material at approximately or at a target mass flow rate according to claim 10.

21. A system for blending or mixing a plurality of particulate materials, the system comprising:
a plurality of devices for supplying a particulate material at approximately or at a target mass flow rate, each of the plurality of devices comprising a supply device for supplying a particulate material at approximately or at a target mass flow rate according to claim 10, wherein at least one of the plurality of devices is arranged to supply particulate material into a container of at least one other of the plurality of devices.

22.-59. (canceled)
